(19) United States
(12) Patent Application Publication
(10) Pub. No.: US 2013/0155360 A1
(43) Pub. Date: Jun. 20, 2013

(54) LIQUID CRYSTAL DISPLAY DEVICE AND METHOD OF MANUFACTURING THE SAME

(71) Applicant: Sony Corporation, Tokyo (JP)

(72) Inventors: Seiji Shibahara, Chiba (JP); Shunichi Suwa, Kanagawa (JP); Masashi Miyakawa, Kanagawa (JP); Masahiko Nakamura, Kanagawa (JP); Tadaaki Isozaki, Kanagawa (JP)

(73) Assignee: Sony Corporation, Tokyo (JP)

(21) Appl. No.: 13/709,085

(22) Filed: Dec. 10, 2012

(30) Foreign Application Priority Data
Dec. 16, 2011 (JP) 2011-275508

(51) Int. Cl. G02F 1/1337

(52) U.S. Cl. CPC G02F 1/1337
USPC 349/123; 445/25

(57) ABSTRACT

A liquid crystal display device includes a liquid crystal display element including a pair of alignment films provided on opposing face sides of a pair of substrates, and a liquid crystal layer including liquid crystal molecules with negative dielectric constant anisotropy provided between the pair of alignment films, wherein at least one of the pair of alignment films includes a compound in which a polymer compound including a cross-linkable functional group as a side chain is cross-linked, a pretilt is conferred on the liquid crystal molecules by the cross-linked compound, and at least one type of a compound represented by the following General Formula 101 or General Formula 102 is included in the liquid crystal layer.

CH₍₄₋ₙ₎(R¹)ₙ (101)

(R²)ₘ-A-(X)ₚ (102)

### BACKGROUND

The present disclosure relates to a liquid crystal display device including a liquid crystal display element in which a liquid crystal layer is sealed between a pair of substrates with an alignment film on the opposing face, and a method of manufacturing the liquid crystal display device.

In recent years, a liquid crystal display (LCD) has often been used as the display monitor of a liquid crystal television set, a notebook personal computer, a car navigation device, or the like. The liquid crystal display is categorized into a variety of display modes (systems) according to the molecular arrangement (alignment) of liquid crystal molecules included in a liquid crystal layer interposed between substrates. As a display mode, for example, a TN (Twisted Nematic) mode in which the liquid crystal molecules are twisted and aligned in a state in which a voltage is not applied is common. With the TN mode, the liquid crystal molecules have positive dielectric constant anisotropy, that is, a property in which the dielectric constant in the major axis direction of the liquid crystal molecules is large compared to the minor axis direction. Therefore, the liquid crystal molecules have a structure in which the alignment direction of the liquid crystal molecules is sequentially rotated within a plane parallel to the substrate face and the liquid crystal molecules being aligned in a direction vertical to the substrate face.

On the other hand, there has been growing attention on a VA (Vertical Alignment) mode in which the liquid crystal molecules are aligned vertically with respect to the substrate face in a state in which a voltage is not applied. In the VA mode, the liquid crystal molecules have negative dielectric constant anisotropy, that is, a property in which the dielectric constant in the major axis of the liquid crystal molecules is small compared to that in the minor axis direction, and a wider viewing angle is able to be realized compared to the TN mode.

A liquid crystal display of the VA mode has a structure of transmitting light by the liquid crystal molecules aligned in the vertical direction with respect to the substrates responding to a voltage being applied by inclining in the horizontal direction with respect to the substrates due to negative dielectric constant anisotropy. However, since the direction in which the liquid crystal molecules aligned in the vertical direction with respect to the substrates incline is arbitrary, the alignment of the liquid crystals molecules is disturbed by the voltage application, causing a deterioration in the response characteristics with respect to the voltage.

Therefore, in order to improve response characteristics, a technology of regulating the direction in which the liquid crystal molecules incline in response to a voltage is being considered. Specifically, there is a technology (optical alignment film technology) of conferring a pretilt on the liquid crystal molecules using an alignment film formed by irradiating linearly polarized light from ultraviolet light or ultraviolet light from a diagonal direction with respect to the substrate face, and the like. As an optical alignment film technology, for example, there is a common technology of forming an alignment film by irradiating linearly polarized light from ultraviolet light or ultraviolet light from a diagonal direction with respect to the substrate face on a film formed by a polymer including a chalcone structure and the double bonded portion of the chalcone structure being cross-linked (refer to Japanese Unexamined Patent Application Publication No. 10-087859, Japanese Unexamined Patent Application Publication No. 10-252646, and Japanese Unexamined Patent Application Publication No. 2002-082336). Further, in addition, there is a technology of forming an alignment film using a mixture of a vinyl cinnamate derivative polymer and a polyimide (refer to Japanese Unexamined Patent Application Publication No. 10-232400). Further, a technology of forming an alignment film by irradiating linearly polarized light with a wavelength of 254 nm on a film including a polyimide and disintegrating a portion of the polyimide (refer to Japanese Unexamined Patent Application Publication No. 10-073821) or the like is also common. Further, as a peripheral technology of the optical alignment film technology, there is also a technology of forming a liquid crystalline alignment film by forming a film formed of a liquid crystalline polymer compound on a film formed of a polymer including dichroic photoreactive constituent units such as an azobenzene derivative on which linearly polarized light or diagonal light is irradiated (refer to Japanese Unexamined Patent Application Publication No. 11-326638).

Further, a liquid crystal display device including a liquid crystal display element including a pair of alignment films provided on the opposing face side of a pair of substrates, and a liquid crystal layer provided between the pair of alignment films and including liquid crystal molecules with negative dielectric constant anisotropy, wherein at least one of the pair of alignment films includes a compound in which a polymer compound including a cross-linkable functional group as a side chain is cross-linked or deformed, and a pretilt is conferred on the liquid crystal molecules by the cross-linked or deformed compound, is commonly recognized from Japanese Unexamined Patent Application Publication No. 2011-095696.

### SUMMARY

However, with the optical alignment film technologies described above, while the response characteristics improve, there is a problem in that a large-scale light irradiation device such as a device irradiating linearly polarized light or a device irradiating light on the substrate face from a diagonal direction is used when forming an alignment film. Further, in order to manufacture a liquid crystal display with a multi-domain in which the alignment of the liquid crystal molecules is divided by providing a plurality of sub pixels within a pixel in order to realize a greater viewing angle, as well as a more large-scale device being used, there is a problem in that the manufacturing process is made complex. Specifically, an alignment film is formed so that the pretilt is different for each sub pixel in a liquid crystal display with a multi-domain. Therefore, in a case where the optical alignment film technologies described above is used in the manufacture of a liquid crystal display with a multi-domain, since light irradiation is performed for each sub pixel, a mask pattern for each sub pixel is used, causing the light irradiation device to be even more large-scale. Further, while it is possible to improve the response characteristics according to the technology disclosed in Japanese Unexamined Patent Application Publication No. 2011-095696, even greater pretilt stabilization (high alignment stability) is in demand.

It is desirable to provide a liquid crystal display device including a liquid crystal display element able to easily improve response characteristics even without using a large-scale manufactured device, and moreover able to confer even greater pretilt stabilization (high alignment stability) on the liquid crystal molecules, and a method of manufacturing the same.

According to a first embodiment of the present disclosure, there is provided a liquid crystal display device including: a liquid crystal display element including a pair of alignment films provided on opposing face sides of a pair of substrates, and a liquid crystal layer including liquid crystal molecules with negative dielectric constant anisotropy provided between the pair of alignment films, wherein at least one of the pair of alignment films includes a compound in which a polymer compound including a cross-linkable functional group as a side chain is cross-linked (for convenience, referred to as “post-alignment process compound”), a pretilt is conferred on the liquid crystal molecules by the cross-linked compound (post-alignment process compound), and at least one type of a compound represented by the following General Formula 101 or General Formula 102 is included in the liquid crystal layer. Further, the liquid crystal display element according to the first embodiment of the present disclosure is formed of the liquid crystal display element of the liquid crystal display device according to the first embodiment of the present disclosure. Here, a “cross-linkable functional group” refers to a group that is able to form a cross-linked structure (bridged structure).

According to a second embodiment of the present disclosure, there is provided a liquid crystal display device including: a liquid crystal display element including a pair of alignment films provided on opposing face sides of a pair of substrates, and a liquid crystal layer including liquid crystal molecules with negative dielectric constant anisotropy provided between the pair of alignment films, wherein at least one of the pair of alignment films includes a compound in which a polymer compound including a photosensitive functional group as a side chain is deformed (for convenience, referred to as “post-alignment process compound”), a pretilt is conferred on the liquid crystal molecules by the deformed compound (post-alignment process compound), and at least one type of a compound represented by the following General Formula 101 or General Formula 102 is included in the liquid crystal layer. Further, the liquid crystal display element according to the second embodiment of the present disclosure is formed of the liquid crystal display element of the liquid crystal display device according to the second embodiment of the present disclosure. Here, a “photosensitive functional group” refers to a group that is able to absorb energy rays.

A method of manufacturing the liquid crystal display device of the first embodiment of the present disclosure (or a method of manufacturing the liquid crystal display element) includes: forming a first alignment film formed of a polymer compound including a cross-linkable functional group as a side chain (for convenience, referred to as “pre-alignment process compound”) on one of a pair of substrates; forming a second alignment film on the other of the pair of substrates; arranging the pair of substrates so that the first alignment film and the second alignment film are opposing, and sealing a liquid crystal layer including liquid crystal molecules with negative dielectric constant anisotropy and at least one type of compound represented by the following General Formula 101 or General Formula 102 between the first alignment film and the second alignment film; and conferring a pretilt on the liquid crystal molecules by cross-linking the polymer compound (pre-alignment process compound) after sealing the liquid crystal layer.

Here, according to the method of manufacturing the liquid crystal display device of the first embodiment of the present disclosure (or the method of manufacturing the liquid crystal display element), the side chain of the polymer compound (pre-alignment process compound) may be cross-linked by irradiating ultraviolet rays while aligning the liquid crystal molecules by applying a predetermined electric field on the liquid crystal layer.

Furthermore, in such a case, it is preferable to irradiate ultraviolet rays while applying an electric field on the liquid crystal layer so that the liquid crystal molecules are arranged in a diagonal direction with respect to the surface of at least one of the pair of substrates, and furthermore, it is more preferable that the pair of substrates be configured by a substrate including pixel electrodes and a substrate including opposing electrodes and the ultraviolet rays be irradiated from the side of the substrate including the pixel electrodes. Since generally, a color filter is formed on the side of the substrate including the opposing electrodes, the ultraviolet rays are absorbed by the color filter, and there is a possibility of the cross-linkable functional group of the alignment film material being unreactive, it is even more preferable that the ultraviolet rays be irradiated from the side of the substrate including the pixel electrodes on which the color filter is not formed as described above. In a case where the color filter is formed on the side of the substrate including the pixel electrodes, it is preferable that the ultraviolet rays be irradiated from the side of the substrate including the opposing electrodes. Here, fundamentally, the azimuth (angle of deviation) of the liquid crystal molecules when a pretilt is conferred is regulated by the direction of the electric field, and the polar angle (zenith angle) is regulated by the strength of the electric field. The same is also true of methods of manufacturing the liquid crystal display devices according to the second and third embodiments of the present disclosure described later.

A method of manufacturing the liquid crystal display device according to the second embodiment (or a method of manufacturing the liquid crystal display element) includes: forming a first alignment film formed of a polymer compound including a photosensitive functional group as a side chain (for convenience, referred to as “pre-alignment process compound”) on one of a pair of substrates; forming a second alignment film on the other of the pair of substrates; arranging the pair of substrates so that the first alignment film and the second alignment film are opposing, and sealing a liquid crystal layer including liquid crystal molecules with negative dielectric constant anisotropy and at least one type of compound represented by the following General Formula 101 or General Formula 102 between the first alignment film and the second alignment film; and conferring a pretilt on the liquid crystal molecules by deforming the polymer compound (pre-alignment process compound) after sealing the liquid crystal layer.

Here, according to the method of manufacturing the liquid crystal display device according to the second embodiment of the present disclosure (or the method of manufacturing the liquid crystal display element), the side chain of the polymer compound (pre-alignment process compound) is deformed by irradiating ultraviolet rays while aligning the liquid crystal molecules by applying a predetermined electric field on the liquid crystal layer.

A method of manufacturing the liquid crystal display device according to the third embodiment (or a method of manufacturing the liquid crystal display element) includes: forming a first alignment film formed of a polymer compound including a cross-linkable functional group or a photosensitive functional group as a side chain (for convenience, referred to as “pre-alignment process compound”) on one of a pair of substrates; forming a second alignment film on the other of the pair of substrates; arranging the pair of substrates so that the first alignment film and the second alignment film are opposing, and sealing a liquid crystal layer including liquid crystal molecules with negative dielectric constant anisotropy and at least one type of compound represented by the following General Formula 101 or General Formula 102 between the first alignment film and the second alignment film; and conferring a pretilt on the liquid crystal molecules by irradiating energy rays on the polymer compound (pre-alignment process compound) after sealing the liquid crystal layer. Here, examples of energy rays include ultraviolet rays, X-rays, and electron rays.

According to the method of manufacturing the liquid crystal display device according to the third embodiment of the present disclosure (or the method of manufacturing the liquid crystal display element), ultraviolet rays as energy rays are irradiated on the polymer compound while aligning the liquid crystal molecules by applying a predetermined electric field on the liquid crystal layer.

General Formula 101 and General Formula 102 are

CH₍₄₋ₙ₎(R¹)ₙ (101)

(R²)ₘ-A-(X)ₚ (102).

Here, in General Formula 101, R² represents a phenyl group or a cyclohexyl group which may be respectively independently substituted and n is 3 or 4, and in General Formula 102, “A” represents a benzene ring or a cyclohexane ring, R² represents a phenyl group, a cyclopentadienyl group, or a naphthyl group which may be respectively independently substituted, X respectively independently represents a halogen atom, m is 3, and p is an integer between 0 and 3.

The liquid crystal display device according to the first embodiment of the present disclosure or the method of manufacturing the liquid crystal display device according to the first embodiment of the present disclosure including the preferable forms described above may be generally referred to below simply as the “first embodiment of the present disclosure”, the liquid crystal display device according to the second embodiment of the present disclosure or the method of manufacturing the liquid crystal display device according to the second embodiment of the present disclosure including the preferable forms described above may be generally referred to below simply as the “second embodiment of the present disclosure”, and the method of manufacturing the liquid crystal display device according to the third embodiment of the present disclosure including the preferable forms described above may be generally referred to below simply as the “third embodiment of the present disclosure”.

According to the first to third embodiments of the present disclosure, the substituent in the R¹ or R² of the compound represented by General Formula 101 or General Formula 102 may be at least one type selected from a group consisting of a halogen atom, a hydrocarbon group with one to eight carbon atoms, and an alkoxy group with one to six carbon atoms. Furthermore, in such a case, the halogen atom preferably takes the form of a fluorine atom or a chlorine atom with which a liquid crystal layer with high specific resistance and excellent reliability is able to be obtained, and a fluorine atom is even more preferable.

Furthermore, according to the first to third embodiments of the present disclosure including the preferable forms described above, the mass ratio of the compound represented by General Formula 101 or General Formula 102 with respect to the total of the compound represented by General Formula 101 or General Formula 102 and the liquid crystal molecules is desirably 0.1 mass % to 5 mass %. If the mass ratio is equal to or greater than 0.1 mass %, effects such as an improvement in the response speed is sufficiently obtained. On the other hand, if 5 mass % is exceeded, there is a concern that the compound represented by General Formula 101 or General Formula 102 does not dissolve easily, aggregates tend to be generated, and the liquid crystal molecules do not exhibit a nematic liquid crystal phase across a wide temperature range.

According to the first to third embodiments of the present disclosure including the preferable forms described above, generally, the liquid crystal layer is configured by a plurality of liquid crystal molecules, wherein at least one type of liquid crystal molecule is a liquid crystal molecule with negative dielectric constant anisotropy.

According to the first embodiment, the second embodiment, and the third embodiment of the present disclosure including the preferable forms described above, the polymer compound (pre-alignment process compound) or a compound configuring at least one of the pair of alignment films (post-alignment process compound) may be formed by a compound including the group represented by Formula 1 as a side chain. Here, for convenience, such configurations are referred to as “the 1A configuration of the present disclosure, the 2A configuration of the present disclosure, and the 3A configuration of the present disclosure”.

—R1—R2—R3 (1)

Here, R1 is a linear or branched divalent organic group with three or more carbon atoms which is coupled with the main chain of the polymer compound or the cross-linked compound (pre-alignment process compound or post-alignment process compound), R2 is a divalent organic group including a plurality of ring structures in which one of the atoms configuring the ring structures is coupled with R1, and R3 is a monovalent group including a hydrogen atom, a halogen atom, an alkyl group, an alkoxy group, and a carbonate group, or a derivative thereof.

Alternatively, according to the first embodiment, the second embodiment, and the third embodiment of the present disclosure including the preferable forms described above, the polymer compound (pre-alignment process compound) or a compound configuring at least one of the pair of alignment films (post-alignment process compound) may be formed by a compound including the group represented by Formula 2 as a side chain. Here, for convenience, such configurations are referred to as “the 1B configuration of the present disclosure, the 2B configuration of the present disclosure, and the 3B configuration of the present disclosure”.

—R11—R12—R13—R14 (2)

Here, R11 is a linear or branched divalent organic group with one or more and twenty or fewer carbon atoms, and preferably three or more and twelve or fewer carbon atoms including an ether group or an ester group which is coupled with the main chain of the polymer compound or the cross-linked compound (pre-alignment process compound or post-alignment process compound), or R11 is an ether group or an ester group which is coupled with the main chain of the polymer compound or the cross-linked compound (pre-alignment process compound or post-alignment process compound), R12 is, for example, a divalent group including any one type of structure out of chalcone, cinnamate, cinnamoyl, coumarin, maleimide, benzophenone, norbornene, oryzanol, and chitosan, or is an ethynylene group, R13 is a divalent organic group including a plurality of ring structures, and R14 is a monovalent group including a hydrogen atom, a halogen atom, an alkyl group, an alkoxy group, and a carbonate group, or a derivative thereof.

Alternatively, according to the first embodiment of the present disclosure including the preferable forms described above, the compound (post-alignment process compound) obtained by cross-linking the polymer compound (pre-alignment process compound) may be configured by a side chain and a main chain supporting the side chain with respect to the substrates, the side chain may be configured by a cross-linked portion coupled to the main chain and in which a portion of the side chain is cross-linked and a terminal structure portion coupled to the cross-linked portion, and a pretilt may be conferred by the liquid crystal molecules being along the terminal structure portion or being interposed by the terminal structure portion. Alternatively, according to the second embodiment of the present disclosure, the compound (post-alignment process compound) obtained by deforming the polymer compound (pre-alignment process compound) may be configured by a side chain and a main chain supporting the side chain with respect to the substrates, the side chain may be configured by a deformed portion coupled to the main chain and in which a portion of the side chain is deformed and a terminal structure portion coupled to the deformed portion, and a pretilt may be conferred by the liquid crystal molecules being along the terminal structure portion or being interposed by the terminal structure portion. Alternatively, according to the third embodiment of the present disclosure, the compound obtained by irradiating energy rays on the polymer compound may be configured by a side chain and a main chain supporting the side chain with respect to the substrates, the side chain may be configured by a cross-linked or deformed portion coupled to the main chain and in which a portion of the side chain is cross-linked or deformed and a terminal structure portion coupled to the cross-linked or deformed portion, and a pretilt may be conferred by the liquid crystal molecules being along the terminal structure portion or being interposed by the terminal structure portion. Here, for convenience, such configurations are referred to as “the 1C configuration of the present disclosure, the 2C configuration of the present disclosure, and the 3C configuration of the present disclosure”. In the 1C configuration of the present disclosure, the 2C configuration of the present disclosure, and the 3C configuration of the present disclosure, the terminal structure portion may include the form of a mesogenic group.

Alternatively, according to the first embodiment of the present disclosure including the preferable forms described above, the compound (post-alignment process compound) obtained by cross-linking the polymer compound (pre-alignment process compound) may be configured by a side chain and a main chain supporting the side chain with respect to the substrates, and the side chain may be configured by a cross-linked portion coupled to the main chain and in which a portion of the side chain is cross-linked and a terminal structure portion coupled to the cross-linked portion, including a mesogenic group. Here, for convenience, such a configuration is referred to as “the 1D configuration of the present disclosure”. Furthermore, in the 1D configuration of the present disclosure, the main chain and the cross-linked portion may be coupled through covalent coupling, and the cross-linked portion and the terminal structure portion may be coupled through covalent coupling. Alternatively, according to the second embodiment of the present disclosure, the compound (post-alignment process compound) obtained by deforming the polymer compound (pre-alignment process compound) may be configured by a side chain and a main chain supporting the side chain with respect to the substrates, the side chain may be configured by a deformed portion coupled to the main chain and in which a portion of the side chain is deformed and a terminal structure portion coupled to the deformed portion, including a mesogenic group. Here, for convenience, such a configuration is referred to as “the 2D configuration of the present disclosure”. Alternatively, according to the third embodiment of the present disclosure, the compound (post-alignment process compound) obtained by irradiating energy rays on the polymer compound (pre-alignment process compound) may be configured by a side chain and a main chain supporting the side chain with respect to the substrates, the side chain may be configured by a cross-linked or deformed portion coupled to the main chain and in which a portion of the side chain is cross-linked or deformed and a terminal structure portion coupled to the cross-linked or deformed portion, including a mesogenic group. Here, for convenience, such a configuration is referred to as “the 3D configuration of the present disclosure”.

According to the first embodiment of the present disclosure including the 1A configuration of the present disclosure to the 1D configuration of the present disclosure, the side chain (more specifically, the cross-linked portion) may include a photodimerized photosensitive group.

Furthermore, according to the first to third embodiments of the present disclosure including the preferable configurations and forms described above, a surface roughness Ra of the first alignment film may be equal to or less than 1 nm, or alternatively, the surface roughness Ra of at least one of the pair of alignment films may be equal to or less than 1 nm. Here, for convenience, such configurations are referred to as “the 1E configuration of the present disclosure, the 2E configuration of the present disclosure, and the 3E configuration of the present disclosure”. Here, the surface roughness Ra is regulated by JIS B 0601: 2001.

Furthermore, according to the first to third embodiments of the present disclosure including the preferable configurations and forms described above, the second alignment film may be formed of a polymer compound (pre-alignment process compound) configuring the first alignment film, or alternatively, the pair of alignment films may have the same composition. However, as long as the pair of alignment films are configured by the polymer compound (pre-alignment process compound) regulated by the first to third embodiments of the present disclosure, the pair of alignment films may have different compositions, or the second alignment film may be formed by a different polymer compound (pre-alignment process compound) from the polymer compound (pre-alignment process compound) configuring the first alignment film.

Furthermore, according to the first to third embodiments of the present disclosure including the preferable configurations and forms described above, an alignment regulation unit formed of a slit formed on an electrode or a protrusion provided on a substrate may be provided.

According to the first to third embodiments of the present disclosure including the preferable configurations and forms described above, the main chain may include imide bonds within repeating units. Further, the polymer compound (post-alignment process compound) may include a structure of arranging the liquid crystal molecules in a predetermined direction on the pair of substrates. Furthermore, the pair of substrates may be configured by a substrate including pixel electrodes and a substrate including opposing electrodes.

According to a liquid crystal display device according to embodiments of the present disclosure of a vertical alignment (VA) mode in which a pretilt is conferred on the liquid crystal molecules by the post-alignment process compound (cross-linked compound or deformed compound), it is considered that the distortion of the liquid crystal molecules on the alignment interface after the pretilt is conferred is large compared to liquid crystal display devices of other modes. Therefore, by including at least one type of compound represented by General Formula 101 or General Formula 102 in the liquid crystal layer, the large distortion of the liquid crystal molecules on the alignment interface after the pretilt is conferred is able to be relieved, as a result, the pretilt is able to be stabilized (high alignment stability) and the response speed is able to be improved further. Moreover, as a result of being able to relieve the large distortion in the liquid crystal molecules on the alignment interface after the pretilt is conferred, the occurrence of alignment defects is able to be suppressed, and a liquid crystal display device in which a decrease in the contrast does not easily occur is able to be provided.

Moreover, in the liquid crystal display device according to the first embodiment of the present disclosure, since at least one of the pair of alignment films includes a compound in which a polymer compound including a cross-linkable functional group is cross-linked as a side chain, a pretilt is conferred on the liquid crystal molecules by the cross-linked compound. Therefore, if an electric field is applied between the pixel electrodes and the opposing electrodes, the major axis direction of the liquid crystal molecules responds in a predetermined direction with respect to the substrate face, securing favorable display characteristics. In addition, since a pretilt is conferred on the liquid crystal molecules by the cross-linked compound, the response speed to the electric field between the electrodes is fast compared to a case where a pretilt is not conferred on the liquid crystal molecules, and it is easier to maintain favorable display characteristics compared to a case where the pretilt is conferred without using the cross-linked compound.

According to the method of manufacturing the liquid crystal display device according to the first embodiment of the present disclosure, after forming the first alignment film including the polymer compound including a cross-linkable functional group as a side chain, the liquid crystal layer is sealed between the first alignment film and the second alignment film. Here, the liquid crystal molecules within the liquid crystal layer are as a whole in a state of being arranged, by the first alignment film and the second alignment film, in a predetermined direction (for example, the horizontal direction, the vertical direction, or a diagonal direction) with respect to the surfaces of the first alignment film and the second alignment film. Next, the polymer compound is cross-linked by reacting the cross-linkable functional group while applying an electric field. In so doing, it is possible to confer a pretilt on the liquid crystal molecules in the vicinity of the cross-linked compound. That is, by cross-linking the polymer compound in a state in which the liquid crystal molecules are arranged, it is possible to confer a pretilt on the liquid crystal molecules even without irradiating linearly polarized light or light in a diagonal direction on the alignment films before sealing the liquid crystal layer and even without using a large-scale device. Therefore, the response speed is improved compared to a case where a pretilt is not conferred on the liquid crystal molecules.

In the liquid crystal display device according to the second embodiment of the present disclosure, since at least one of the pair of alignment films includes a compound in which a polymer compound including a photosensitive functional group as a side chain is deformed, a pretilt is conferred on the liquid crystal molecules by the deformed compound. Therefore, if an electric field is applied between the pixel electrodes and the opposing electrodes, the major axis direction of the liquid crystal molecules responds in a predetermined direction with respect to the substrate face, securing favorable display characteristics. In addition, since a pretilt is conferred on the liquid crystal molecules by the cross-linked compound, the response speed to the electric field between the electrodes is fast compared to a case where a pretilt is not conferred on the liquid crystal molecules, and it is easier to maintain favorable display characteristics compared to a case where the pretilt is conferred without using the deformed compound.

According to the method of manufacturing the liquid crystal display device according to the second embodiment of the present disclosure, after forming the first alignment film including the polymer compound including a photosensitive functional group as a side chain, the liquid crystal layer is sealed between the first alignment film and the second alignment film. Here, the liquid crystal molecules within the liquid crystal layer are as a whole in a state of being arranged, by the first alignment film and the second alignment film, in a predetermined direction (for example, the horizontal direction, the vertical direction, or a diagonal direction) with respect to the surfaces of the first alignment film and the second alignment film. Next, the polymer compound is deformed while applying an electric field. In so doing, it is possible to confer a pretilt on the liquid crystal molecules in the vicinity of the deformed compound. That is, by deforming the polymer compound in a state in which the liquid crystal molecules are arranged, it is possible to confer a pretilt on the liquid crystal molecules even without irradiating linearly polarized light or light in a diagonal direction on the alignment films before sealing the liquid crystal layer and even without using a large-scale device. Therefore, the response speed is improved compared to a case where a pretilt is not conferred on the liquid crystal molecules.

According to the method of manufacturing the liquid crystal display device according to the third embodiment of the present disclosure, a pretilt is conferred on the liquid crystal molecules by irradiating energy rays on the polymer compound (pre-alignment process compound). That is, by cross-linking or deforming the side chain of the polymer compound in a state in which the liquid crystal molecules are arranged, it is possible to confer a pretilt on the liquid crystal molecules even without irradiating linearly polarized light or light in a diagonal direction on the alignment films before sealing the liquid crystal layer and even without using a large-scale device. Therefore, the response speed is improved compared to a case where a pretilt is not conferred on the liquid crystal molecules.

### BRIEF DESCRIPTION OF THE DRAWINGS

FIG. 1 is a schematic partial cross-sectional view of a liquid crystal display device according to an embodiment of the present disclosure;

FIG. 2A is an outline view of a state in which the compound represented by General Formula 101 and the liquid crystal molecules are mixed seen as if from the horizontal direction, FIG. 2B is an outline view of a state in which the compound represented by General Formula 102 and the liquid crystal molecules are mixed seen as if from the horizontal direction, and FIG. 2C is an outline view of a state in which the compound represented by General Formula 102 and the liquid crystal molecules are mixed seen as if from above;

FIG. 3 is a schematic view for describing the pretilt of the liquid crystal molecules;

FIG. 4 is a flowchart for describing a method of manufacturing the liquid crystal display device illustrated in FIG. 1;

FIG. 5 is a schematic view representing the state of the polymer compound (pre-alignment process compound) within the alignment films for describing a method of manufacturing the liquid crystal display device illustrated in FIG. 1;

FIG. 6 is a schematic partial cross-sectional view of the substrates and the like for describing a method of manufacturing the liquid crystal display device illustrated in FIG. 1;

FIG. 7 is a schematic partial cross-sectional view of the substrates and the like for describing the process following FIG. 6;

FIGS. 8A and 8B are respectively a schematic partial cross-sectional view of the substrates and the like for describing the process following FIG. 7 and a schematic view representing the state of the polymer compound (post-alignment process compound) within the alignment films;

FIG. 9 is a circuit configuration view of the liquid crystal display device illustrated in FIG. 1;

FIGS. 10A and 10B are cross-sectional schematic views for describing order parameters;

FIG. 11 is a schematic partial cross-sectional view of a modification example of a liquid crystal display device of an embodiment of the present disclosure;

FIG. 12 is a schematic partial cross-sectional view of a modification example of the liquid crystal display device illustrated in FIG. 11;

FIG. 13 is a schematic partial cross-sectional view of another modification example of a liquid crystal display device of an embodiment of the present disclosure;

FIG. 14 is an outline view describing the relationship between a cross-linked polymer compound and the liquid crystal molecules; and

FIG. 15 is an outline view describing the relationship between a deformed polymer compound and the liquid crystal molecules.

### DETAILED DESCRIPTION OF EMBODIMENTS

Here, while the embodiments of the present disclosure will be described below based on the embodiments of the technology and examples with reference to the drawings, the embodiments of the present disclosure are not limited by the embodiments of the technology and examples, and the various numerical values and materials in the embodiments of the technology and examples are examples. Here, description will be given in the following order.

### 1. Description Relating to Common Configurations and Structures in Liquid Crystal Display Device of Embodiment of Present Disclosure

### 2. Description of Liquid Crystal Display Device of Embodiment of Present Disclosure and Method of Manufacturing Same Based on Embodiments of Technology

### 3. Description of Liquid Crystal Display Device of Embodiment of Present Disclosure and Method of Manufacturing Same Based on Examples, So Forth

### Description Relating to Common Configurations and Structures in Liquid Crystal Display Device (Liquid Crystal Display Element) of Embodiment of Present Disclosure

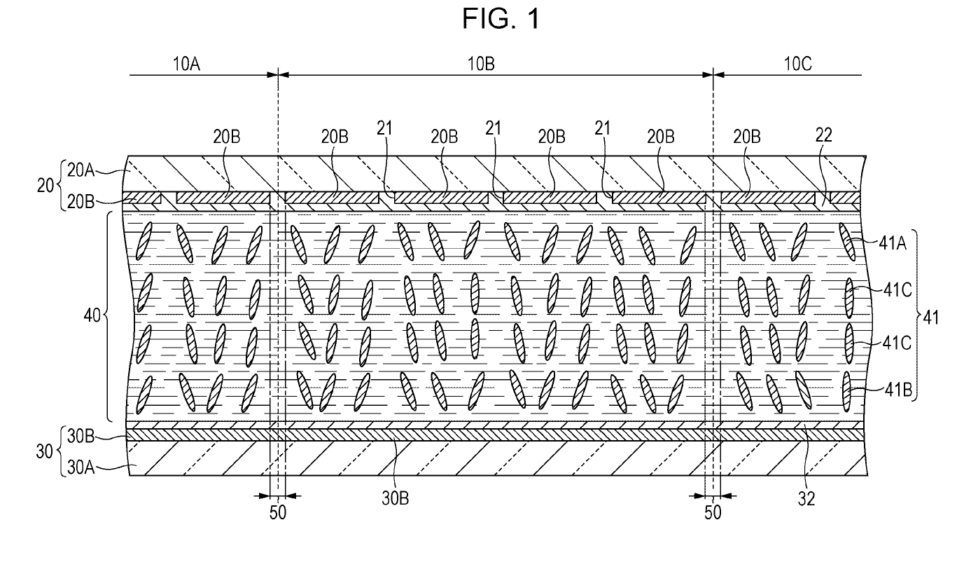

A schematic partial cross-sectional view of the liquid crystal display device (or liquid crystal display element) according to the first to third embodiments of the present disclosure is illustrated in FIG. 1. The liquid crystal display device includes a plurality of pixels 10 (10A, 10B, 10C . . . ). In the liquid crystal display device (liquid crystal display element), a liquid crystal layer 40 including liquid crystal molecules 41 with negative dielectric constant anisotropy is provided between a TFT (Thin Film Transistor) substrate 20 and a CF (Color Filter) substrate 30 via alignment films 22 and 32.

The liquid crystal layer 40 further includes at least one type of a compound represented by General Formula 101 which is a molecule with a three-dimensional shape (molecule with a three-dimensional spread) or a compound represented by General Formula 102 which is a molecule with a planar shape (molecule with a planar spread), or the General Formula 102 which is a molecule with a three-dimensional shape (molecule with a three-dimensional shape). Here, for convenience, the compound represented by General Formula 101 or General Formula 102 is referred to as the “pretilt stability conferring compound”. In a case where the “A” in General Formula 102 is a cyclohexane ring, the molecule has a three-dimensional shape (molecule with a three-dimensional spread). Further, in a case where the “A” in General Formula 102 is a benzene ring, generally, the molecule has a planar shape (molecule with a planar spread).

In such a manner, the liquid crystal layer 40 is a system in which the liquid crystal molecules 41 with negative dielectric constant anisotropy and the pretilt stability conferring compound are mixed. Here, the liquid crystal molecules 41 normally include a mesogenic skeleton. The liquid crystal display device (liquid crystal display element) is a so-called transmission type, and the display mode is the vertical alignment (VA) mode. In FIG. 1, a non-driving state in which a driving voltage is not applied is represented.

Formulae 101A to 101F as specific examples of the compound of General Formula 101 and Formulae 102-A to 102-E as specific examples of the compound of General Formula 102 are shown below.

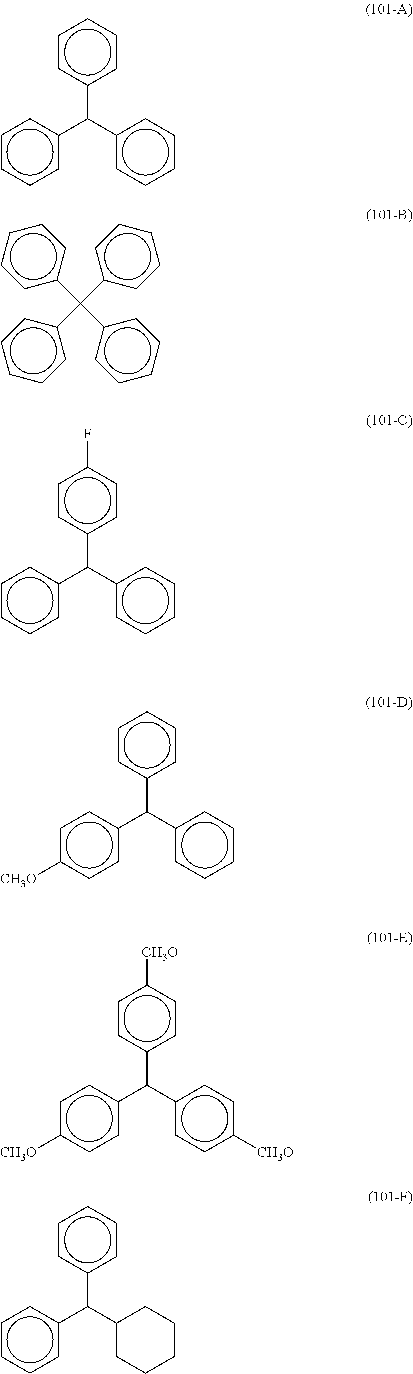

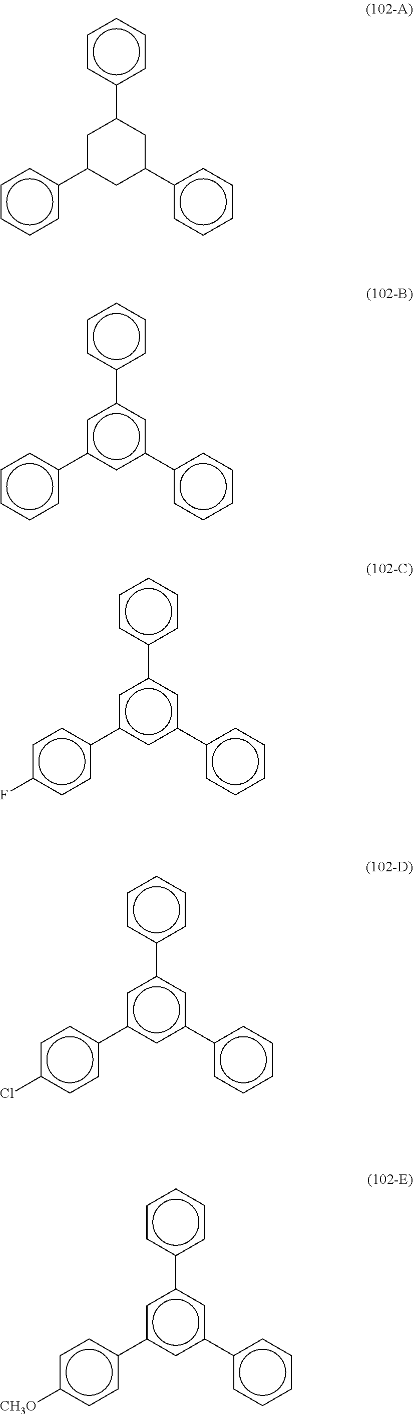

Below, a pretilt stability conferring compound 42 with a three-dimensional shape (pretilt stability conferring compound 42 with a three-dimensional spread) which is the compound (molecule) represented by General Formula 101 or General Formula 102 will be described.

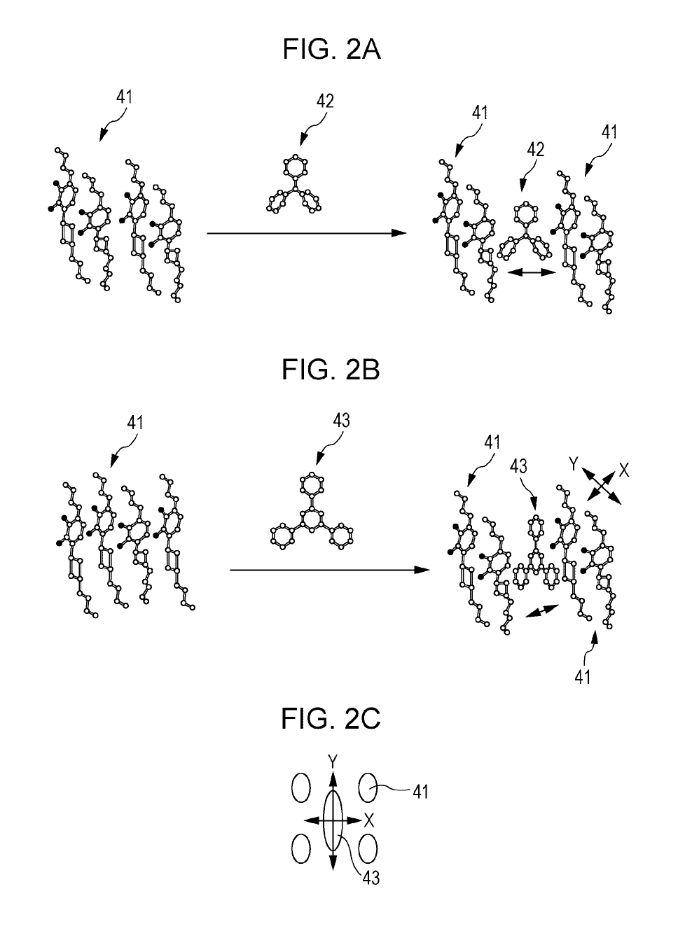

As an outline view is illustrated in FIG. 2A, by the pretilt stability conferring compound 42 with a three-dimensional shape entering between a type of bar-like liquid crystal molecules 41 in the liquid crystal layer 40, the mutual alignment correlation between each of the liquid crystal molecules 41 is somewhat weakened. Here, FIG. 2A is an outline view of a state in which the pretilt stability conferring compound 42 with a three-dimensional shape and the liquid crystal molecules 41 are mixed seen as if from the horizontal direction. That is, if the pretilt stability conferring compound 42 with a three-dimensional shape is present between a liquid crystal molecule 41 and another liquid crystal molecule 41, the alignment correlation between the liquid crystal molecules 41 is weakened. That is, in a case where the distortion of the liquid crystal molecules 41 in the vicinity of the alignment film interface after the pretilt is conferred is large, while the distortion is relieved by the three-dimensionally shaped pretilt stability conferring compound 42 entering, since the distortion is large to start with, even if the distortion is relieved, there is no particular problem with the alignment stability of the liquid crystal molecules 41 in the vicinity of the alignment film interface. On the other hand, by the distortion being relieved, it is considered that alignment change in the external response of the liquid crystal molecules 41 is made smooth. Furthermore, as a result of the above, the alignment stability improves (pretilt stability), and the response speed is improved due to the improvement in the smoothness of the alignment change, and excellent response characteristics are obtained. Further, the occurrence of alignment defects is suppressed by the alignment distortion being relieved, preventing a decrease in the contrast.

The substituent in R¹ or R² of the pretilt stability conferring compound 42 with a three-dimensional shape is preferably at least one type selected from a group consisting of a halogen atom, a hydrocarbon group with one to eight carbon atoms, and an alkoxy group with one to six carbon atoms, and furthermore, the halogen atom is preferably in the form of a fluorine atom or a chlorine atom with which a liquid crystal layer with high specific resistance and excellent reliability is able to be obtained, and a fluorine atom is even more preferable. However, in the pretilt stability conferring compound 42 with a three-dimensional shape, the number of halogen elements is preferably one to twelve. If the number of halogen elements is too large, as a result of the crystallinity of the pretilt stability conferring compound 42 with a three-dimensional shape improving, there is a concern that compatibility with the liquid crystal molecules deteriorates.

By the pretilt stability conferring compound 42 with a three-dimensional shape not including constituent elements other than C, H, O, and halogens, heat resistance and light resistance are excellent, and specific resistance is high. By heat resistance being excellent and specific resistance being high, a high voltage retention rate is able to be maintained even at high temperature. Further, since the light resistance is excellent, there are no problems in the light irradiation process (for example, pasting and sealing of the liquid crystal injection opening using a sealant cured through light irradiation, and creation of an optically alignment film regulating the alignment direction through light irradiation) during the manufacturing of the liquid crystal display device, and high resistance to external light is able to be conferred on the liquid crystal display device. In such a manner, since light resistance with respect to visible light and ultraviolet light is excellent, even if strong light is irradiated on the liquid crystal layer, disintegration or isomerization of the materials configuring the liquid crystal layer do not occur, and it is possible to maintain a high specific resistance. Alternatively, as the substituent in the pretilt stability conferring compound 42 with a three-dimensional shape, a substituent including fluorine atoms such as a trifluoro group, a difluoromethoxy group, or a trifluoromethoxy group is preferable. Since a fluorine-containing-based molecule including such substituents has high specific resistance, a high voltage retention rate is able to be maintained even at high temperature. Moreover, a fluorine-containing-based molecule has low viscosity, and the response speed is able to be improved.

Here, for a pretilt stability conferring compound 42 with a three-dimensional shape in which the “A” is a cyclohexane ring, the total number of phenyl groups and cyclohexyl groups is preferably three or four. Further, in the pretilt stability conferring compound 42 with a three-dimensional shape, R¹ may be a phenyl group or a phenyl group substituted by a cyclohexyl group, or alternatively, may be a phenyl group or a cyclohexyl group substituted by a cyclohexyl group. However, in such case, the total number of phenyl groups and cyclohexyl groups in R¹ is preferably three to eight. Further, in a case where the “A” is a cyclohexane ring in the pretilt stability conferring compound 42 with a three-dimensional shape, R² may be a phenyl group or a phenyl group substituted by a cyclohexyl group, or may be a phenyl group or a cyclohexyl group substituted by a cyclohexyl group. However, in such cases, the total number of phenyl groups and cyclohexyl groups in R² is preferably four to seven. The molecular weight of the pretilt stability conferring compound 42 with a three-dimensional shape is preferably equal to or greater than 200, and in so doing, volatility when injecting the liquid crystal material during the manufacture of the liquid crystal display device is able to be suppressed, the component ratio of the liquid crystal material does not easily change, and changes in the response characteristics of the liquid crystal molecules are able to be suppressed.

Next, a pretilt stability conferring compound 43 with a planar shape (pretilt stability conferring compound 43 with a planar spread) which is the compound (molecule) represented by General Formula 101 or General Formula 102 will be described. Here, in pretilt stability conferring compound 43 with a planar shape, both R² and “A”, of which there are m, exist on the same plane. More specifically, the pretilt stability conferring compound 43 with a planar shape making the alignment change of the liquid crystal molecules smoother is a compound represented by General Formula 102 in which “A” is a benzene ring.

As outline views are illustrated in FIGS. 2B and 2C, by the pretilt stability conferring compound 43 with a planar shape entering between a type of bar-like liquid crystal molecules 41 in the liquid crystal layer 40, the mutual alignment correlation between each of the liquid crystal molecules 41 is somewhat weakened. Here, FIG. 2B is an outline view of a state in which the pretilt stability conferring compound 43 with a planar shape and the liquid crystal molecules 41 are mixed seen as if from the horizontal direction, and FIG. 2C is an outline view of a state in which the pretilt stability conferring compound 43 with a planar shape and the liquid crystal molecules 41 are mixed seen as if from above. That is, if the pretilt stability conferring compound 43 with a planar shape is present between a liquid crystal molecule 41 and another liquid crystal molecule 41, the alignment correlation between the liquid crystal molecules 41 is weakened. That is, in a case where the distortion of the liquid crystal molecules 41 in the vicinity of the alignment film interface after the pretilt is conferred is large, while the distortion is relieved by the planar-shaped pretilt stability conferring compound 43 entering, since the distortion is large to start with, even if the distortion is relieved, there is no particular problem with the alignment stability of the liquid crystal molecules 41 in the vicinity of the alignment film interface. On the other hand, by the distortion being relieved, it is considered that alignment change in the external response of the liquid crystal molecules 41 is made smooth. Furthermore, as a result of the above, the alignment stability improves (pretilt stability), and the response speed is improved due to the improvement in the smoothness of the alignment change, and excellent response characteristics are obtained. Further, the occurrence of alignment defects is suppressed by the alignment distortion being relieved, preventing a decrease in the contrast.

That is, as illustrated in FIGS. 2B and 2C, if the pretilt stability conferring compound 43 with a planar shape enters between the liquid crystal molecules 41, a space that is wider in the Y direction compared to the X direction is generated. While the detailed mechanism is not clear, by such an anisotropic space being generated, it is considered that distortion is relieved and the alignment stability of the liquid crystal molecules 41 in the vicinity of the alignment film interface after the pretilt is conferred is able to be improved. Further, by the distortion being relieved, it is considered that alignment change in the external response of the liquid crystal molecules 41 is made smooth. Furthermore, as a result of the above, the alignment stability improves (pretilt stability), and the response speed is improved due to the improvement in the smoothness of the alignment change, and excellent response characteristics are obtained.

The substituent in R³ of the pretilt stability conferring compound 43 with a planar shape is preferably at least one type selected from a group consisting of a halogen atom, a hydrocarbon group with one to eight (preferably six) carbon atoms, and an alkoxy group with one to six carbon atoms, and furthermore, the halogen atom is preferably in the form of a fluorine atom or a chlorine atom with which a liquid crystal layer with high specific resistance and excellent reliability is able to be obtained, and a fluorine atom is even more preferable. However, in the pretilt stability conferring compound 43 with a planar shape, the number of halogen elements is preferably one to six. If the number of halogen elements is too large, as a result of the crystallinity of the pretilt stability conferring compound 43 with a planar shape improving, there is a concern that compatibility with the liquid crystal molecules deteriorates.

By the pretilt stability conferring compound 43 with a planar shape not including constituent elements other than C, H, O, and halogens, heat resistance and light resistance are excellent, and specific resistance is high. By heat resistance being excellent and specific resistance being high, a high voltage retention rate is able to be maintained even at high temperature. Further, since the light resistance is excellent, there are no problems in the light irradiation process (for example, pasting and sealing of the liquid crystal injection opening using a sealant cured through light irradiation, and creation of an optically alignment film regulating the alignment direction through light irradiation) during the manufacturing of the liquid crystal display device, and high resistance to external light is able to be conferred on the liquid crystal display device. In such a manner, since light resistance with respect to visible light and ultraviolet light is excellent, even if strong light is irradiated on the liquid crystal layer, disintegration or isomerization of the materials configuring the liquid crystal layer do not occur, and it is possible to maintain a high specific resistance. Alternatively, as the substituent in the pretilt stability conferring compound 43 with a planar shape, a substituent including fluorine atoms such as a trifluoro group, a difluoromethoxy group, or a trifluoromethoxy group is preferable. Since a fluorine-containing-based molecule including such substituents has high specific resistance, a high voltage retention rate is able to be maintained even at high temperature. Moreover, a fluorine-containing-based molecule has low viscosity, and the response speed is able to be improved.

Here, for the pretilt stability conferring compound 43 with a planar shape (in which the “A” is a benzene ring as described above), the total number of phenyl groups and cyclohexyl groups is preferably four. Further, in the pretilt stability conferring compound 43 with a planar shape, R² may be a phenyl group or a phenyl group substituted by a cyclohexyl group, or alternatively may be a phenyl group or a cyclohexyl group substituted by a cyclohexyl group. However, in such cases, the total number of phenyl groups and cyclohexyl groups as substituents in R² is preferably four to seven. Further, the molecular weight of the pretilt stability conferring compound 43 with a planar shape is preferably equal to or greater than 200, and in so doing, volatility when injecting the liquid crystal material during the manufacture of the liquid crystal display device is able to be suppressed, the component ratio of the liquid crystal material does not easily change, and changes in the response characteristics of the liquid crystal molecules are able to be suppressed.

On the TFT substrate 20, plurality of pixel electrodes 20B are arranged in a matrix pattern, for example, on the surface of a glass substrate 20A opposing the CF substrate 30. Furthermore, TFT switching elements including a gate, a source, a drain, and the like respectively driving the plurality of pixel electrodes 20B, and gate lines, sources lines, and the like (not shown) connected to the TFT switching elements are provided. A pixel electrode 20B is provided for each pixel electrically separated on the glass substrate 20A by a pixel separation unit 50, and is configured by a material with transparency such as, for example, ITO (Indium Tin Oxide). Slit portions 21 (portions on which there are no electrodes formed) with a striped or V-shaped pattern, for example, are provided within each pixel on the pixel electrodes 20B. In so doing, when a driving voltage is applied, since a diagonal electric field is conferred on the major axis direction of the liquid crystal molecules 41 and a region with a different alignment direction is formed within the pixel (alignment division), the viewing angle characteristics are improved. That is, the slit portions 21 are alignment regulation units for regulating the alignment of the whole of the liquid crystal molecules 41 within the liquid crystal layer 40 in order to secure favorable display characteristics, and here, the alignment direction of the liquid crystal molecules 41 when the driving voltage is applied is regulated by the slit portions 21. As described above, fundamentally, the azimuth of the liquid crystal molecules when a pretilt is conferred is regulated by the direction of the electric field, and the direction of the electric field is determined by the alignment regulation unit.

On the CF substrate 30, a color filter (not shown) configured by striped filters of red (R), green (G), and blue (B), for example, and opposing electrodes 30B are arranged across approximately the entire face of the effective display region on the opposing face of a glass substrate 30A with respect to the TFT substrate 20. Similarly to the pixel electrodes 20B, the opposing electrodes 30B are configured by a material with transparency such as, for example, ITO.

An alignment film 22 is provided to cover the pixel electrodes 20B and the slit portions 21 on the surface of the TFT substrate 20 on the liquid crystal layer 40 side. An alignment film 32 is provided on the surface of the CF substrate 30 on the liquid crystal layer 40 side to cover the opposing electrodes 30B. The alignment films 22 and 32 regulate the alignment of the liquid crystal molecules 41, and here, along with aligning the liquid crystal molecules 41 in the vertical direction with respect to the substrate face, have the function of conferring a pretilt to the liquid crystal molecules 41 (41A, 41B) in the vicinity of the substrates. Here, in the liquid crystal display device (liquid crystal display element) illustrated in FIG. 1, no slit portions are provided on the side of the CF substrate 30.

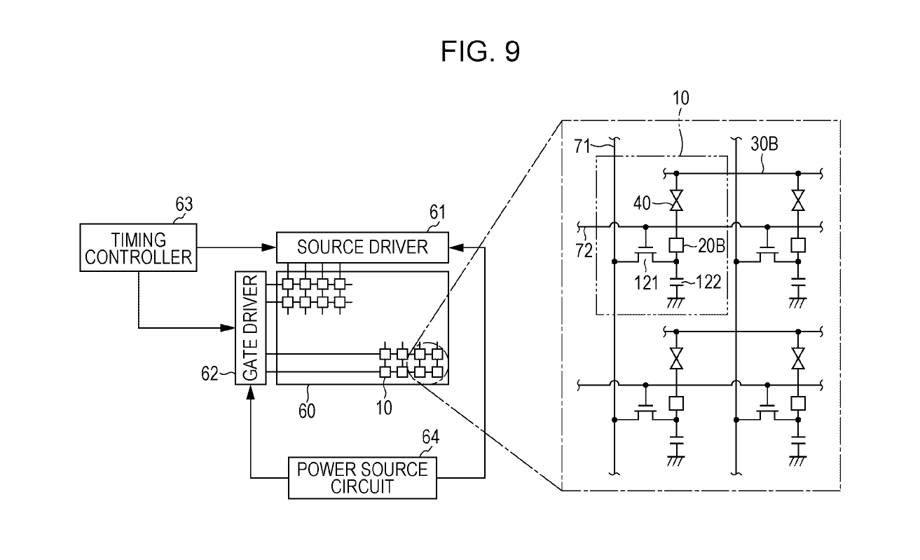

FIG. 9 represents the circuit configuration of the liquid crystal display device illustrated in FIG. 1.

As illustrated in FIG. 9, the liquid crystal display device is configured including a liquid crystal display element including the plurality of pixels 10 provided in a display region 60. In the liquid crystal display device, a source driver 61 and a gate driver 62, a timing controller 63 controlling the source driver 61 and the gate driver 62, and a power source circuit 64 supplying electrical power to the source driver 61 and the gate driver 62 are provided around the display region 60.

The display region 60 is a region on which a picture is displayed, and is a region configured so that a picture is displayable by a plurality of pixels 10 being arranged in a matrix pattern. Here, in FIG. 9, in addition to the display region 60 including the plurality of pixels 10 being illustrated, regions corresponding to four pixels 10 are illustrated separately, enlarged.

On the display region 60, a plurality of source lines 71 are arranged in the row direction and a plurality of gate lines 72 are arranged in the column direction, and the pixels 10 are respectively arranged at positions where the source lines 71 and the gate lines 72 intersect one another. Along with the pixel electrodes 20B and the liquid crystal layer 40, each pixel 10 includes a transistor 121 and a capacitor 122. In each transistor 121, the source electrode is connected to the source line 71, the gate electrode is connected to the gate line 72, and the drain electrode is connected to the capacitor 122 and the pixel electrode 20B. Each source line 71 is connected to the source driver 61, and an image signal is supplied from the source driver 61. Each gate line 72 is connected to the gate driver 62, and a scanning signal is sequentially supplied from the gate driver 62.

The source driver 61 and the gate driver 62 select specific pixels 10 from the plurality of pixels 10.

The timing controller 63 outputs, for example, an image signal (for example, each picture signal of RGB corresponding to red, green, and blue) and a source driver control signal for controlling the action of the source driver 61 to the source driver 61. Further, the timing controller 63 outputs a gate driver control signal for controlling the action of the gate driver 62, for example, to the gate driver 62. Examples of the source driver control signal include, for example, a horizontally synchronized signal, a start pulse signal, a clock signal for the source driver, and the like. Examples of the gate driver control signal include, for example, a vertically synchronized signal, a clock signal for the gate driver, and the like.

In the liquid crystal display device, a picture is displayed by a driving voltage being applied between the pixel electrodes 20B and the opposing electrodes 30B in the following manner. Specifically, the source driver 61 supplies, through the input of the source driver control signal from the timing controller 63, individual image signals to predetermined source lines 71 based on image signals input similarly from the timing controller 63. In addition, the gate driver 62 sequentially supplies a scanning signal to a gate line 72 at a predetermined timing through the input of the gate driver control signal from the timing controller 63. In so doing, a pixel 10 positioned at the intersection point between the source line 71 to which an image signal is supplied and the gate line 72 to which a scanning signal is supplied is selected, and a driving voltage is applied to the pixel 10.

Embodiments of the present disclosure will be described below based on the embodiments of the technology (shortened “embodiments”) and examples.

### Embodiment 1

Embodiment 1 relates to a VA mode liquid crystal display device (or liquid crystal display element) according to the first embodiment of the present disclosure and a method of manufacturing the liquid crystal display device (or liquid crystal display element) according to the first and third embodiments of the present disclosure. According to Embodiment 1, the alignment films 22 and 32 include one type or two or more types of a polymer compound (post-alignment process compound) with a cross-linked structure as a side chain. Furthermore, a pretilt is conferred on the liquid crystal molecules 41 by the cross-linked compound. Here, the post-alignment process compound is generated by forming the alignment films 22 and 32 in a state of including one type or two or more types of a polymer compound (pre-alignment process compound) including a main chain and a side chain, providing the liquid crystal layer 40, and cross-linking the polymer compound, or alternatively, by irradiating energy rays on the polymer compound, more specifically, by reacting the cross-linkable functional group included in the side chain while applying an electric field or a magnetic field. Furthermore, the post-alignment process compound includes a structure of arranging the liquid crystal molecules 41 in a predetermined direction (specifically, a diagonal direction) with respect to a pair of substrates (specifically, the TFT substrate 20 and the CF substrate 30). In such a manner, since a pretilt is conferred on the liquid crystal molecules 41 in the vicinity of the alignment films 22 and 32 by cross-linking the polymer compound, or alternatively, by the post-alignment process compound being included in the alignment films 22 and 32 by irradiating the polymer compound with energy rays, the response speed is hastened, and the display characteristics are improved.

The pre-alignment process compound preferably includes a structure with high heat resistance as the main chain. In so doing, even when the liquid crystal display device (liquid crystal display element) is exposed to a high temperature environment, since the post-alignment process compound within the alignment films 22 and 32 maintain an alignment regulation function with respect to the liquid crystal molecules 41, display characteristics such as the contrast are also favorably maintained in addition to the response characteristics, and reliability is secured. Here, the main chain preferably includes imide bonds within repeating units. Examples of a pre-alignment process compound including imide bonds in the main chain include, for example, a polymer compound including the polyimide structure represented by Formula 3. The polymer compound including the polyimide structure illustrated in Formula 3 may be configured by one type out of the polyimide structure shown in Formula 3, a plurality of types may be included being randomly linked, or structures other than the structure shown in Formula 3 may be included.

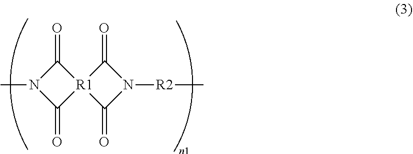

Here, R1 is a quadrivalent organic group, R2 is a divalent organic group, and n1 is an integer equal to or greater than 1.

While R1 and R2 in Formula 3 are arbitrary as long as R1 and R2 are quadrivalent and divalent groups configured to include carbon, a cross-linkable functional group is preferably included as a side chain on one of R1 and R2. The reason is that a sufficient alignment regulation function in the post-alignment process compound is then more easily obtained.

Further, in the pre-alignment process compound, a plurality of side chains are coupled to the main chain, and at least one of the plurality of side chains may include a cross-linkable functional group. That is, the pre-alignment process compound may include side chains with no cross-linkability other than a side chain with cross-linkability. There may be one type or a plurality of types of side chains including a cross-linkable functional group. While the cross-linkable functional group is arbitrary as long as the cross-linkable functional group is a functional group that is able to cross-link react after forming the liquid crystal layer 40, and may be a group forming a cross-linked structure through an optical reaction or a group forming a cross-linked structure through a thermal reaction, among the above, an optically reactive cross-linkable functional group (photosensitive group with photosensitivity) forming a cross-linked structure through an optical reaction is preferable. The reason is that it is easy to regulate the alignment of the liquid crystal molecules 41 in a predetermined direction, the response characteristics are improved, and the manufacture of the liquid crystal display device (liquid crystal display element) with favorable display characteristics is easy.

An example of an optically reactive cross-linkable functional group (a photosensitive group with photosensitivity, for example, a photodimerized photosensitive group) is a group including any one type of structure out of, for example, chalcone, cinnamate, cinnamoyl, coumarin, maleimide, benzophenone, norbornene, oryzanol, and chitosan. Of the above, an example of a group including a chalcone, cinnamate, or cinnamoyl structure is the group represented by Formula 41. When the pre-alignment process compound including the side chain including the group shown in Formula 41 is cross-linked, the structure shown in Formula 42, for example, is formed. That is, the post-alignment process compound generated from a polymer compound including the group shown in Formula 41 includes the structure shown in Formula 42 with a cyclobutane skeleton. Here, for example, an optically reactive cross-linkable functional group such as maleimide may exhibit not only a photodimerization reaction, but in some cases, may also exhibit a polymerization reaction. Therefore, “cross-linkable functional group” includes not only a cross-linkable functional group exhibiting a photodimerization reaction but also a cross-linkable functional group exhibiting a polymerization reaction. In other words, according to the embodiments of the present disclosure, the concept of “cross-link” includes not only photodimerization reactions but also polymerization reactions.

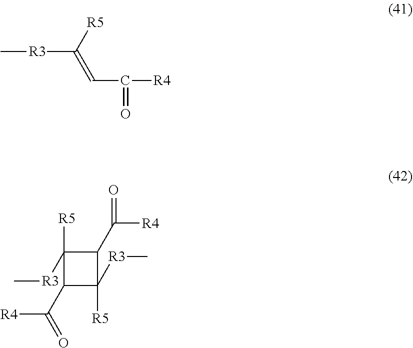

Here, R3 is a divalent group including an aromatic ring, R4 is a monovalent group including one or two or more ring structures, and R5 is a hydrogen atom, an alkyl group, or a derivative thereof.

R3 in Formula 41 is arbitrary as long as R3 is a divalent group including an aromatic ring such as a benzene ring, and in addition to the aromatic ring, a carbonyl group, an ether bond, an ester bond, or a hydrocarbon group may be included. Further R4 in Formula 41 is arbitrary as long as R4 is a monovalent group including one or two or more ring structures, and in addition to the ring structure, a carbonyl group, an ether bond, an ester bond, a hydrocarbon group, a halogen atom, or the like may be included. The ring structure that R4 includes is arbitrary as long as the ring structure is a ring including carbon as the element configuring the skeleton, and examples of the ring structure include an aromatic ring, a heterocyclic ring, an aliphatic ring, a ring structure in which the above are linked or condensed, and the like. R5 in Formula 41 is arbitrary as long as R5 is a hydrogen atom or an alkyl group or a derivative thereof. Here, “derivative” refers to a group in which a portion or the whole of the hydrogen atoms that the alkyl group includes is substituted by a substituent such as a halogen atom. Further, the number of carbon atoms in the alkyl group introduced as R5 is arbitrary. A hydrogen atom or a methyl group is preferable as R5. The reason is that favorable cross-linking reactivity is then obtained.

Each R3 in Formula 42 may be the same or different from one another. The same is also true of each R4 and each R5 in Formula 41. Examples of R3, R4, and R5 in Formula 42 include those that are the same as R3, R4, and R5 in Formula 41 described above.

Examples of the groups shown in Formula 41 include the groups represented by Formulae 41-1 to 41-27. However, as long as the group is a group including the structure shown in Formula 41, the group is not limited to the groups shown in Formulae 41-1 to 41-27.

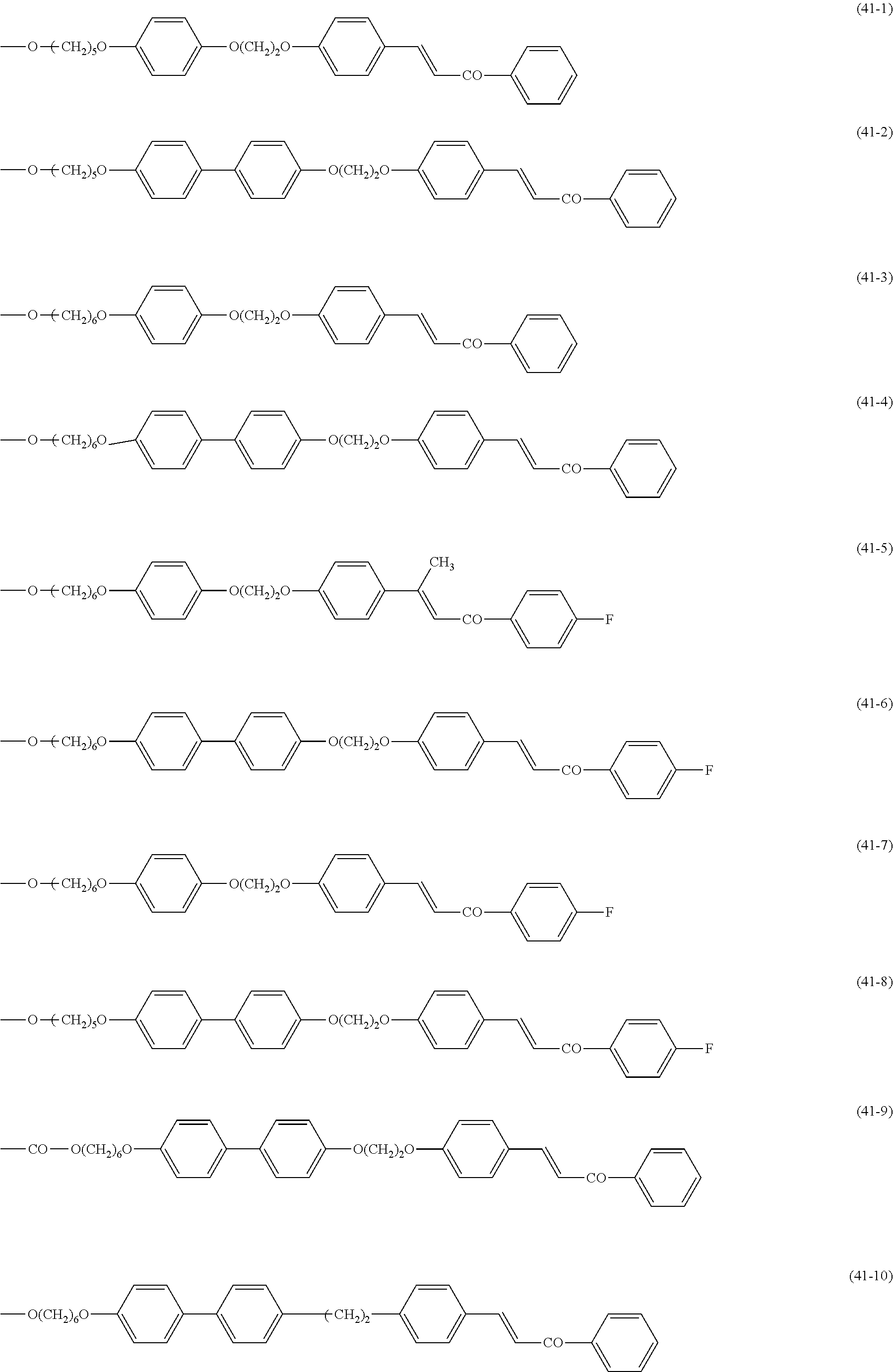

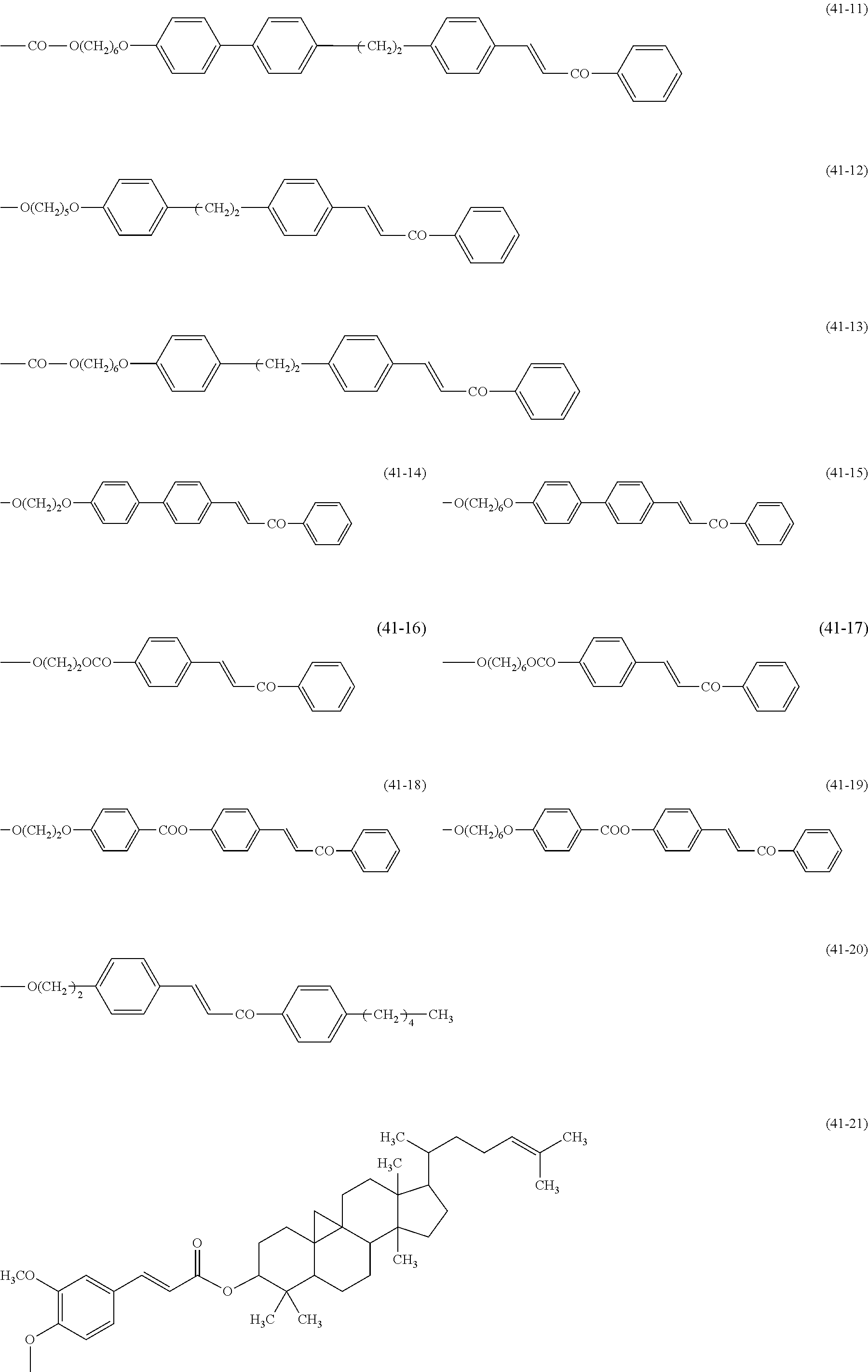

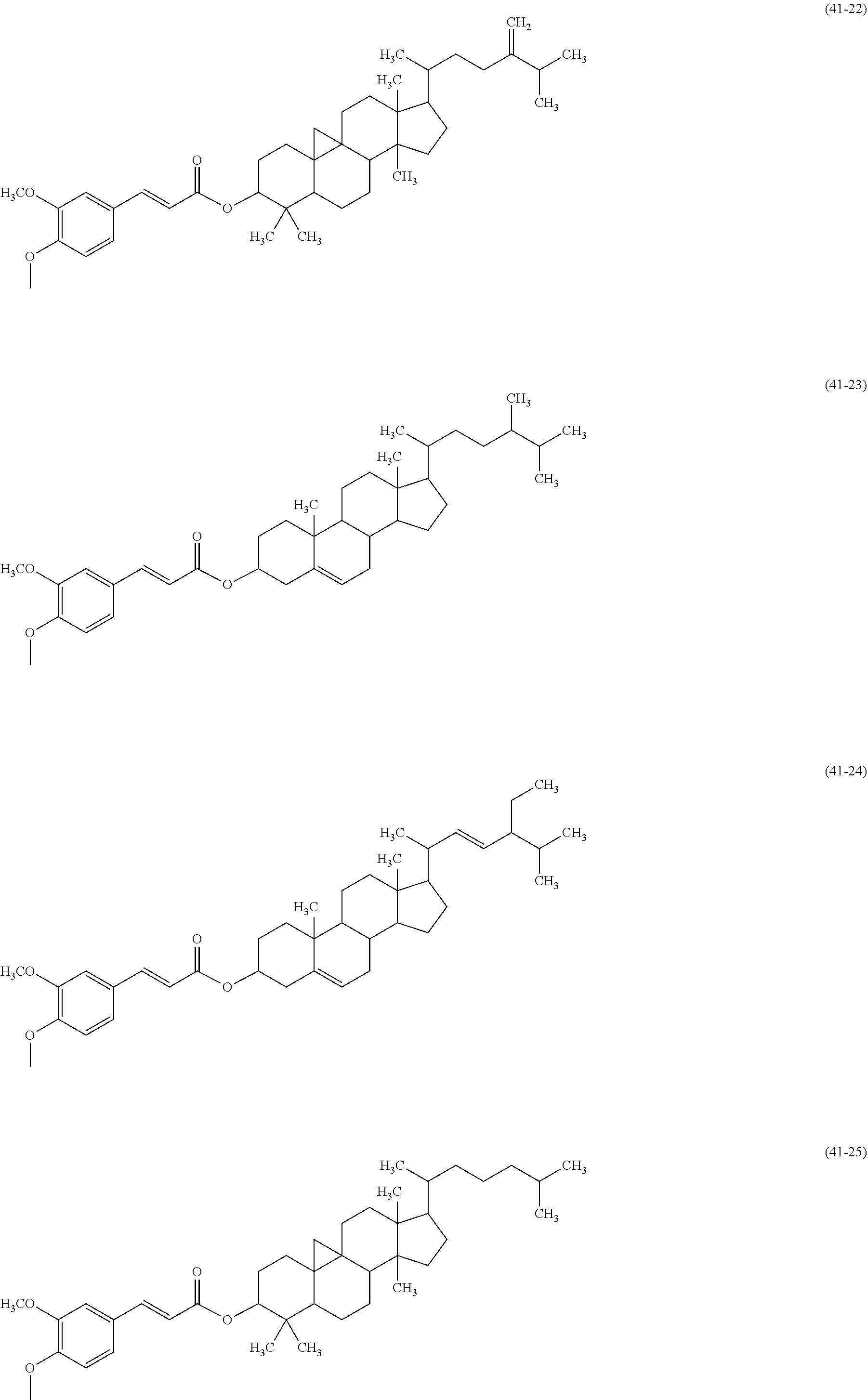 [SMILES: C=C(CCC(C)C1CCC2(C)C3CCC4C(C)(C)C(OC(=O)/C=C/c5ccc(OC)c(OC)c5)CCC45CC35CCC12C)C(C)C ; COc1ccc(/C=C/C(=O)OC2CCC3(C)C(=CCC4C3CCC3(C)C(C(C)CCC(C)C(C)C)CCC43)C2)cc1OC ; CCC(/C=C/C(C)C1CCC2C3CC=C4CC(OC(=O)/C=C/c5ccc(OC)c(OC)c5)CCC4(C)C3CCC12C)C(C)C ; COc1ccc(/C=C/C(=O)OC2CCC34CC35CCC3(C)C(C(C)CCCC(C)C)CCC3(C)C5CCC4C2(C)C)cc1OC]

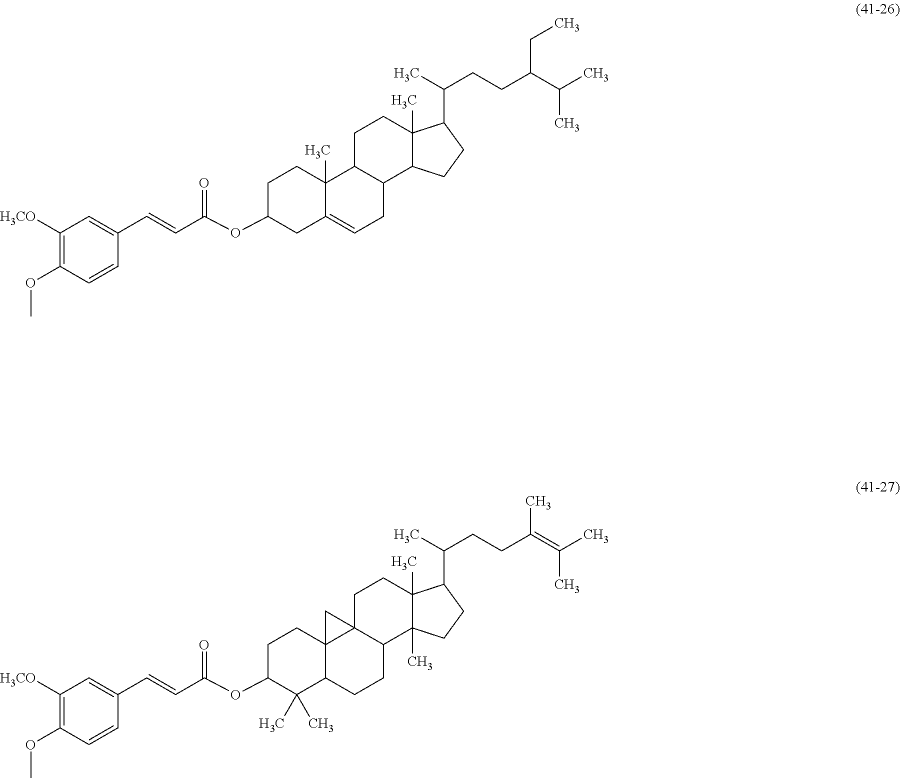 [SMILES: CCC(CCC(C)C1CCC2C3CC=C4CC(OC(=O)/C=C/c5ccc(OC)c(OC)c5)CCC4(C)C3CCC12C)C(C)C ; COc1ccc(/C=C/C(=O)OC2CCC34CC35CCC3(C)C(C(C)CCC(C)=C(C)C)CCC3(C)C5CCC4C2(C)C)cc1OC]

The pre-alignment process compound preferably includes a structure for aligning the liquid crystal molecules 41 in the vertical direction with respect to the substrate faces (hereinafter referred to as a “vertical alignment inducing structure portion”). The reason is that even if the alignment films 22 and 32 do not include a compound including a vertical alignment inducing structure portion separately from the post-alignment process compound (so-called normal vertical alignment agent), alignment regulation of the whole of the liquid crystal molecules 41 is possible. Moreover, the reason is that alignment films 22 and 32 that are able to exhibit a more even alignment regulation function with respect to the liquid crystal layer 40 are more easily formed than in a case where a compound including a vertical alignment inducing structure portion is separately included. In the pre-alignment process compound, the vertical alignment inducing structure portion may be included in the main chain, may be included in a side chain, or may be included in both. Further, in a case where the pre-alignment process compound includes the polyimide structure shown in Formula 3 described above, the two types of structures of a structure including the vertical alignment inducing structure portion as R2 (repeating units) and a structure including a cross-linkable functional group as R2 (repeating units) are preferably included. The reason is that such structures are easily obtainable. Here, if the vertical alignment inducing structure portion is included in the pre-alignment process compound, the vertical alignment inducing structure portion is also included in the post-alignment process compound.

Examples of the vertical alignment inducing structure portion include an alkyl group with ten or more carbon atoms, an alkyl halide group with ten or more carbon atoms, an alkoxy group with ten or more carbon atoms, an alkoxy halide group with ten or more carbon atoms, an organic group including a ring structure, and the like. Specifically, examples of the structure including a vertical alignment inducing structure portion include the structures and the like represented by Formulae 5-1 to 5-6.

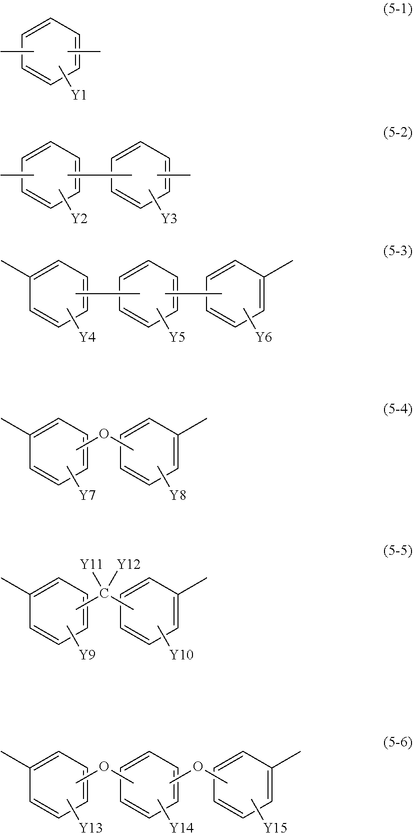

Here, Y1 is an alkyl group with ten or more carbon atoms, an alkoxy group with ten or more carbon atoms, or a monovalent organic group including a ring structure. Further, Y2 to Y15 are a hydrogen atom, an alkyl group with ten or more carbon atoms, an alkoxy group with ten or more carbon atoms, or a monovalent organic group including a ring structure, and at least one of Y2 and Y3, at least one of Y4 to Y6, at least one of Y7 and Y8, at least one of Y9 to Y12, and at least one of Y13 to Y15 are an alkyl group with ten or more carbon atoms, an alkoxy group with ten or more carbon atoms, or a monovalent organic group including a ring structure. Here, Y11 and Y12 may be coupled to form a ring structure.

Further, examples of the monovalent organic group including a ring structure as the vertical alignment inducing structure portion include the groups represented by Formulae 6-1 to 6-23 and the like. Examples of the divalent organic group including a ring structure as the vertical alignment inducing structure portion include the groups represented by Formulae 7-1 to 7-7 and the like.

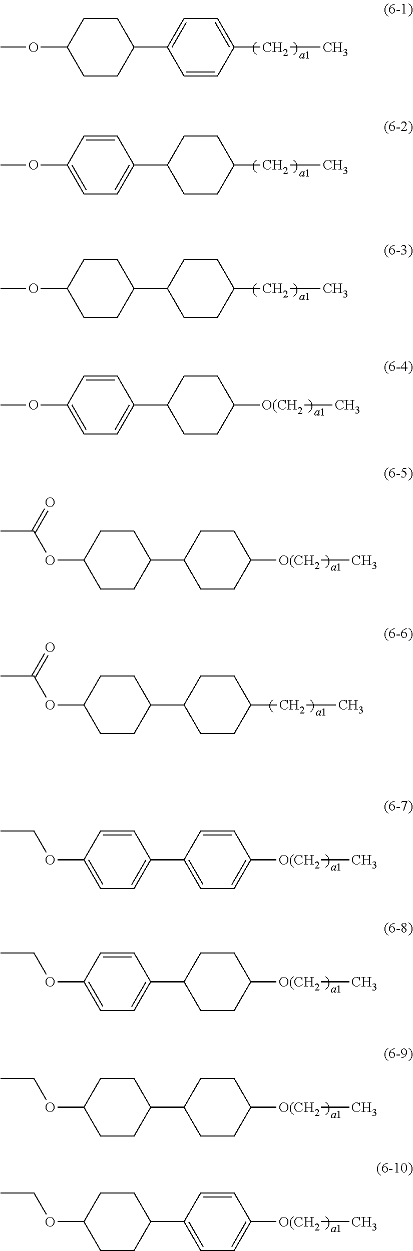

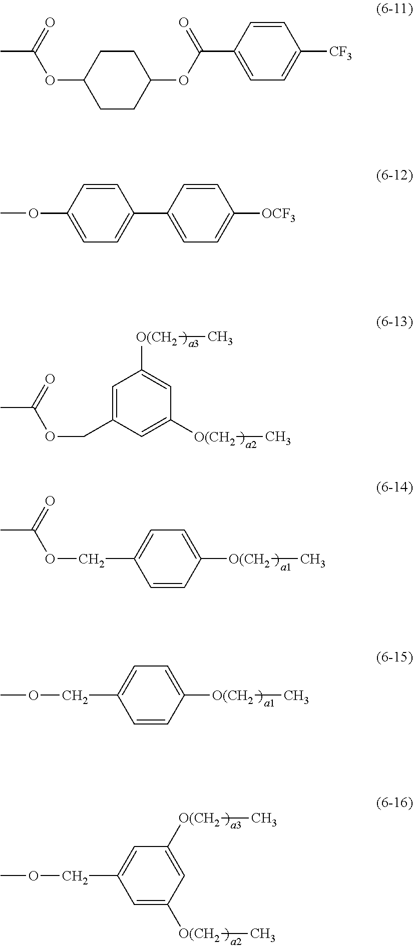

Here, a1 to a3 are integers equal to or greater than 0 and equal to or less than 21.

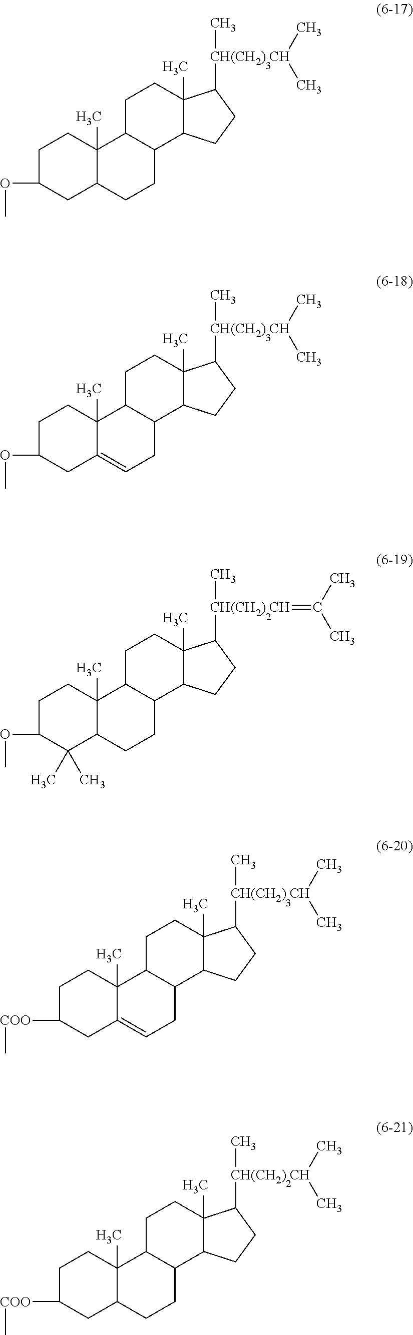

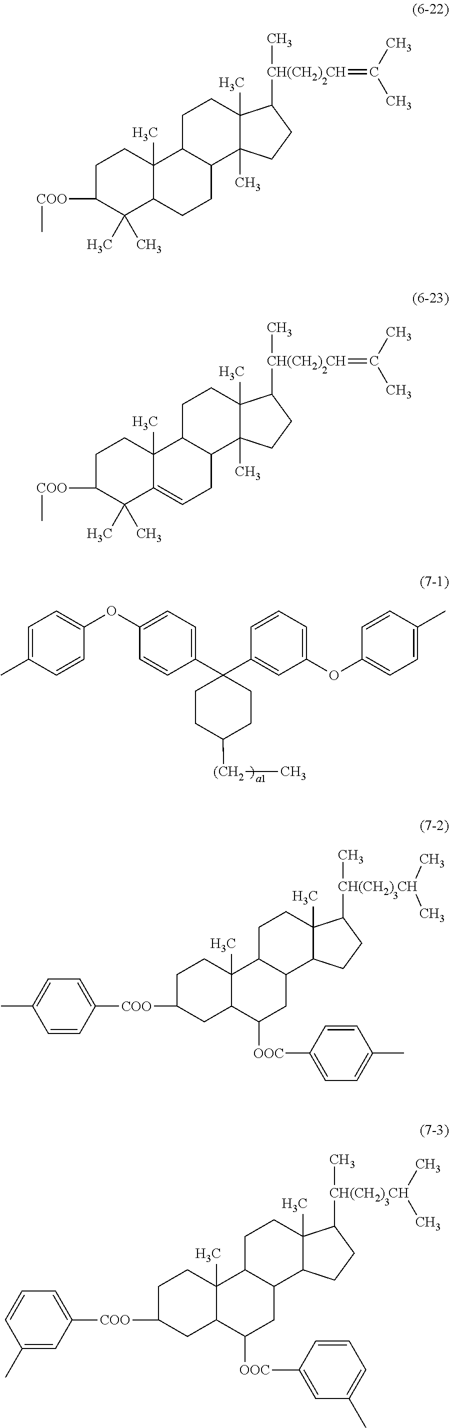

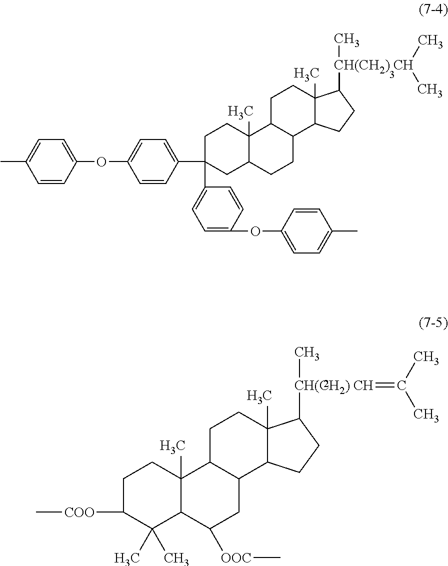

Here, a1 is an integer equal to or greater than 0 and equal to or less than 21.

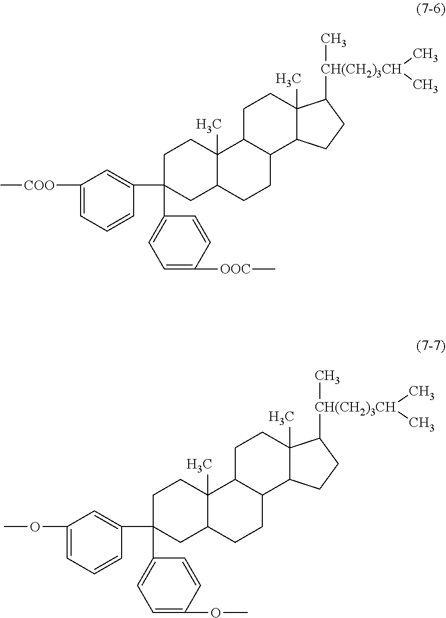

Here, the vertical alignment inducing structure portion is not limited to the groups described above as long as the vertical alignment inducing structure portion includes a structure that functions to arrange the liquid crystal molecules 41 in the vertical direction with respect to the substrate faces.

Further, expressed in accordance with the 1A configuration, the 2A configuration (refer to Embodiment 6 described later), or the 3A configuration of the present disclosure, the polymer compound before cross-linking (pre-alignment process compound) is formed, in addition to a cross-linkable functional group, by a compound including the group represented by Formula 1 as a side chain. Since the group shown in Formula 1 is able to move along the liquid crystal molecules 41, when the pre-alignment process compound is cross-linked, the group shown in Formula 1 is fixed together with the cross-linkable functional group in a state of being along the alignment direction of the liquid crystal molecules 41. Furthermore, since the alignment of the liquid crystal molecules 41 is more easily regulated in a predetermined direction due to the fixed group shown in Formula 1, the manufacture of a liquid crystal display element with favorable display characteristics is made easier.

—R1—R2—R3 (1)

Here, R1 is a linear or branched divalent organic group with three or more carbon atoms, and is coupled to the main chain of the polymer compound before cross-linking (pre-alignment process compound). R2 is a divalent organic group including a plurality of ring structures, and one of the atoms configuring the ring structure is coupled to R1. R3 is a monovalent group including a hydrogen atom, a halogen atom, an alkyl group, an alkoxy group, and a carbonate group, or a derivative thereof.

R1 in Formula 1 is a portion for fixing R2 and R3 to the main chain and for functioning as a spacer portion to make R2 and R3 move freely along the liquid crystal molecules 41, and an example of R1 includes an alkylene group or the like. The alkylene group may include ether bonds between carbon atoms in the middle, and there may be one or two or more locations with such ether bonds. Further, R1 may include a carbonyl group or a carbonate group. The number of carbon atoms in R1 is preferably six or more. The reason is that since the group shown in Formula 1 mutually interacts with the liquid crystal molecules 41, the group is easily able to be along the liquid crystal molecules 41. The number of carbon atoms is preferably determined so that the length of R1 is approximately equal to the length of the terminal chain of the liquid crystal molecules 41.

R2 in Formula 1 is a portion along a ring structure (core portion) generally included in nematic liquid crystal molecules. Examples of R2 include the same groups or skeletons as the ring structure included in the liquid crystal molecules 41 such as a 1,4-phenylene group, a 1,4-cyclohexylene group, a pyrimidine-2,5-diyl group, a 1,6-naphthalene group, a divalent group including a steroid skeleton, or a derivative thereof. Here, “derivative” is a group in which one or two or more substituents are introduced to the series of groups described above.

R3 in Formula 1 is a portion along the terminal chain of the liquid crystal molecules 41, and examples of R3 include an alkylene group, an alkylene halide group, and the like. Here, with the alkylene halide group, at least one hydrogen atom of the alkylene group may be substituted by a halogen atom, and the type of halogen atom is arbitrary. The alkylene group or the alkylene halide group may include ether bonds between the carbon atoms in the middle, and there may be one location or two or more locations with such ether bonds. Further, R3 may include a carbonyl group or a carbonate group. For the same reasons as R1, the number of carbon atoms in R3 is preferably six or more.

Specifically, examples of the group shown in Formula 1 include the monovalent groups represented by Formulae 1-1 to 1-8, and the like.

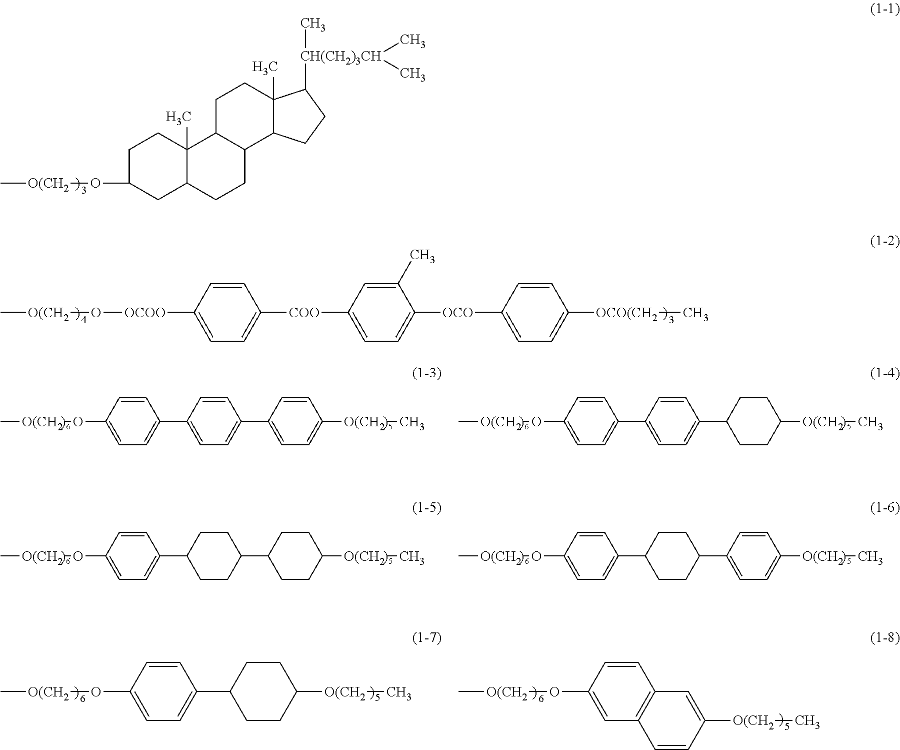

Here, the group shown in Formula 1 is not limited to the groups described above as long as the group is able to move along the liquid crystal molecules 41.

Alternatively, expressed in accordance with the 1B configuration, the 2B configuration (refer to Embodiment 6 described later), or the 3B configuration of the present disclosure, the polymer compound before cross-linking (pre-alignment process compound) is formed by a compound including the group represented by Formula 2 as a side chain. Since a portion along the liquid crystal molecules 41 and a portion that is able to move freely are included in addition to the cross-linked portion, the portion of the side chain along the liquid crystal molecules 41 is able to be fixed in a state of being more along the liquid crystal molecules 41. Furthermore, as a result, since the alignment of the liquid crystal molecules 41 is more easily regulated in a predetermined direction, the manufacture of a liquid crystal display element with favorable display characteristics is made easier.

—R11—R12—R13—R14 (2)

Here, R11 is a linear or branched divalent organic group with one or more and twenty or fewer carbon atoms, preferably three or more and twelve or fewer carbon atoms, which may include an ether group or an ester group, and is coupled to the main chain of the polymer compound or the cross-linked compound (pre-alignment process compound or post-alignment process compound), or alternatively, R11 is an ether group or an ester group, and is coupled with the main chain of the polymer compound or a cross-linked compound (pre-alignment process compound or post-alignment process compound). R12 is, for example, a divalent group including any one type of structure out of chalcone, cinnamate, cinnamoyl, coumarin, maleimide, benzophenone, norbornene, oryzanol, and chitosan, or is an ethynylene group. R13 is a divalent organic group including a plurality of ring structures. R14 is a monovalent group including a hydrogen atom, a halogen atom, an alkyl group, an alkoxy group, and a carbonate group, or a derivative thereof.

R11 in Formula 2 is a portion able to move freely in the pre-alignment process compound, and is preferably flexible in the pre-alignment process compound. An example of R11 includes the group described for R1 in Formula 1. Since in the group shown in Formula 2, R12 to R14 are able to move easily with R11 as the axis, R13 and R14 are easily able to be along the liquid crystal molecules 41. The number of carbon atoms in R11 is more preferably six or more and ten or fewer.

R12 in Formula 2 is a portion including a cross-linkable functional group. The cross-linkable functional group may be a group forming a cross-linked structure through an optical reaction or a group forming a cross-linked structure through a thermal reaction as described above. Specifically, examples of R12 include a divalent group including any one type of structure out of chalcone, cinnamate, cinnamoyl, coumarin, maleimide, benzophenone, norbornene, oryzanol, and chitosan, and an ethynylene group.

R13 in Formula 2 is a portion able to be along the core portion of the liquid crystal molecules 41, and examples of R13 include the group described for R2 in Formula 1, and the like.

R14 in Formula 2 is a portion along the terminal chain of the liquid crystal molecules 41, and examples of R14 include the group described for R3 in Formula 1, and the like.

Specifically, examples of the group shown in Formula 2 include the monovalent groups represented by Formulae 2-1 to 2-7, and the like.

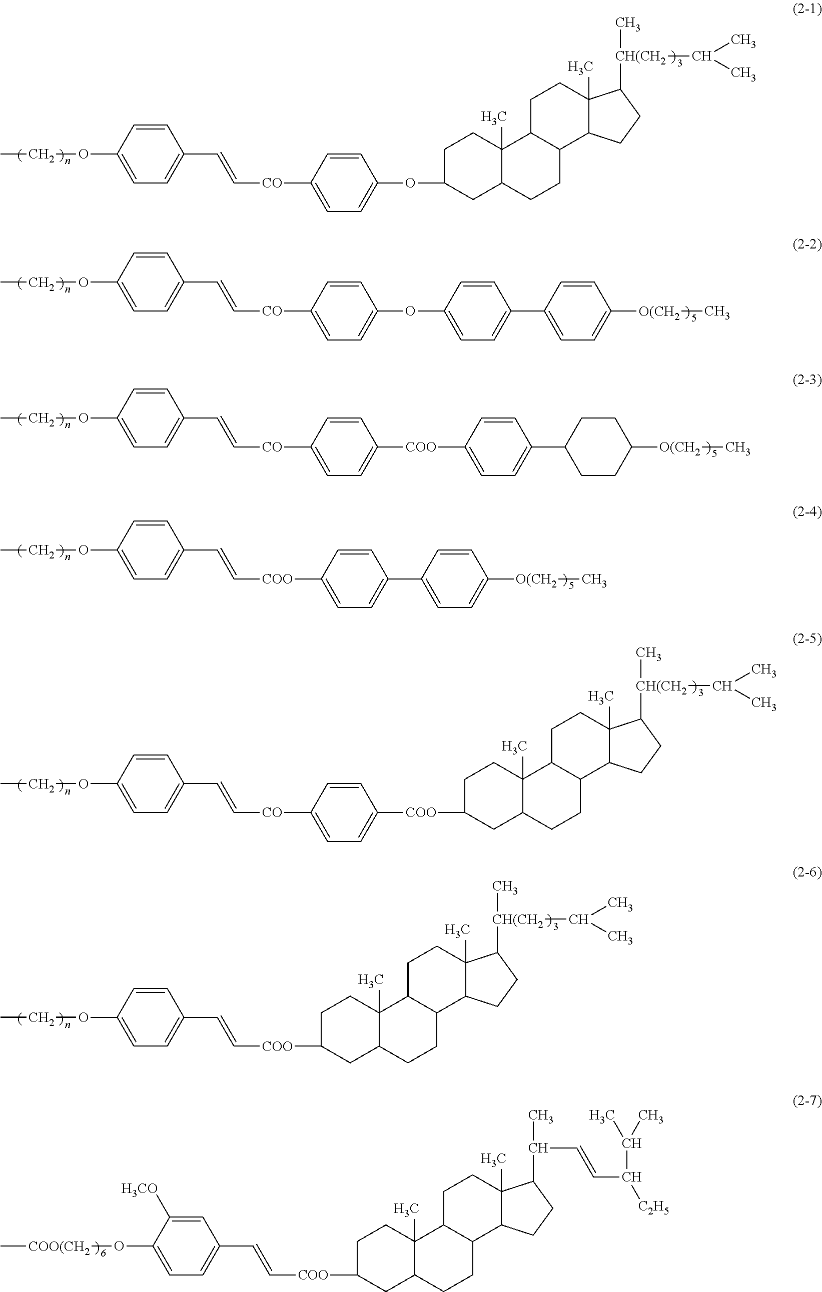

Here, n is an integer equal to or greater than 3 and equal to or less than 20.

Here, the group shown in Formula 2 is not limited to the groups described above as long as the group shown in Formula 2 includes the four portions (R11 to R14) described above.

Alternatively, expressed in accordance with the 1C configuration of the present disclosure, a compound (post-alignment process compound) obtained by cross-linking the polymer compound (pre-alignment process compound) is configured by a side chain and a main chain supporting the side chain with respect to the substrates, the side chain is coupled to the main chain and is configured by a cross-linked portion in which a portion of the side chain is cross-linked and a terminal structure portion coupled to the cross-linked portion, and a pretilt is conferred by the liquid crystal molecules 41 being along the terminal structure portion or being interposed by the terminal structure portion. Further, expressed in accordance with the 2C configuration of the present disclosure (refer to Embodiment 6 described later), a compound (post-alignment process compound) obtained by deforming the polymer compound (pre-alignment process compound) is configured by a side chain and a main chain supporting the side chain with respect to the substrates, the side chain is coupled to the main chain and is configured by a deformed portion in which a portion of the side chain is deformed and a terminal structure portion coupled to the deformed portion, and a pretilt is conferred by the liquid crystal molecules 41 being along the terminal structure portion or being inter posed by the terminal structure portion. Further, expressed in accordance with the 3C configuration of the present disclosure, a compound obtained by irradiating energy rays on the polymer compound is configured by a side chain and a main chain supporting the side chain with respect to the substrates, the side chain is coupled to the main chain and is configured by a cross-linked or deformed portion in which a portion of the side chain is cross-linked or deformed and a terminal structure portion coupled to the cross-linked or deformed portion, and a pretilt is conferred by the liquid crystal molecules 41 being along the terminal structure portion or being interposed by the terminal structure portion.

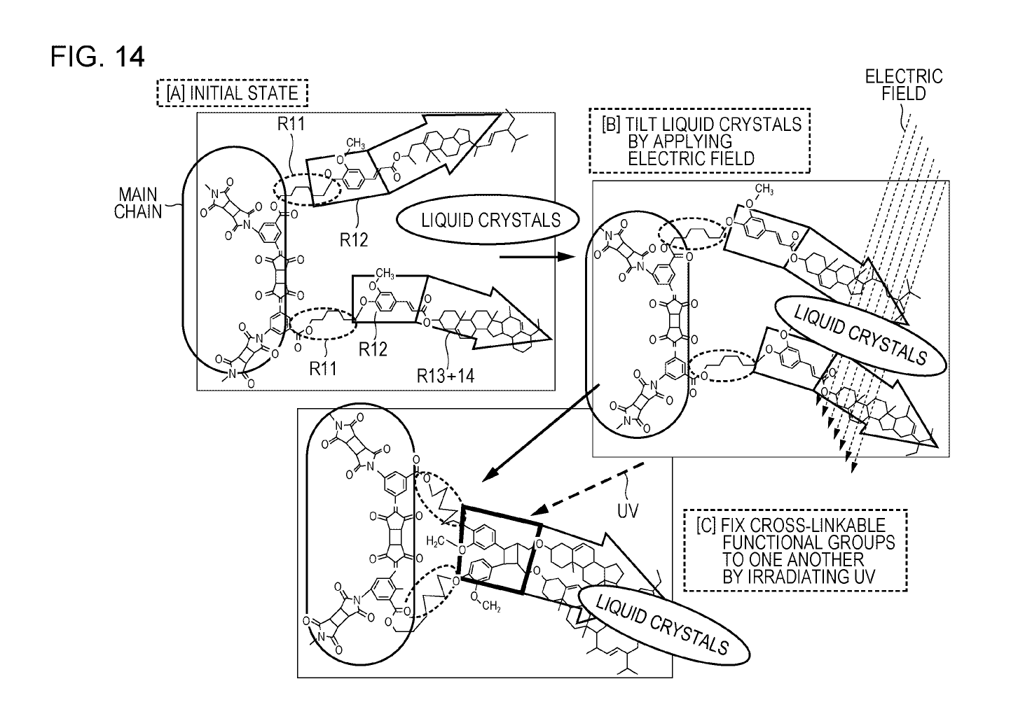

Here, in the 1C configuration of the present disclosure, the cross-linked portion in which a portion of the side chain is cross-linked corresponds to E12 (after being cross-linked) in Formula 2. Further, R13 and R14 in Formula 2 correspond to the terminal structure portion. Here, in the post-alignment process compound, a pretilt is conferred on the liquid crystal molecules 41, for example, by the cross-linked portions of two side chains extending from the main chain being cross-linked with each other, a portion of the liquid crystal molecules 41 being as if interposed between a terminal structure portion extending from one of the cross-linked portions and a terminal structure portion extending from the other cross-linked portion, and the terminal structure portions being fixed in a state of forming a predetermined angle with respect to the substrates. Here, such a state is illustrated in the outline view of FIG. 14.

Alternatively, expressed in accordance with the 1D configuration of the present disclosure, a compound (post-alignment process compound) obtained by cross-linking the polymer compound (pre-alignment process compound) is configured by a side chain and a main chain supporting the side chain with respect to the substrates, and the side chain is coupled to the main chain and is configured by a cross-linked portion in which a portion of the side chain is cross-linked and a terminal structure portion coupled to the cross-linked portion and including a mesogenic group. Here, the side chain may include a photodimerized photosensitive group. Further, the main chain and the cross-linked portion are coupled through covalent coupling, and the cross-linked portion and the terminal structure portion are coupled through covalent coupling. Further, expressed in accordance with the 2D configuration of the present disclosure (refer to Embodiment 6 described later), a compound (post-alignment process compound) obtained by deforming the polymer compound (pre-alignment process compound) is configured by a side chain and a main chain supporting the side chain with respect to the substrates, and the side chain is coupled to the main chain and is configured by a deformed portion in which a portion of the side chain is deformed and a terminal structure portion coupled to the deformed portion and including a mesogenic group. Further, expressed in accordance with the 3D configuration of the present disclosure, a compound (post-alignment process compound) obtained by irradiating energy rays on the polymer compound (pre-alignment process compound) is configured by a side chain and a main chain supporting the side chain with respect to the substrates, and the side chain is coupled to the main chain and is configured by a cross-linked or deformed portion in which a portion of the side chain is cross-linked or deformed and a terminal structure portion coupled to the cross-linked or deformed portion including a mesogenic group.

Here, according to the 1D configuration of the present disclosure, as described above, an example of the photodimerized photosensitive group as the cross-linkable functional group (photosensitive functional group) includes a group including any one type of structure out of chalcone, cinnamate, cinnamoyl, coumarin, maleimide, benzophenone, norbornene, oryzanol, and chitosan. Further, the rigid mesogenic group configuring the terminal structure portion may or may not exhibit liquid crystallinity as a side chain, and specific structures include a steroid derivative, a cholesterol derivative, biphenyl, triphenyl, naphthalene, and the like. Furthermore, examples of the terminal structure portion include R13 and R14 in Formula 2.

Alternatively, expressed in accordance with the 1E configuration, the 2E configuration (refer to Embodiment 6 described later) and the 3E configuration of the present disclosure, the surface roughness Ra of the first alignment film (or an alignment film formed by the post-alignment process compound) is equal to or less than 1 nm.

While the post-alignment process compound may include an unreacted cross-linkable functional group, since there is a concern that the alignment of the liquid crystal molecules 41 is disturbed in a case where the unreacted cross-linkable functional group reacts when driving, the less there is of the unreacted cross-linkable functional group, the more preferable. Whether or not the post-alignment process compound includes an unreacted cross-linkable functional group is able to be verified by disassembling the liquid crystal display device, for example, and analyzing the alignment films 22 and 32 using a transmission type or reflection type FT-IR (Fourier Transform Infra Red spectrophotometer). Specifically, first, the liquid crystal display device is dismantled and the surfaces of the alignment films 22 and 32 are washed using an organic solvent or the like. By then analyzing the alignment films 22 and 32 using an FT-IR, for example, if the double bonds forming the cross-linked structure shown in Formula 41 remains in the alignment films 22 and 32, an absorption spectrum resulting from a double bond is obtained, allowing verification.

Further, the alignment films 22 and 32 may include, in addition to the post-alignment process compound described above, other vertical alignment agents. Examples of other vertical alignment agents include a polyimide including a vertical alignment inducing structure portion, a polysiloxane including a vertical alignment inducing structure portion, and the like.

The liquid crystal layer 40 includes the liquid crystal molecules 41 with negative dielectric constant anisotropy and the pretilt stability conferring compound 42 or the pretilt stability conferring compound 43. The liquid crystal molecules 41 have, for example, a rotationally symmetrical shape with a major axis and a minor axis orthogonal to each other respectively as the center axis, and have negative dielectric constant anisotropy.

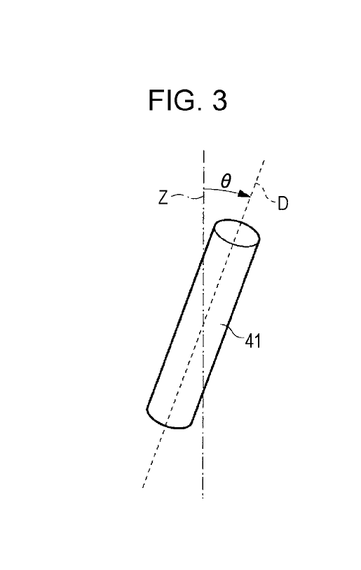

The liquid crystal molecules 41 are able to be categorized into liquid crystal molecules 41A retained by the alignment film 22 in the vicinity of the interface with the alignment film 22, liquid crystal molecules 41B retained by the alignment film 32 in the vicinity of the interface with the alignment film 32, and other liquid crystal molecules 41C. The liquid crystal molecules 41C are positioned in an intermediate region in the thickness direction of the liquid crystal layer 40, and are arranged so that the major axis direction (director) of the liquid crystal molecules 41C in a state in which the driving voltage is off is approximately vertical to the glass substrates 20A and 30A. Here, when the driving voltage is turned on, the directors of the liquid crystal molecules 41C are tilted and aligned to be parallel to the glass substrates 20A and 30A. The behavior is due to the liquid crystal molecules 41C having a property in which the dielectric constant in the major axis direction is smaller than in the minor axis direction. Since the liquid crystal molecules 41A and 41B have the same property, fundamentally, the same behavior as the liquid crystal molecules 41C is exhibited according to changes in the on and off state of the driving voltage. However, when the driving voltage is in an off state, a pretilt θ1 is conferred on the liquid crystal molecules 41A by the alignment film 22, and the directors thereof have an inclined stance from the normal direction of the glass substrates 20A and 30A. Similarly, the pretilt θ1 is conferred on the liquid crystal molecules 41B by the alignment film 32, and the directors thereof have an inclined stance from the normal direction of the glass substrates 20A and 30A. Here, “retained” refers to the alignment of the liquid crystal molecules 41 being regulated without fixing the alignment films 22 and 32 and the liquid crystal molecules 41A and 41C. Further, as illustrated in FIG. 3, a “pretilt θ (θ1, θ2)” refers to the incline angle of directors D of the liquid crystal molecules 41 (41A, 41B) with respect to a Z direction in a state in which the driving voltage is off in a case where a direction vertical to the surfaces of the glass substrates 20A and 30A (normal direction) is Z.

In the liquid crystal layer 40, both the pretilts θ1 and θ2 have values greater than 0°. While the pretilts θ1 and θ2 may be the same angle (θ1=θ2) or may be different angles (θ1≠θ2) in the liquid crystal layer 40, of those, the pretilts θ1 and θ2 are preferably different angles. In so doing, the response speed to the application of the driving voltage is improved over a case where both the pretilts θ1 and θ2 are 0°, and approximately the same contrast as in a case where both the pretilts θ1 and θ2 are 0° is able to be obtained. Accordingly, the transmission amount of light during black display is able to be reduced while improving the response characteristics, and the contrast is able to be improved. In a case where the pretilts θ1 and θ2 are different angles, it is more desirable that the greater pretilt θ of the pretilts θ1 and θ2 be equal to or greater than 1° and equal to or less than 4°. By the greater pretilt θ being within the range described above, particularly high effects are able to be obtained.

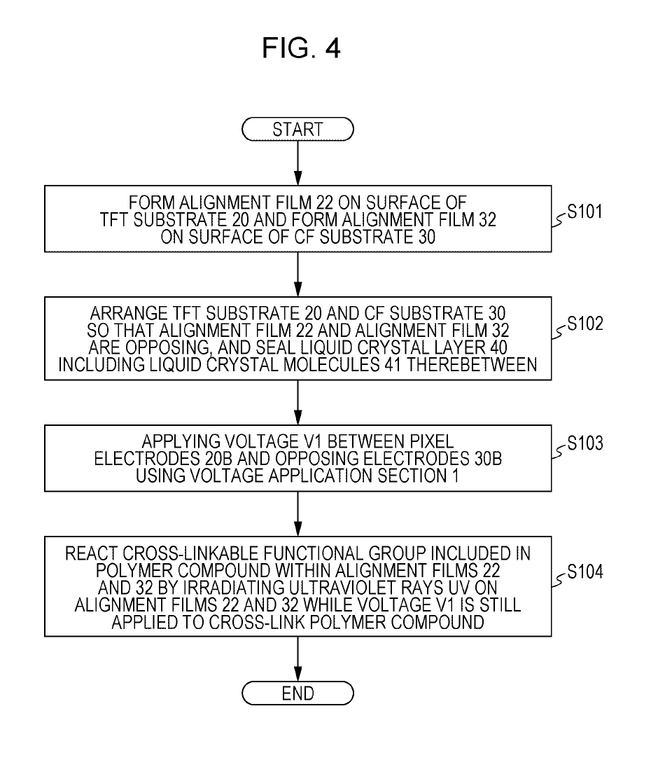

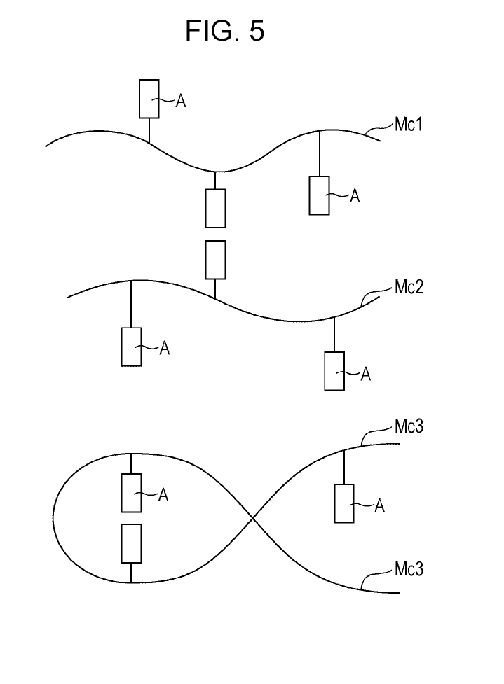

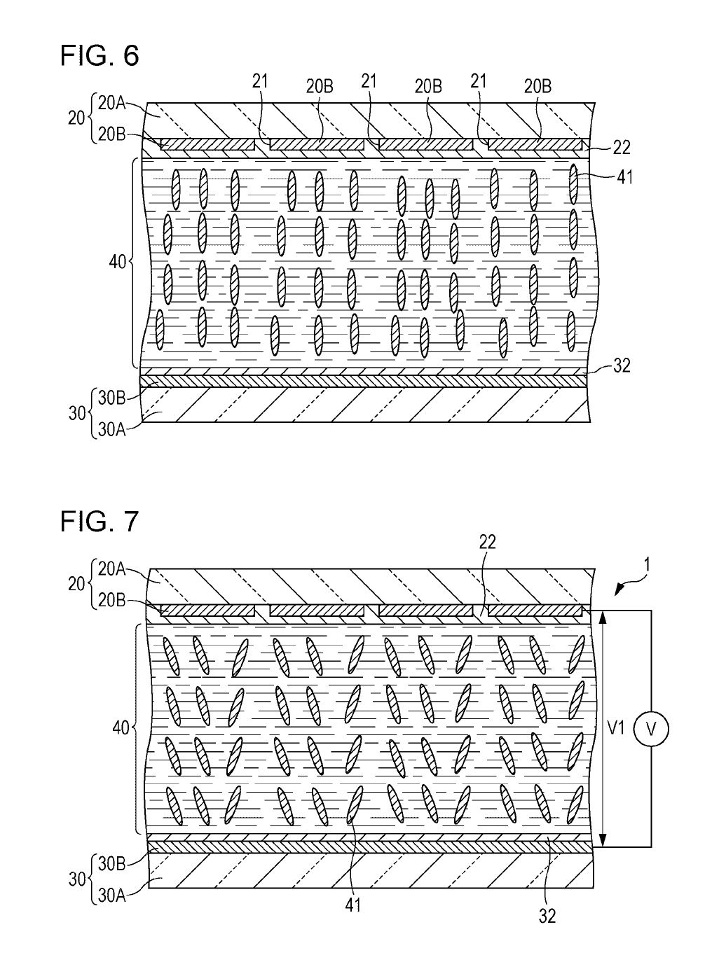

Next, a method of manufacturing the liquid crystal display device (liquid crystal display element) described above will be described with reference to the flowchart illustrated in FIG. 4, the schematic view for describing the states within the alignment films 22 and 32 illustrated in FIG. 5, and the schematic partial cross-sectional views of the liquid crystal display device and the like shown in FIGS. 6, 7, and 8A. Here, for convenient, only one pixel is illustrated in FIGS. 6, 7, and 8A.

First, the alignment film 22 is formed on the surface of the TFT substrate 20, and the alignment film 32 is formed on the surface of the CF substrate 30 (step S101).

Specifically, first, the TFT substrate 20 is created by providing the pixel electrodes 20B including predetermined slit portions 21 in a matrix pattern, for example, on the surface of the glass substrate 20A. Further, the CF substrate 30 is created by providing the opposing substrates 30B on the color filter of the glass substrate 30A on which a color filter is formed.

Meanwhile, for example, a liquid alignment film material is prepared by mixing the pre-alignment process compound or a polymer compound precursor as the pre-alignment process compound, a solvent, and a vertical alignment agent as necessary.

In a case where the polymer compound including a cross-linkable functional group as a side chain includes the polyimide structure shown in Formula 3, an example of the polymer compound precursor as the pre-alignment process compound includes polyamic acid including a cross-linkable functional group. The polyamic acid as the polymer compound precursor is synthesized, for example, by reacting a diamine compound with a tetracarboxylic dianhydride. At least one of the diamine compound and the tetracarboxylic dianhydride used here includes a cross-linkable functional group. Examples of the diamine compound include the compounds including a cross-linkable functional group represented by Formulae A-1 to A-15, and examples of the tetracarboxylic dianhydride include the compounds including a cross-linkable functional group represented by a-1 to a-10. Here, the compounds represented by Formulae A-9 to A-15 are compounds configuring the cross-linked portion and the terminal structure portion of the cross-linked polymer compound in the 1C configuration of the present disclosure. Alternatively, examples of compounds configuring the cross-linked portion and the terminal structure portion of the cross-linked polymer compound in the 1C configuration of the present disclosure include the compounds represented by Formulae F-1 to F-18. Here, for the compounds represented by Formulae F-1 to F-18, it is considered that a pretilt is conferred on the liquid crystal molecules along the terminal structure portions of the compounds represented by Formulae F-1 to F-3, F-7 to F-9, and F-13 to F-15, while it is considered that a pretilt is conferred on the liquid crystal molecules by the liquid crystal molecules being interposed by the terminal structure portions of the compounds represented by Formulae F-4 to F-6, F-10 to F-12, and F-16 to F-18.

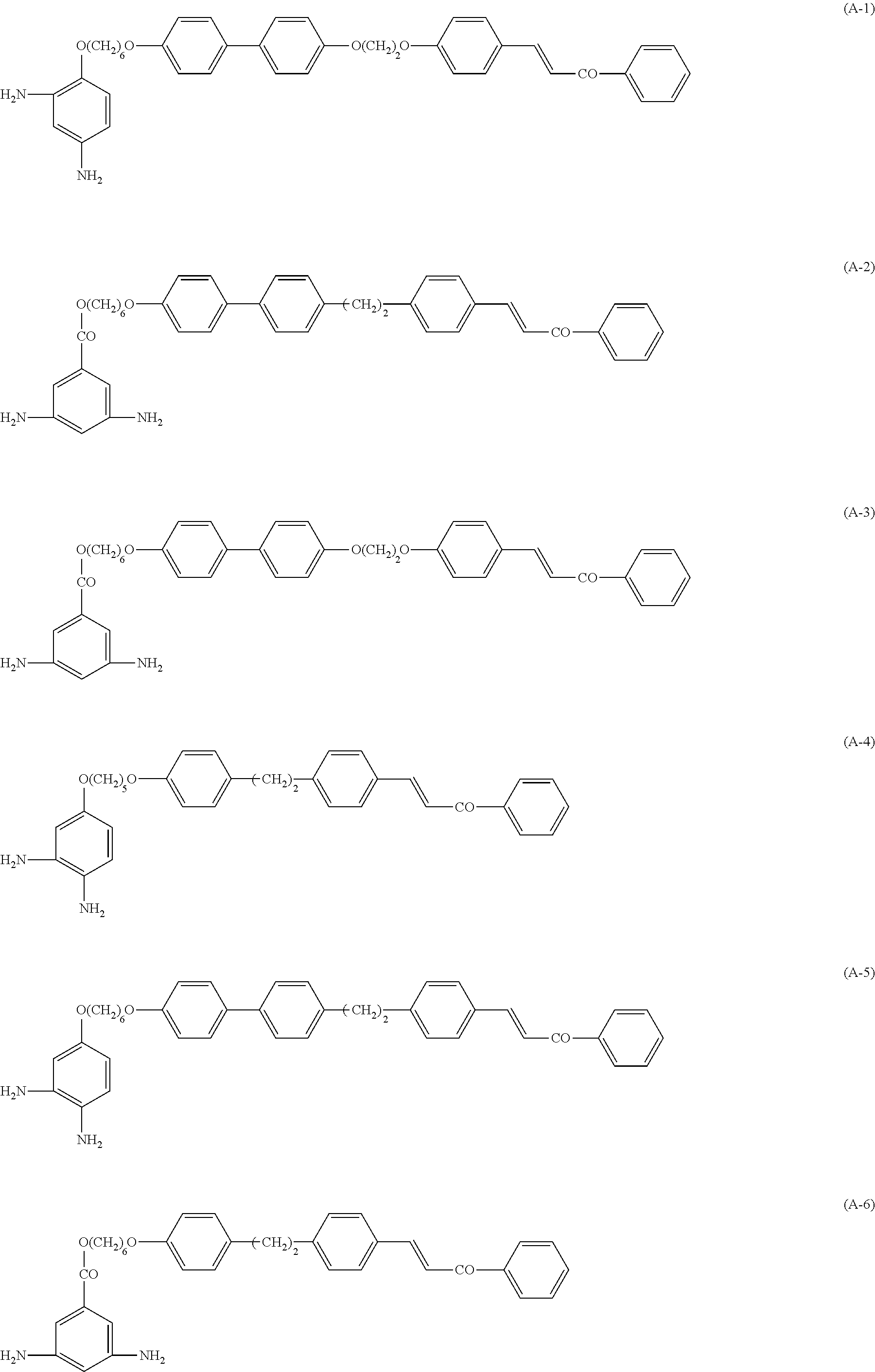

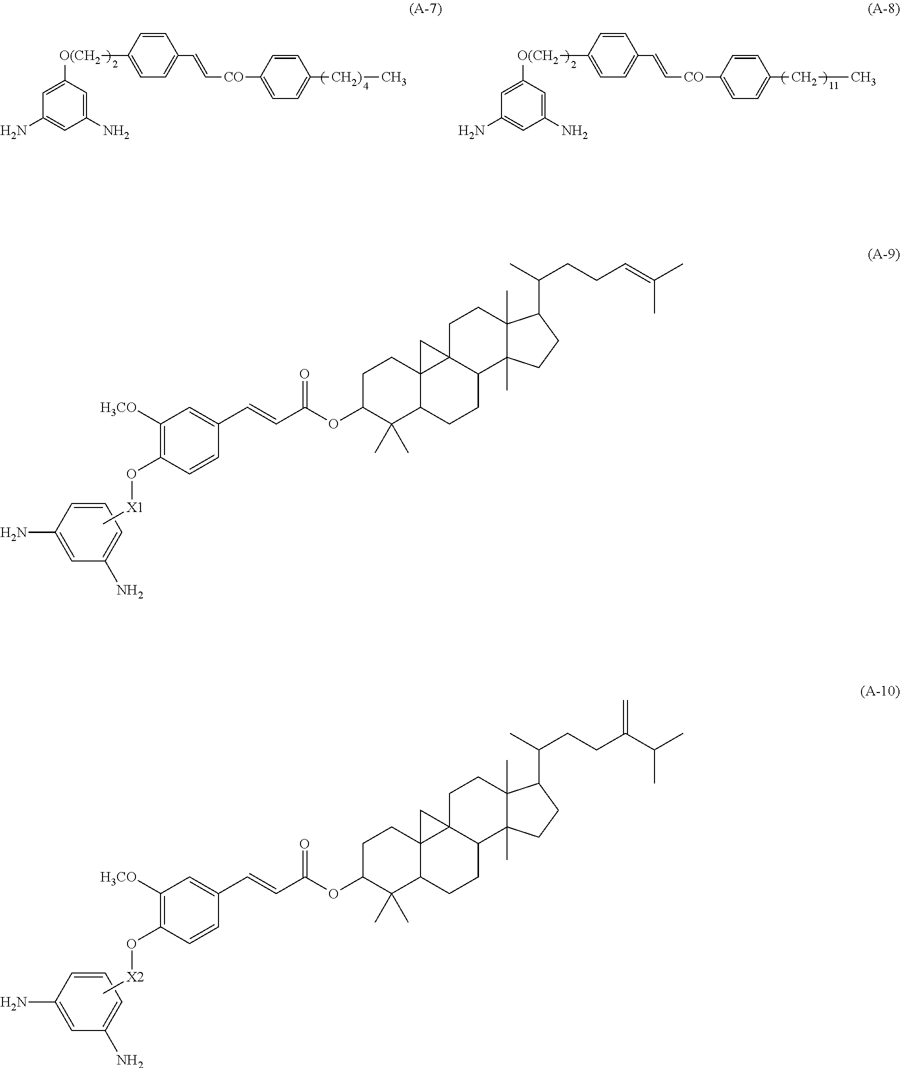

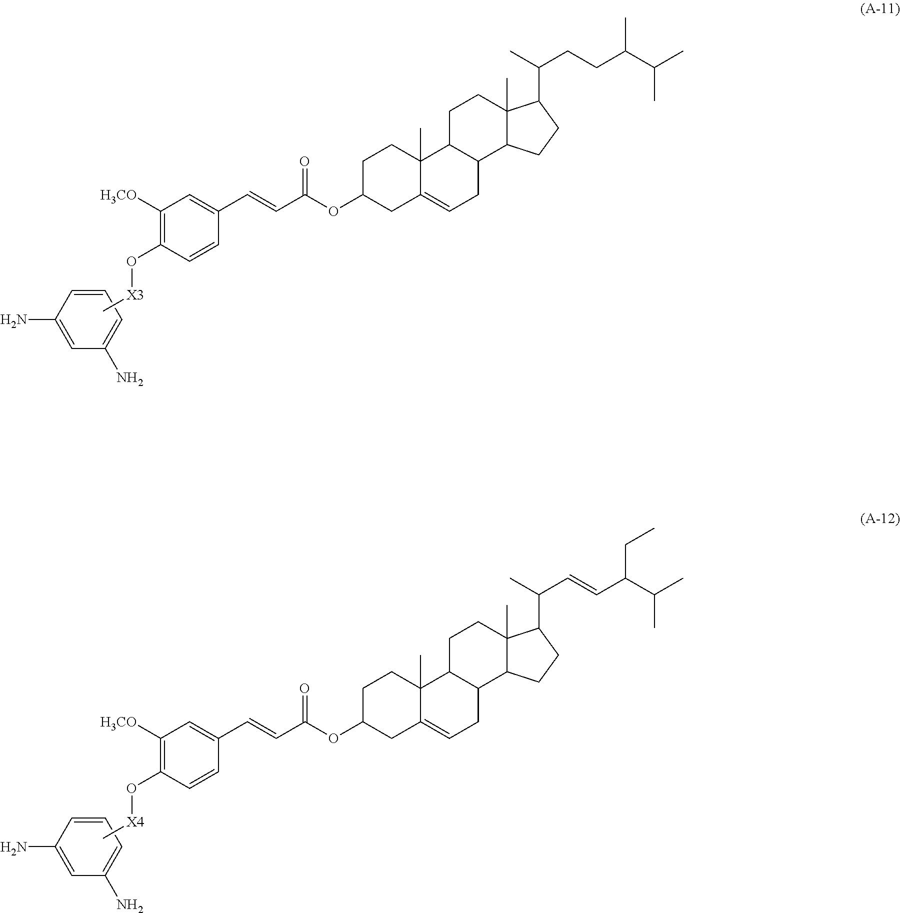

Here, X1 to X4 are single bond or divalent organic groups.

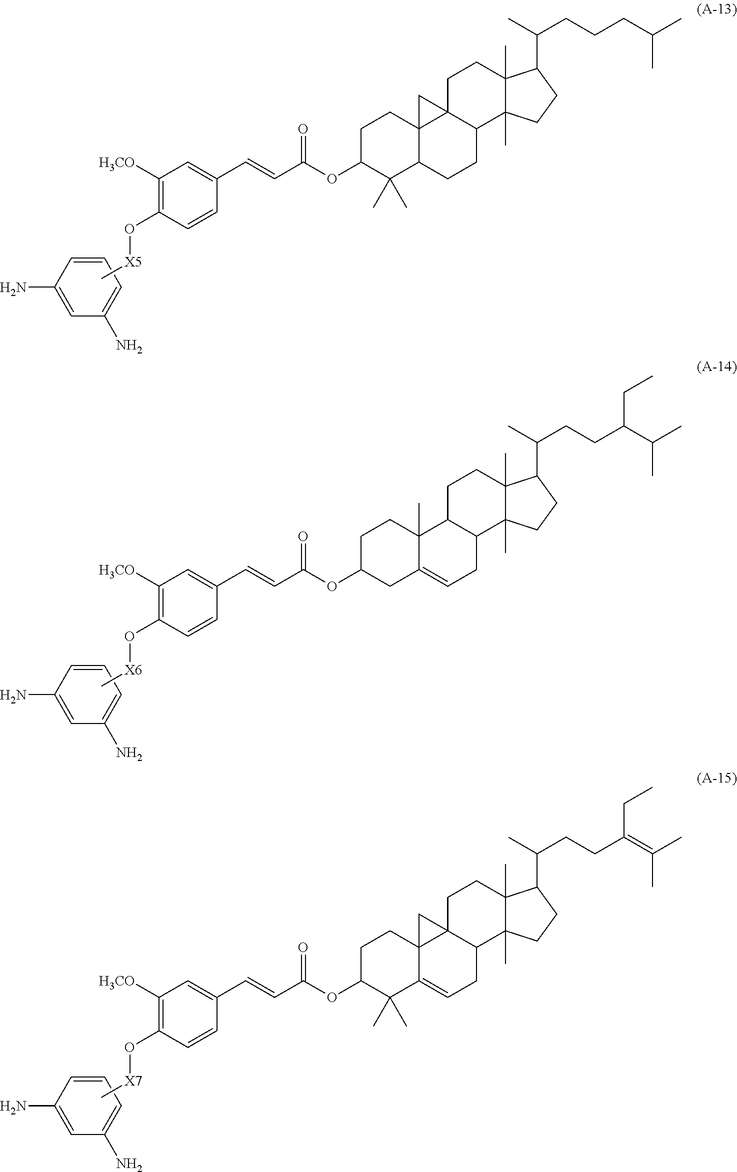

Here, X5 to X7 are single bond or divalent organic groups.

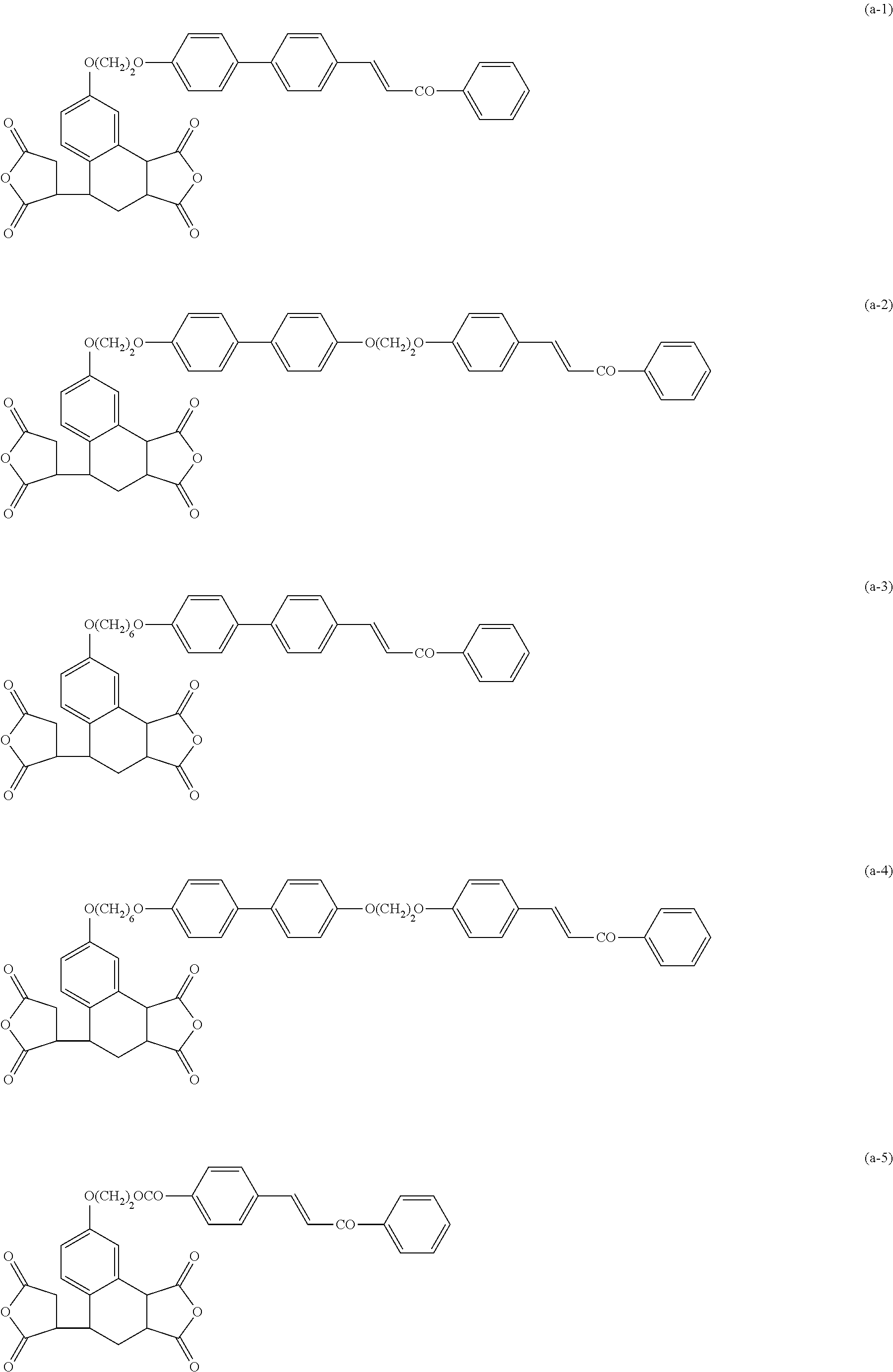

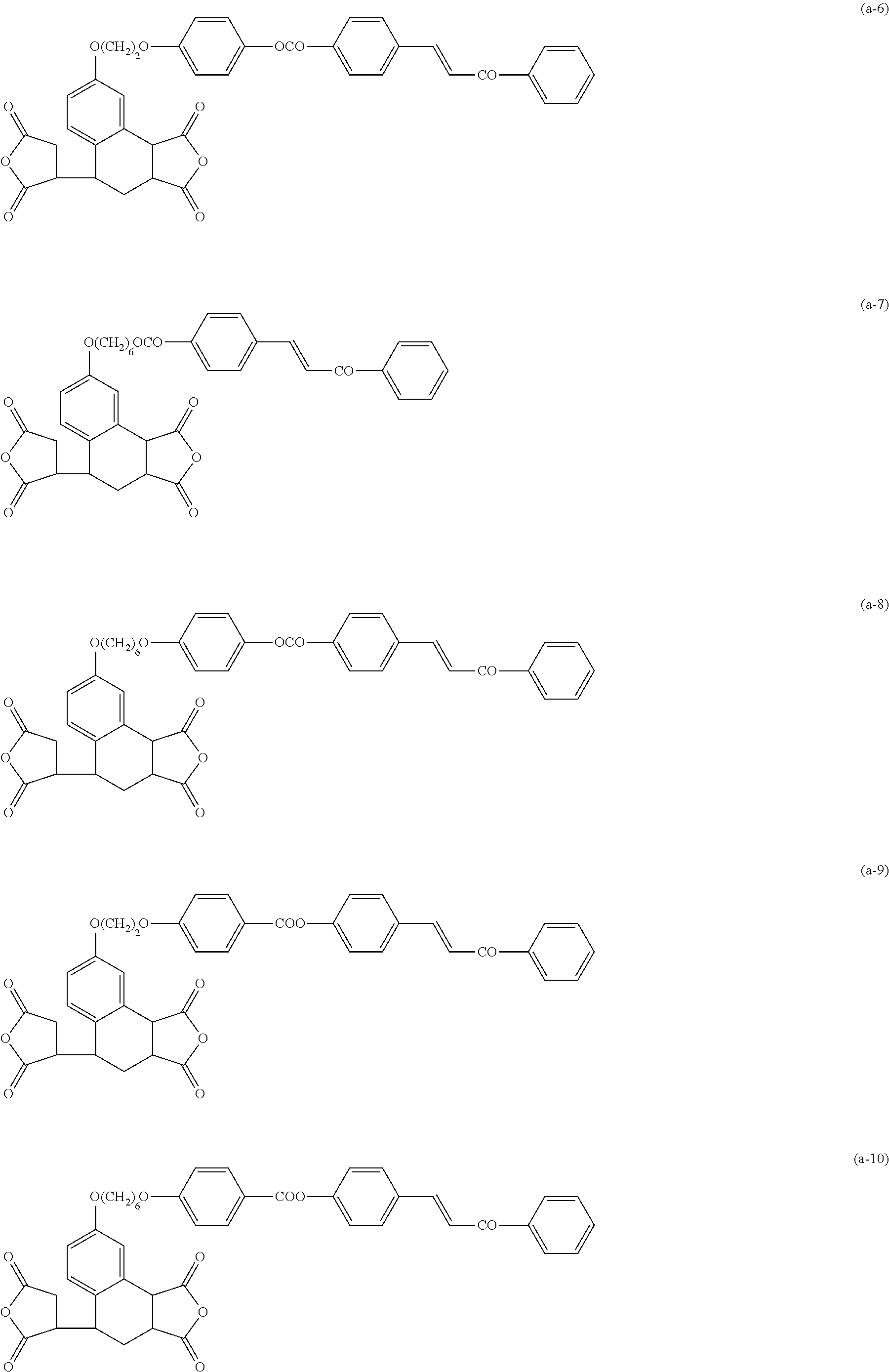

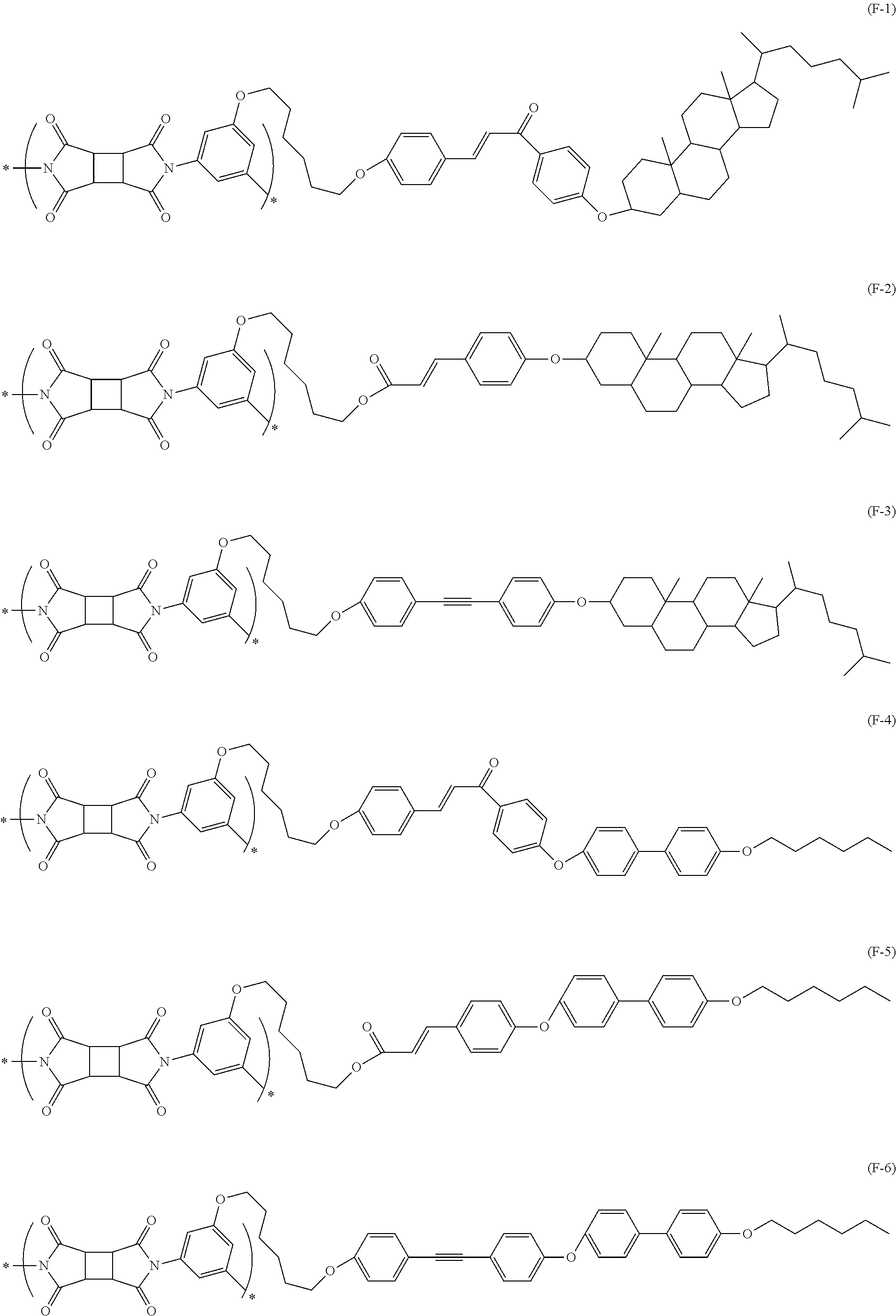

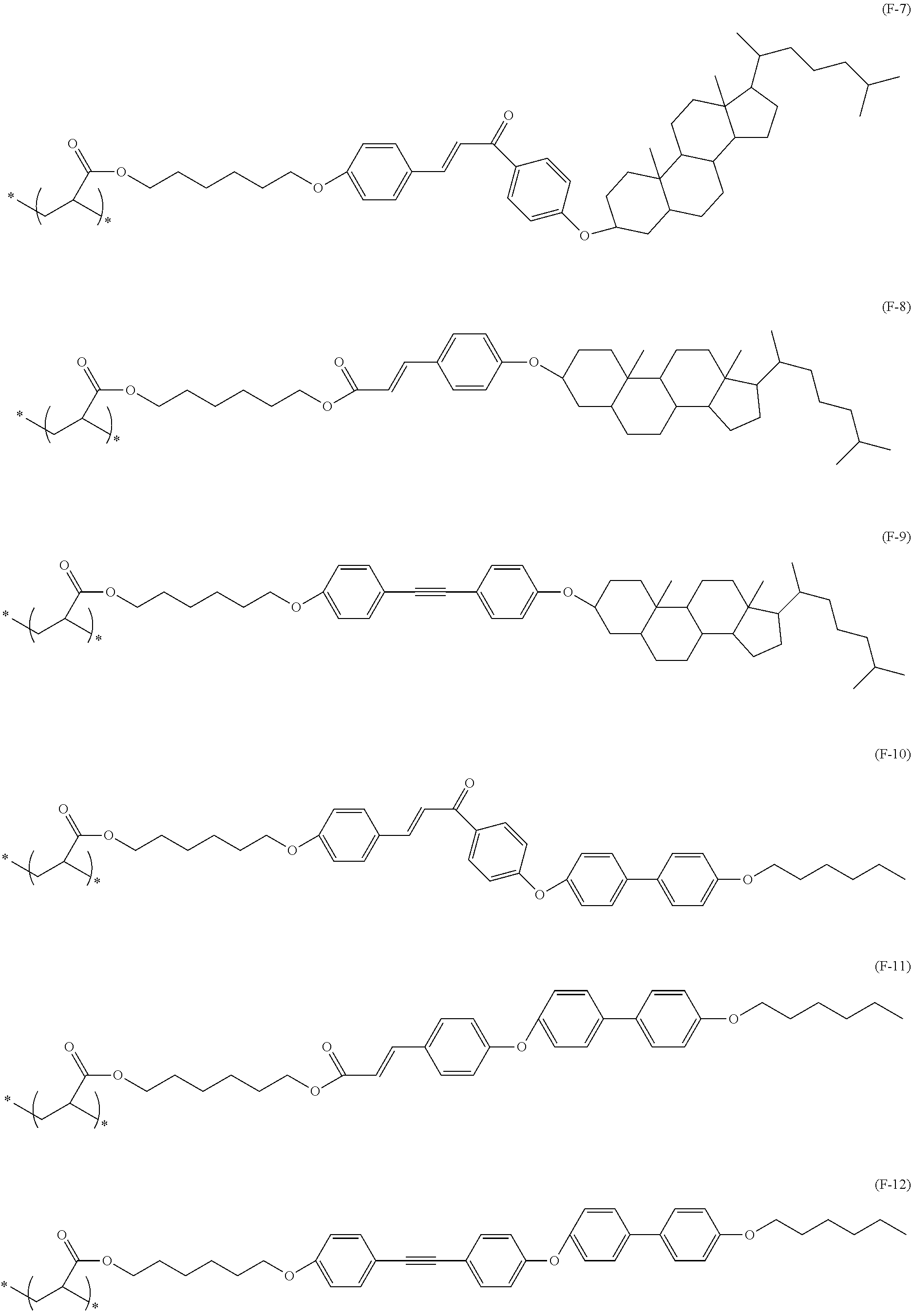

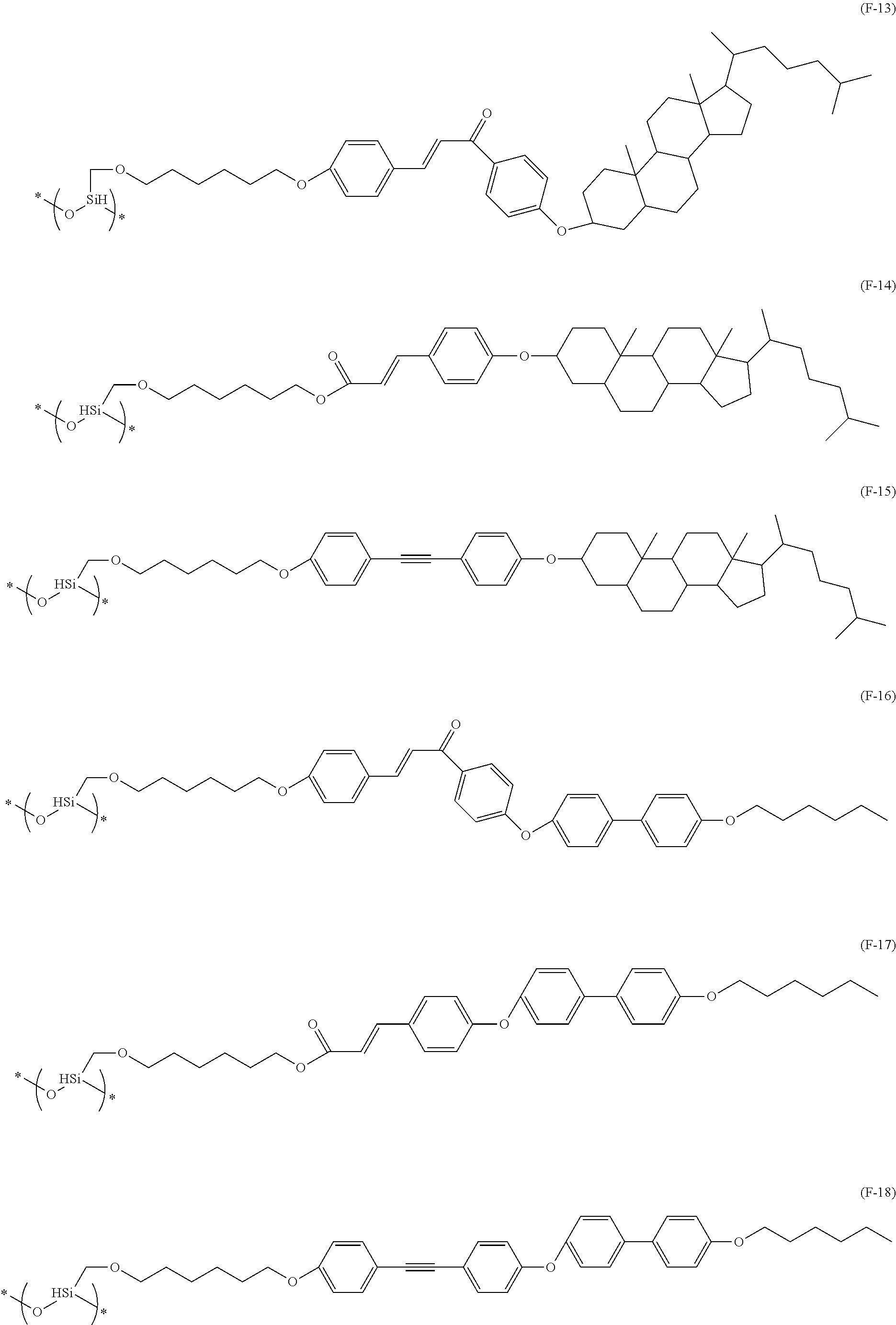

Further, in a case where polyamic acid as the polymer compound precursor is synthesized so that the pre-alignment process compound includes a vertical alignment inducing structure portion, in addition to the compounds including a cross-linkable functional group described above, the compounds including a vertical alignment inducing structure portion represented by Formulae B-1 to B-36 as diamine compounds, and the compounds including a vertical alignment inducing structure portion represented by Formulae b-1 to b-3 as tetracarboxylic dianhydrides may be used.

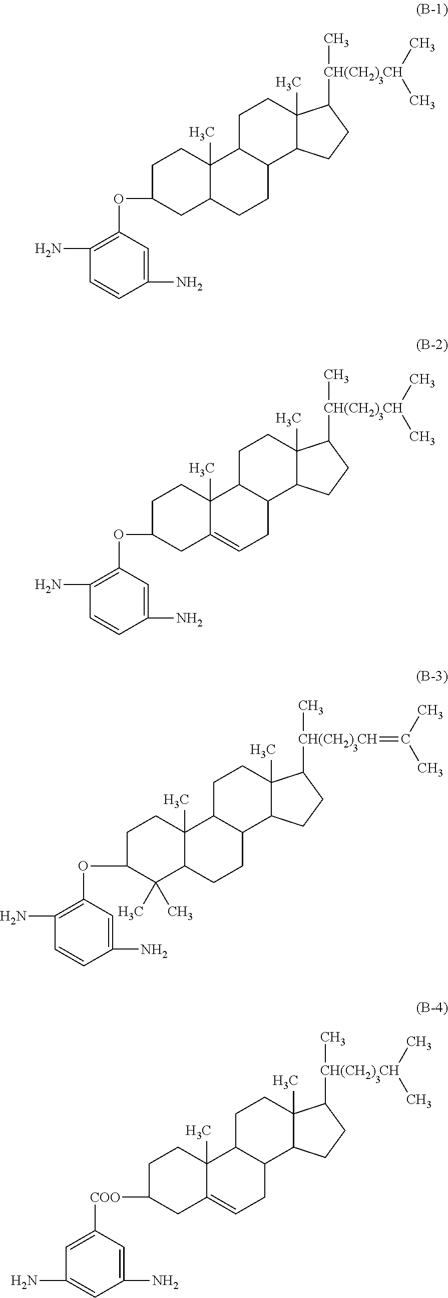

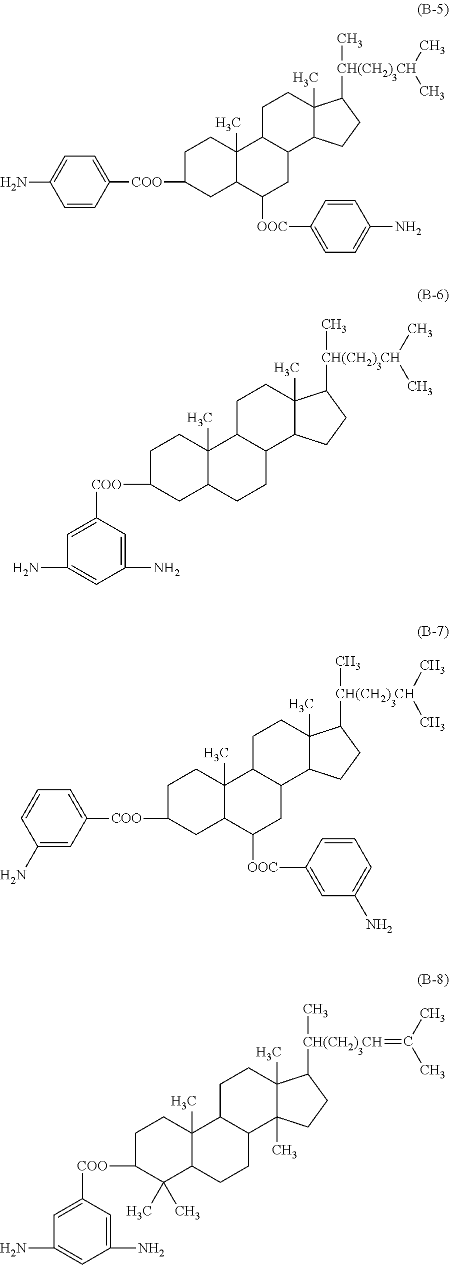

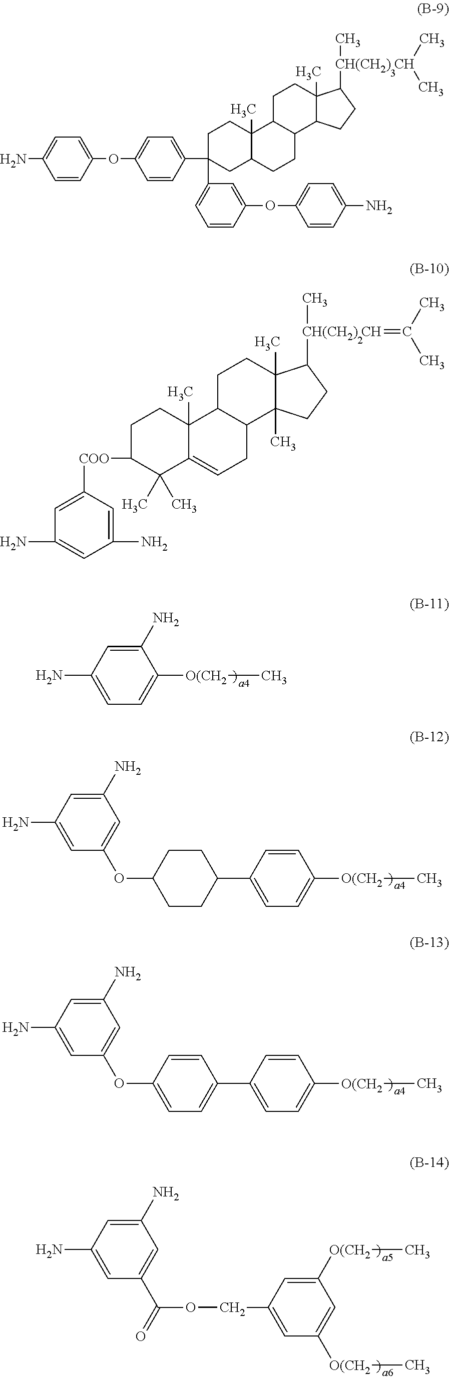

Here, a4 to a6 are integers equal to or greater than 0 and equal to or less than 21.

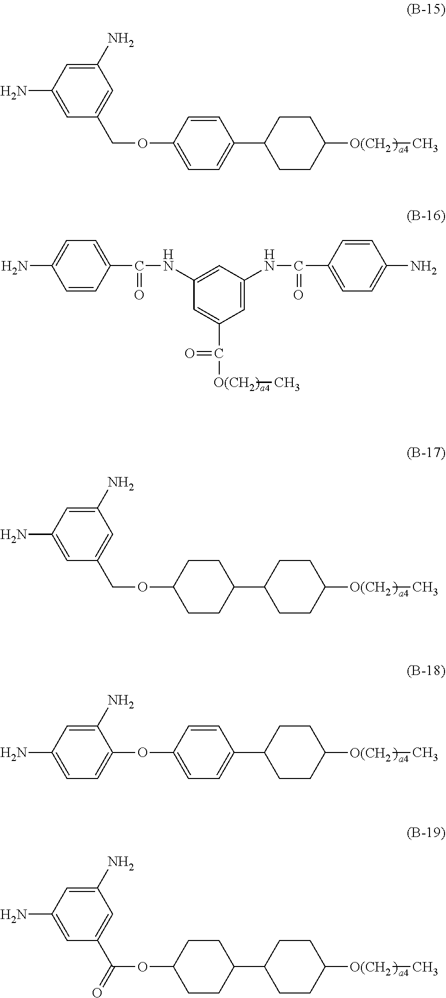

Here, a4 is an integer equal to or greater than 0 and equal to or less than 21.

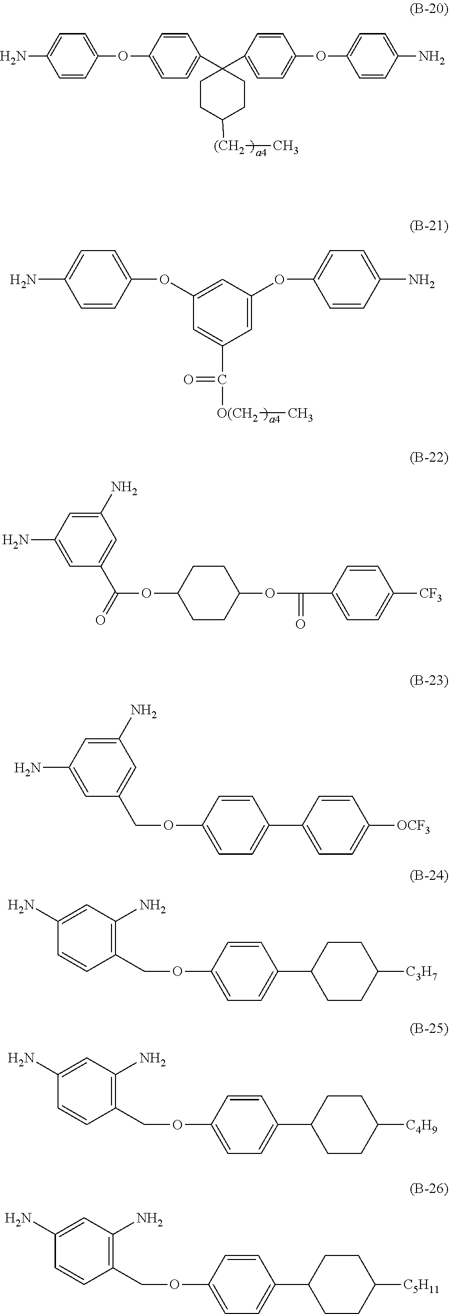

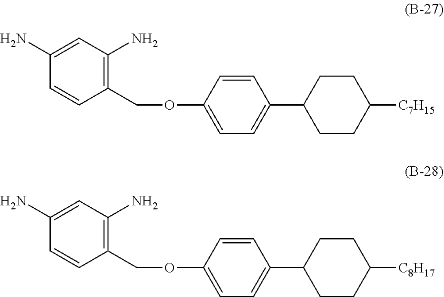

Here, a4 is an integer equal to or greater than 0 and equal to or less than 21.

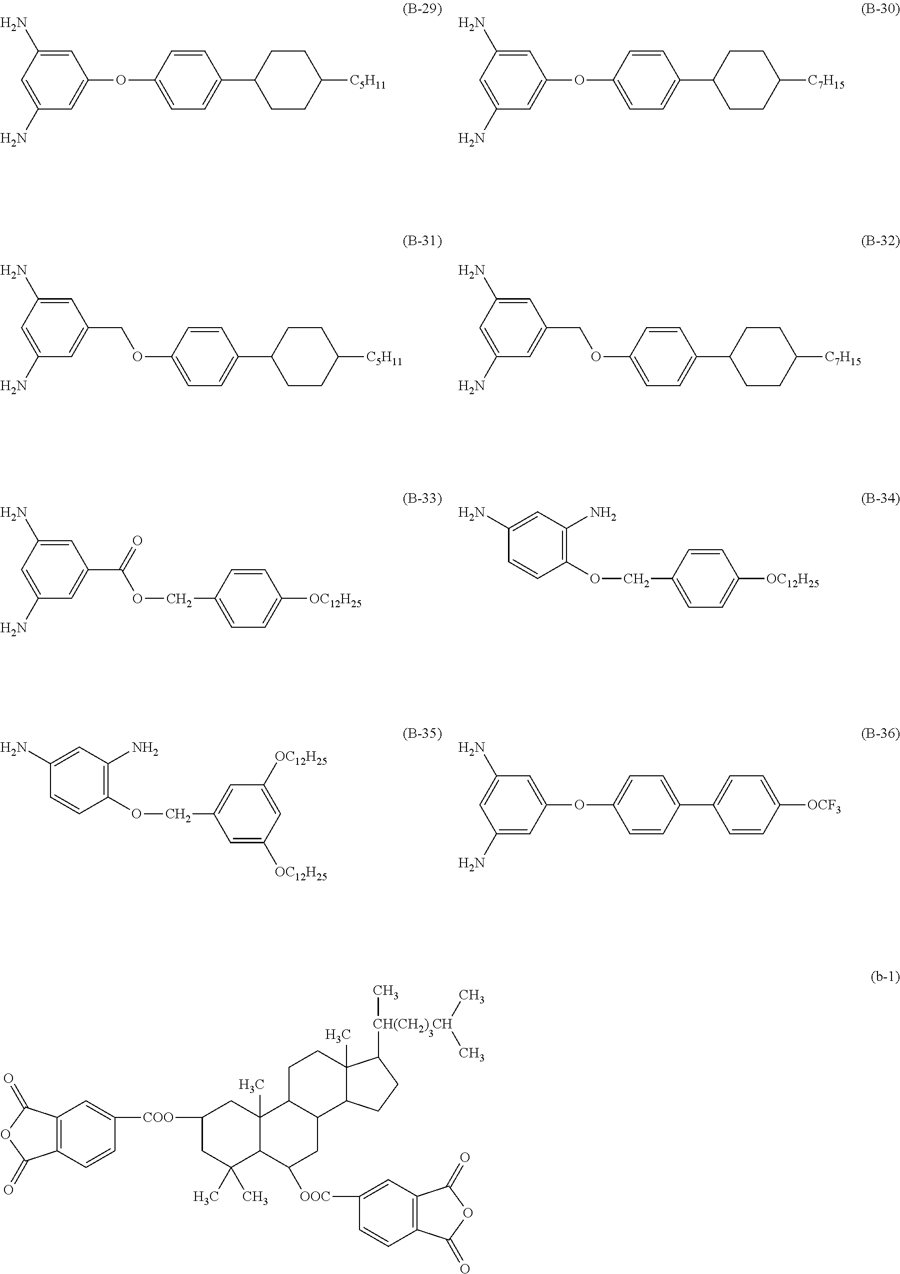

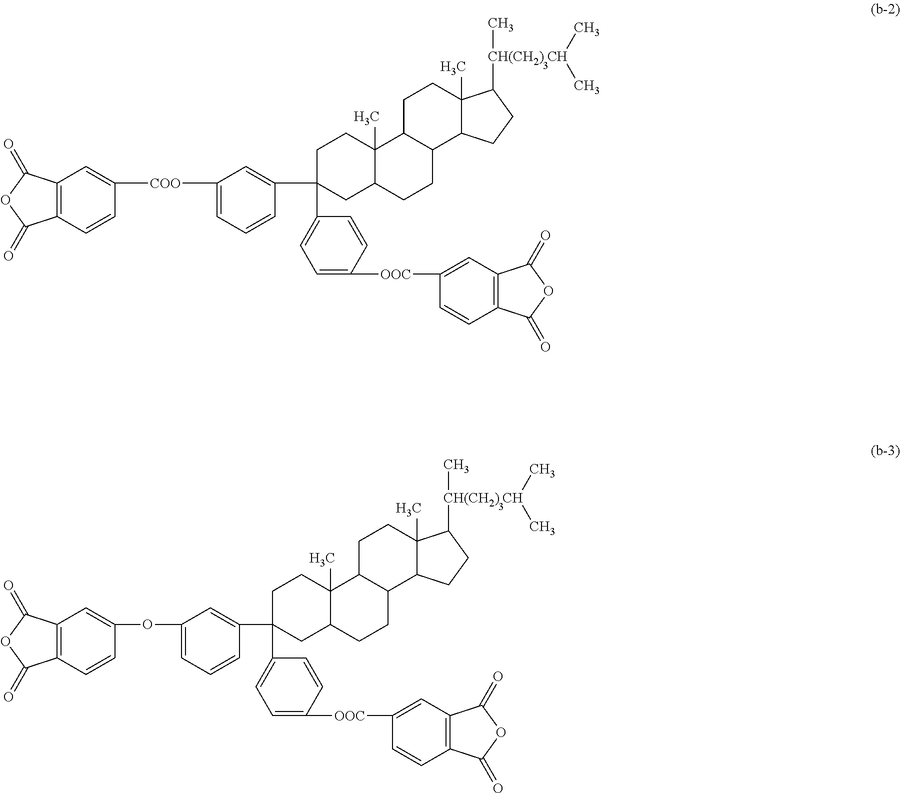

Further, in a case where polyamic acid as the polymer compound precursor is synthesized so that the pre-alignment process compound includes the group shown in Formula 1 along with a cross-linkable functional group, in addition to the compounds including a cross-linkable functional group described above, the compounds including a group able to be along the liquid crystal molecules 41 represented by Formulae C-1 to C-20 may be used as diamine compounds.

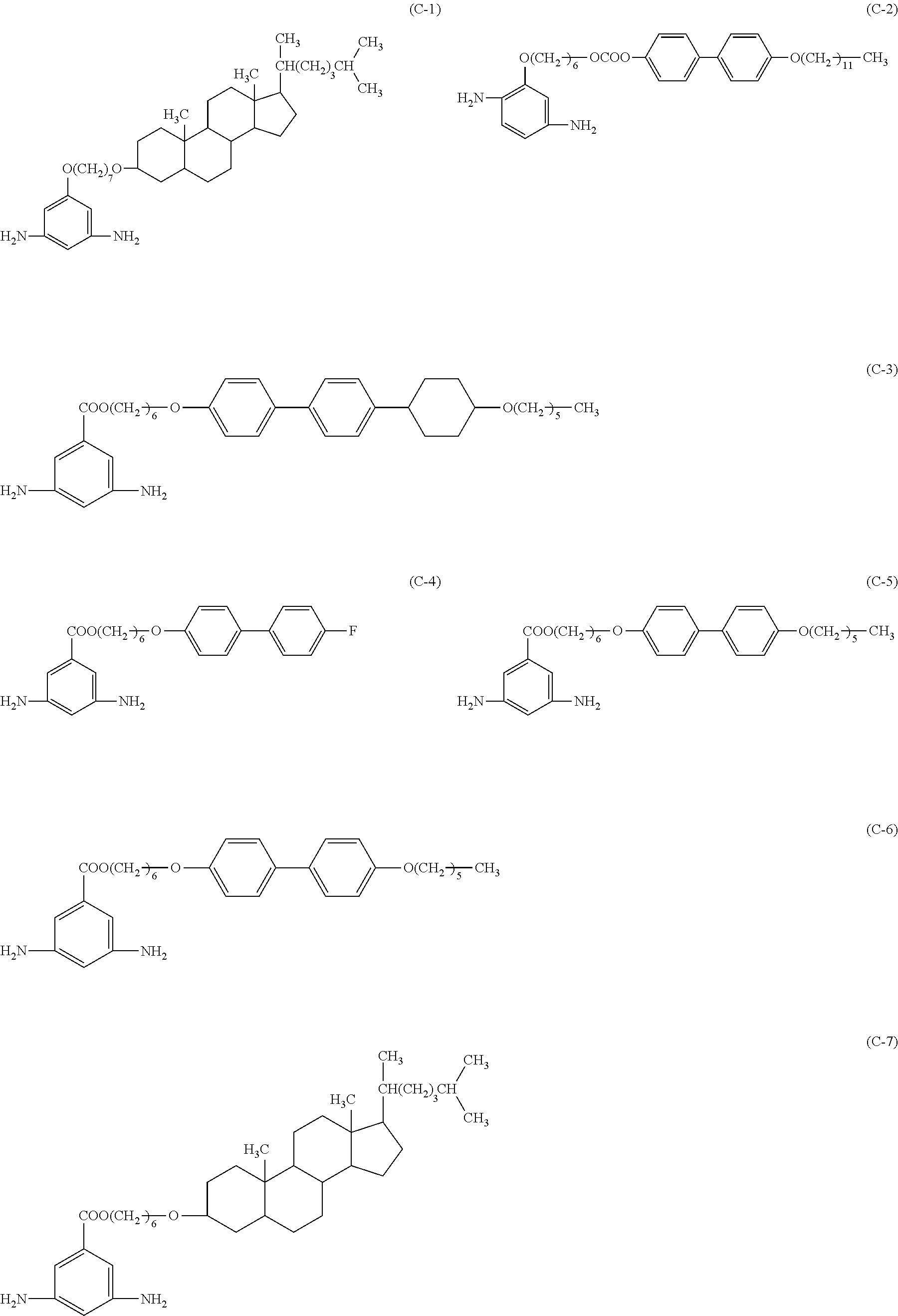

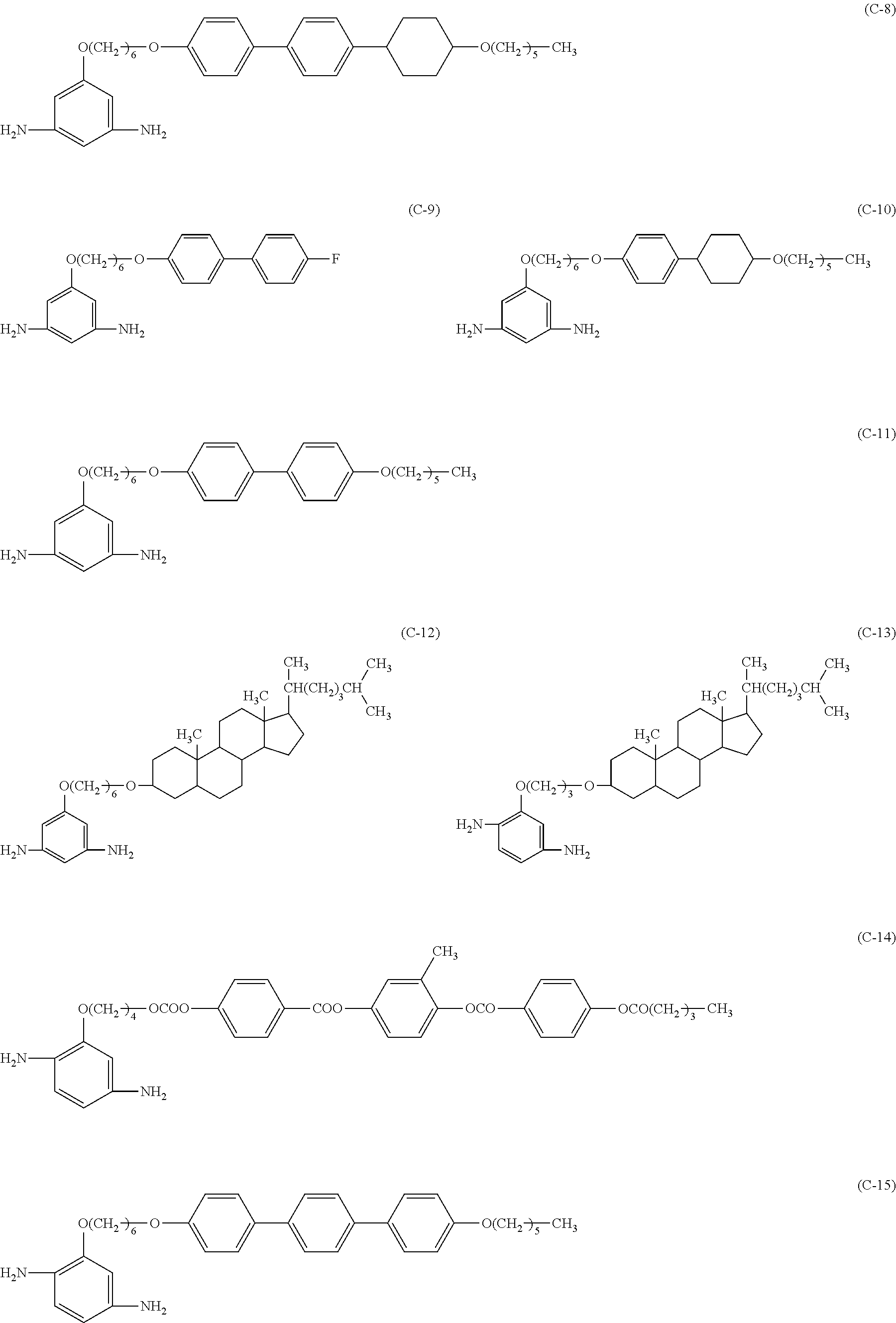

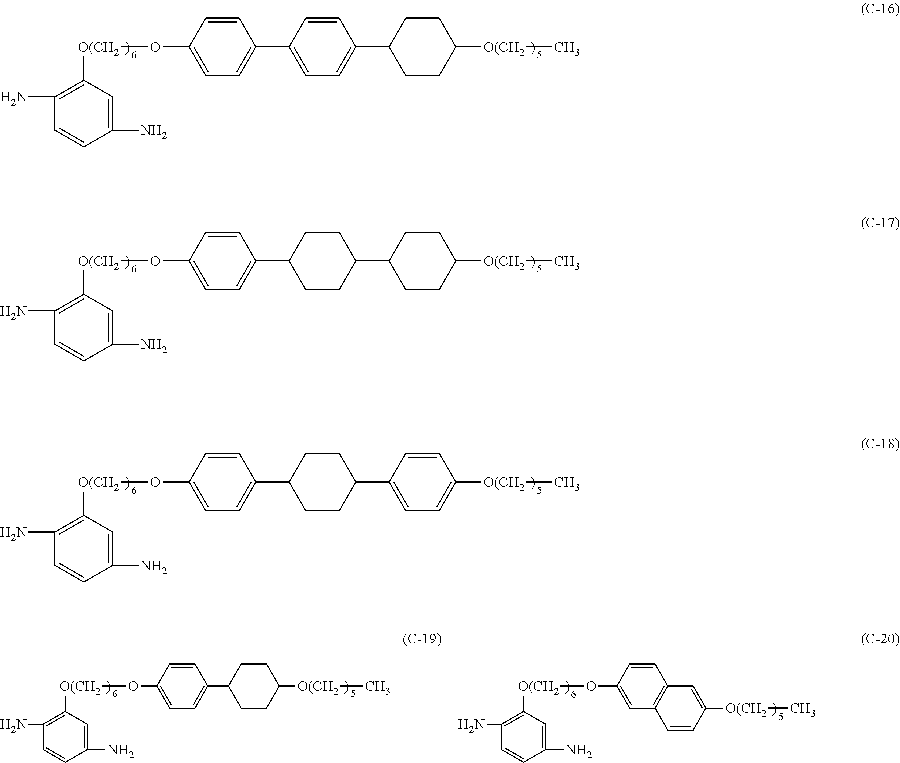

Further, in a case where polyamic acid as the polymer compound precursor is synthesized so that the pre-alignment process compound includes the group shown in Formula 2, in addition to the compounds including a cross-linkable functional group described above, the compounds including a group able to be along the liquid crystal molecules 41 represented by Formulae D-1 to D-7 may be used as diamine compounds.

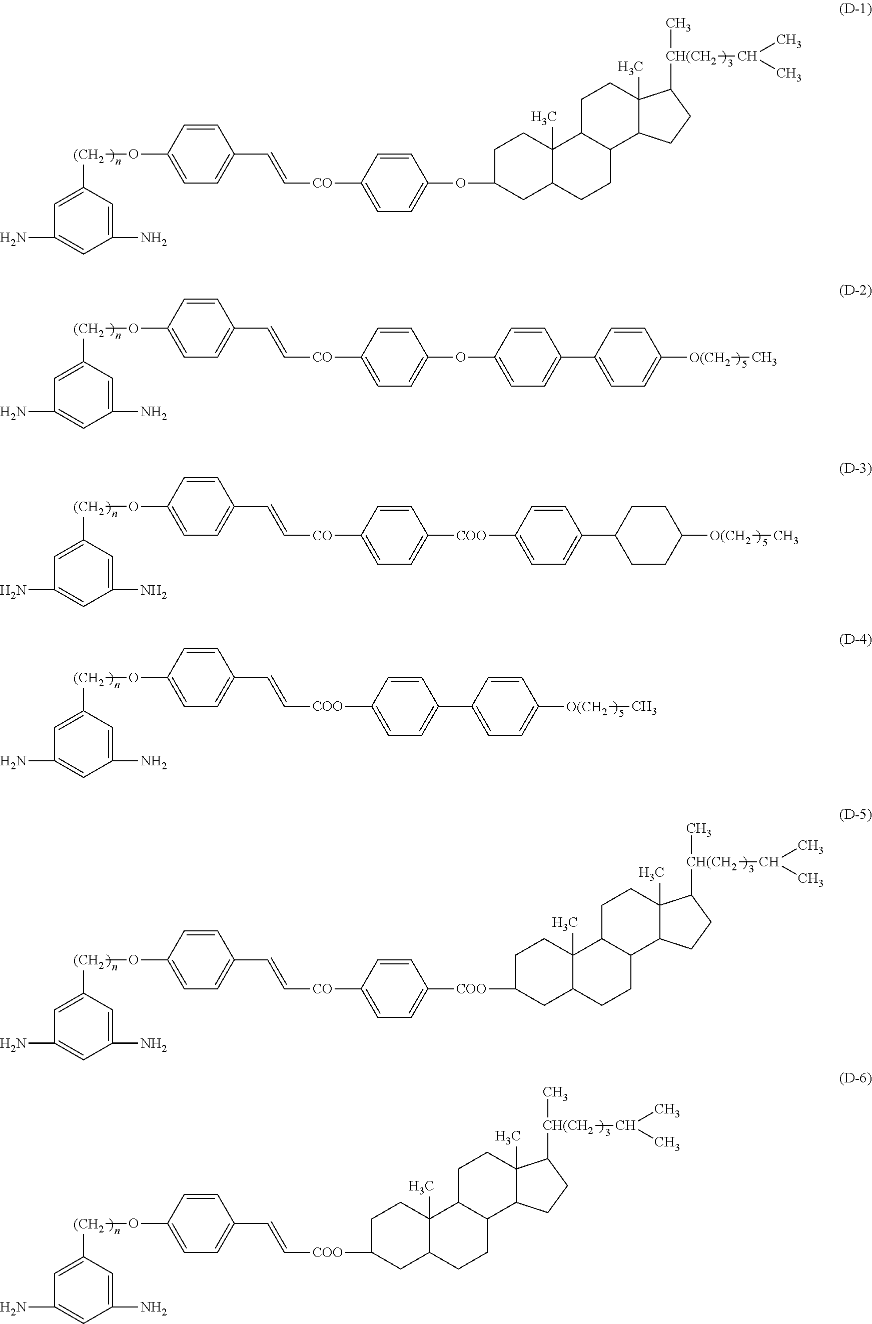

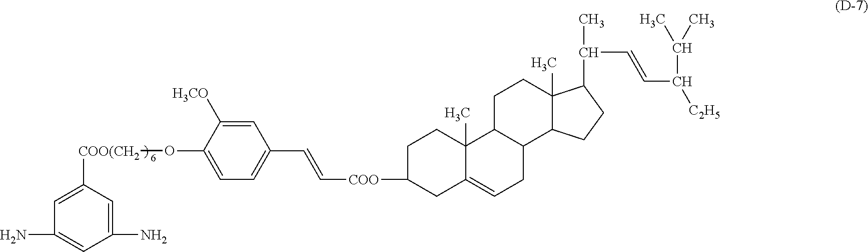

Here, n is an integer equal to or greater than 3 and equal to or less than 20.

Furthermore, in a case where polyamic acid as the polymer compound precursor is synthesized so that the pre-alignment process compound includes the two types of structures of a structure including a vertical alignment inducing structure portion as R2 in Formula 3 and a structure including a cross-linkable functional group, the diamine compound and the tetracarboxylic dianhydride are selected in the following manner, for example. That is, at least one type out of the compounds including a cross-linkable functional group shown in Formulae A-1 to A-15, at least one type of the compounds including a vertical alignment inducing structure portion shown in Formulae B-1 to B-36 and Formulae b-1 to b-3, and at least one type of the tetracarboxylic dianhydrides represented by Formulae E-1 to E-28 are used. Here, R1 and R2 in Formula E-23 are the same or different alkyl groups, alkoxy groups, or halogen atoms, and the type of halogen atoms is arbitrary.

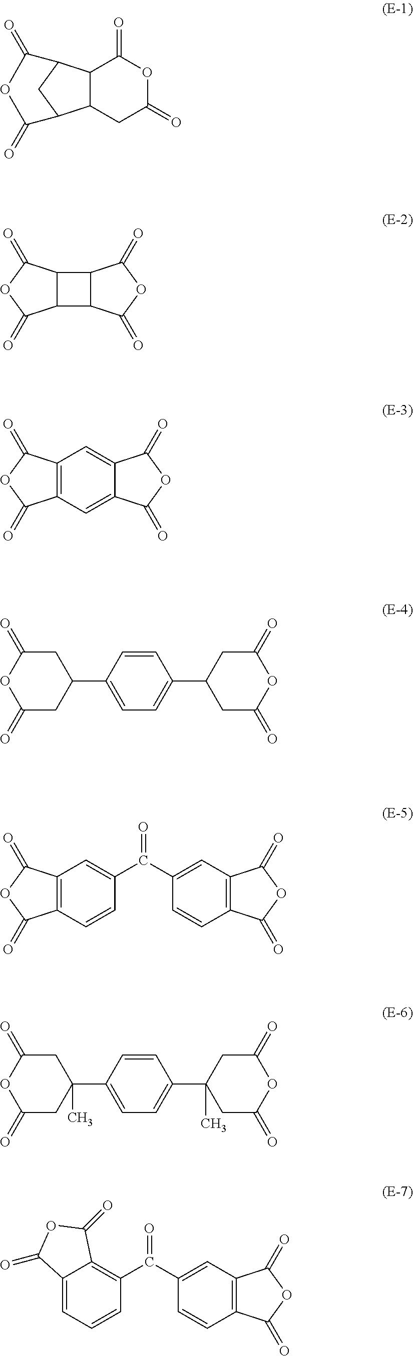

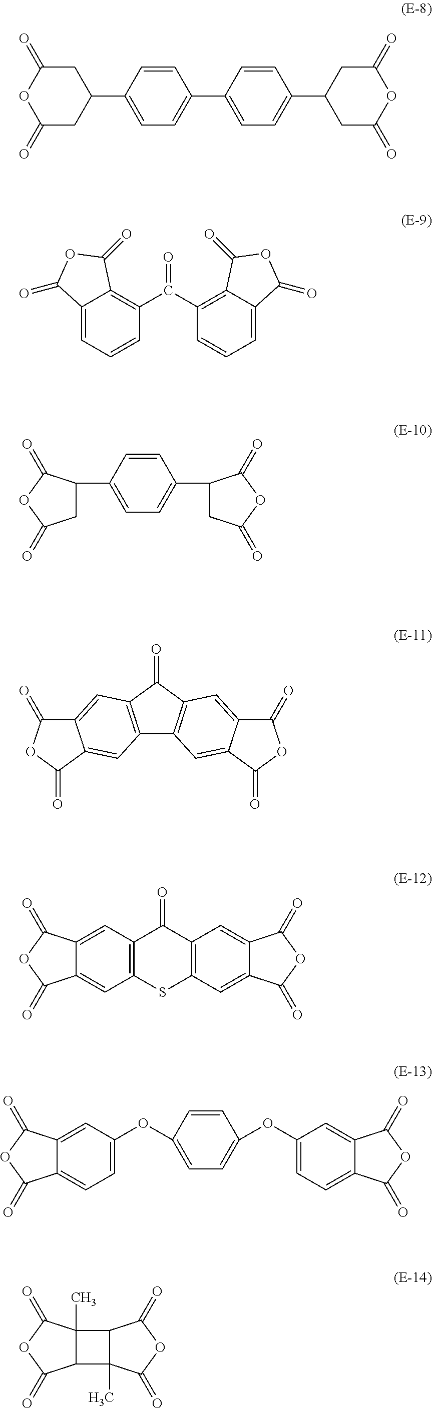

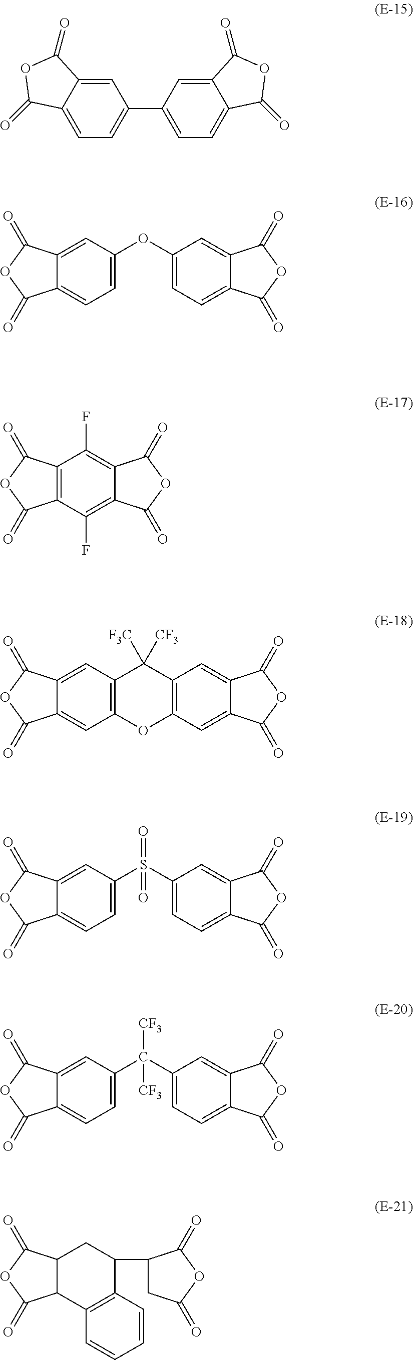

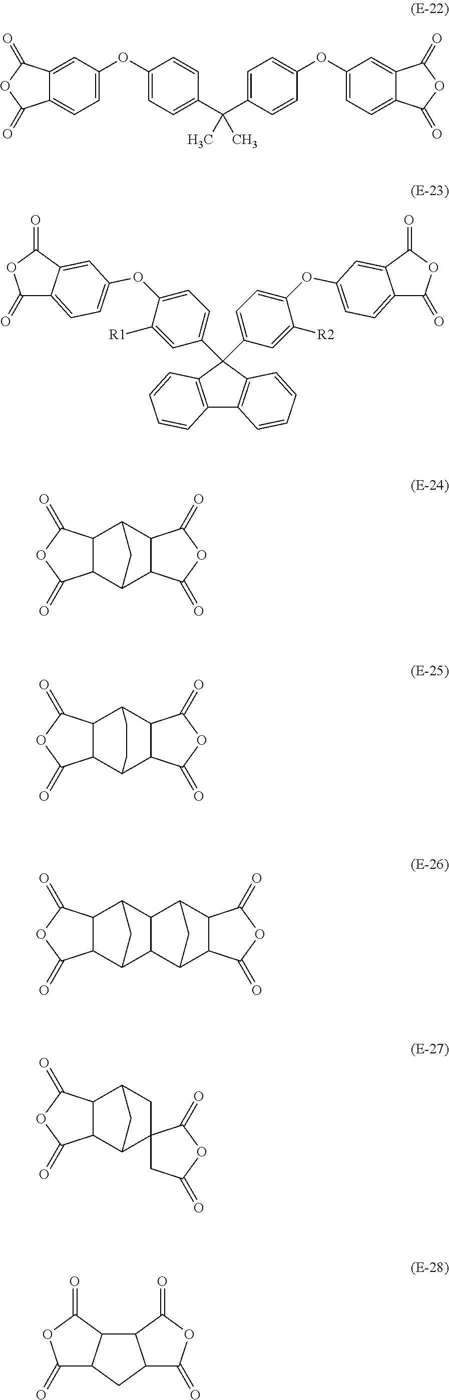

Here, R1 and R2 are alkyl groups, alkoxy groups, or halogen atoms.

Further, in a case where a polyamic acid as the polymer compound precursor is synthesized so that the pre-alignment process compound includes the two types of structures of a structure including the group shown in Formula 1 as R2 in Formula 3 and a structure including a cross-linkable functional group, the diamine compound and the tetracarboxylic dianhydride are selected in the following manner, for example. That is, at least one type out of the compounds including a cross-linkable functional group shown in Formulae A-1 to A-15, at least one type of the compounds shown in Formulae C-1 to C-20, and at least one type of the tetracarboxylic dianhydrides represented by Formulae E-1 to E-28 are used.

Further, in a case where polyamic acid as the polymer compound precursor is synthesized so that the pre-alignment process compound includes the two types of structures of a structure including the group shown in Formula 2 as R2 in Formula 3 and a structure including a cross-linkable functional group, the diamine compound and the tetracarboxylic dianhydride are selected in the following manner, for example. That is, at least one type out of the compounds including a cross-linkable functional group shown in Formulae A-1 to A-15, at least one type of the compounds shown in Formulae D-1 to D-7, and at least one type of the tetracarboxylic dianhydrides represented by Formulae E-1 to E-28 are used.

The content amount of the pre-alignment process compound or the polymer compound precursor as the pre-alignment compound within the alignment film material is preferably equal to or greater than 1 mass % and equal to or less than 30 mass %, and more preferably equal to or greater than 3 mass % and equal to or less than 10 mass %. Further, a photopolymerization initiator or the like may be mixed in the alignment film material as necessary.

Furthermore, after applying or printing the prepared alignment film material on the TFT substrate 20 and the CF substrate 30 respectively to cover the pixel electrodes 20B and the slit portions 21 and the opposing electrodes 30B, a heating process is performed. The temperature of the heating process is preferably equal to or greater than 80° C., and equal to or greater than 150° C. and equal to or less than 200° C. is more preferable. Further, the heating temperature of the heating process may be gradually changed. In so doing, the solvent included in the applied or printed alignment film material evaporates, and the alignment films 22 and 32 including the polymer compound (pre-alignment process compound) including a cross-linkable functional group as a side chain are formed. Processes such as rubbing may be performed thereafter as necessary.

Here, it is considered that the pre-alignment process compound within the alignment films 22 and 32 is in the state illustrated in FIG. 5. That is, the pre-alignment process compound includes a main chain Mc (Mc1 to Mc3) and a cross-linkable functional group A introduced to the main chain Mc as a side chain, and exists in a state in which the main chains Mc1 to Mc3 are not linked. The cross-linkable functional group A in such a state faces a random direction due to thermal motion.

Next, the TFT substrate 20 and the CF substrate 30 are arranged so that the alignment film 22 and the alignment film 32 are opposing, and the liquid crystal layer 40 including the liquid crystal molecules 41 and the pretilt stability conferring compound is sealed between the alignment film 22 and the alignment film 32 (step S102). Specifically, spacer protrusions for securing a cell gap, for example, plastic beads or the like are dispersed on the face of either one of the TFT substrate 20 or the CF substrate 30 on which the alignment films 22 and 32 are formed, and a sealing portion is printed, for example using an epoxy adhesive or the like through screen printing. Thereafter, as illustrated in FIG. 6, the TFT substrate 20 and the CF substrate 30 are pasted together via the spacer protrusions and the sealing portion so that the alignment films 22 and 32 are opposing, and the liquid crystal material including the liquid crystal molecules 41 and the pretilt stability conferring compound is injected. By then performing curing of the sealing portion by heating or the like, the liquid crystal material is sealed between the TFT substrate 20 and the CF substrate 30. FIG. 6 illustrates a cross-sectional configuration of the liquid crystal layer 40 sealed between the alignment film 22 and the alignment film 32.

Next, as illustrated in FIG. 7, a voltage V1 is applied between the pixel electrodes 20B and the opposing electrodes 30B using a voltage application section 1 (step S103). The voltage V1 is, for example, 5 volts to 30 volts. In so doing, an electric field in a direction with a predetermined angle with respect to the surfaces of the glass substrates 20A and 30A is generated, and the liquid crystal molecules 41 are aligned inclined in a predetermined direction from the vertical direction of the glass substrates 20A and 30A. That is, the azimuth angle (angle of deviation) of the liquid crystal molecules 41 at this time is regulated by the direction of the electric field, and the polar angle (zenith angle) is regulated by the strength of the electric field. Furthermore, the inclination angle of the liquid crystal molecules 41 and the pretilts θ1 and θ2 conferred on the liquid crystal molecules 41A retained by the alignment film 22 in the vicinity of the interface with the alignment film 22 and the liquid crystal molecules 41B retained by the alignment film 32 in the vicinity of the interface with the alignment film 32 in a process described later are approximately equal. Therefore, by adjusting the value of the voltage V1 as appropriate, the values of the pretilts θ1 and θ2 of the liquid crystal molecules 41A and 41B are able to be controlled.

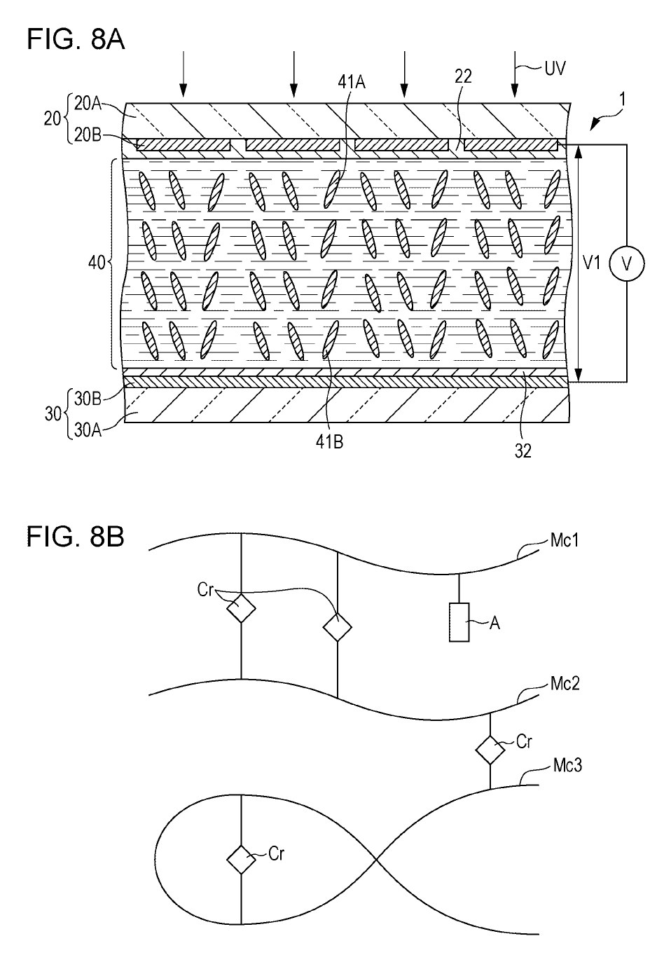

Furthermore, as illustrated in FIG. 8A, energy rays (specifically, ultraviolet rays UV) are irradiated on the alignment films 22 and 32 from the outside of the TFT substrate 20, for example, while still in a state in which the voltage V1 is applied. That is, ultraviolet rays are irradiated while an electric field or a magnetic field is applied to the liquid crystal layer so that the liquid crystal molecules 41 are arranged in a diagonal direction with respect to the surfaces of the pair of substrate 20 and 30. In so doing, the cross-linkable functional group that the pre-alignment process compound within the alignment films 22 and 32 includes is reacted, and the pre-alignment process compound is cross-linked (step S104). In such a manner, the direction in which the liquid crystal molecules 41 are to respond is stored by the post-alignment process compound, and a pretilt is conferred on the liquid crystal molecules 41 in the vicinity of the alignment films 22 and 32. Furthermore, as a result, the post-alignment process compound is formed within the alignment films 22 and 32, and the pretilts θ1 and θ2 are conferred in a non-driving state on the liquid crystal molecules 41A and 41B positioned in the vicinity of the interface with the alignment films 22 and 32 within the liquid crystal layer 40. Ultraviolet rays including a large number of optical components with a wavelength of approximately 365 nm are preferable as the ultraviolet rays UV. The reason is that if ultraviolet rays including a large number of optical components with short wavelength bands are used, there is a concern that the liquid crystal molecules 41 photolyze and deteriorate. Here, while the ultraviolet rays UV are irradiated from the outside of the TFT substrate 20, the ultraviolet rays UV may be irradiated from the outside of the CF substrate 30, and may be irradiated from the outside of both substrates of the TFT substrate 20 and the CF substrate 30. In such a case, the ultraviolet rays UV are preferably irradiated from the substrate side with the higher transmission rate. Further, in a case where the ultraviolet rays UV are irradiated from the outside of the CF substrate 30, depending on the wavelength band of the ultraviolet rays UV, there is a concern that the ultraviolet rays UV are absorbed by the color filter and do not easily cross-link and react. Therefore, the ultraviolet rays UV are preferably irradiated from the outside of the TFT substrate 20 (side of the substrate including the pixel electrodes).

Here, the post-alignment process compound within the alignment films 22 and 32 are in the state illustrated in FIG. 8B. That is, the alignment of the cross-linkable functional group A introduced to the main chain Mc of the pre-alignment process compound changes according to the alignment direction of the liquid crystal molecules 41, cross-linkable functional groups A that are physically close react with one another, and a linked portion Cr is formed. It is considered that the alignment films 22 and 32 formed by the post-alignment process compound generated in such a manner confer the pretilts θ1 and θ2 with respect to the liquid crystal molecules 41A and 41B. Here, the linked portion Cr may be formed between pre-alignment process compounds or may be formed within the pre-alignment process compound. That is, as illustrated in FIG. 8B, the linked portion Cr may be formed, for example, by reaction between the cross-linkable functional group A of a pre-alignment process compound including the main chain Mc1 and the cross-linkable functional group A of a pre-alignment process compound including the main chain Mc2. Further, the linked portion Cr may be formed, for example, by the cross-linkable functional groups A introduced to the same main chain Mc3 reacting as with a polymer compound including the main chain Mc3.

The liquid crystal display device (liquid crystal display element) illustrated in FIG. 1 is able to be completed by the processes described above.

According to the action of the liquid crystal display device (liquid crystal display element), at a selected pixel 10, when a driving voltage is applied, the alignment state of the liquid crystal molecules 41 included in the liquid crystal layer 40 changes according to the potential difference between the pixel electrodes 20B and the opposing electrodes 30B. Specifically, in the liquid crystal layer 40, the liquid crystal molecules 41A and 41B positioned in the vicinity of the alignment films 22 and 32 incline in their own inclination directions by the driving voltage being applied from the state before the driving voltage is applied illustrated in FIG. 1, and the action is propagated to the other liquid crystal molecules 41C. As a result, the liquid crystal molecules 41 respond to adopt a posture that is approximately horizontal (parallel) with respect to the TFT substrate 20 and the CF substrate 30. In so doing, the optical characteristics of the liquid crystal layer 40 change, incident light on the liquid crystal display element becomes modulated emission light, and a picture is displayed by gradations being expressed based on the emission light.

Moreover, in the liquid crystal layer 40, as a result of the mutual alignment correlation between the liquid crystal molecules 41 being weakened by a pretilt stability conferring compound entering between a type of bar-like liquid crystal molecules 41, the distortion of the liquid crystal molecules 41 in the vicinity of the alignment film interface after the pretilt is conferred is relieved, the response speed is improved by the improvement in the alignment stability (pretilt stability) and the improvement in the smoothness of alignment change, and excellent response characteristics are obtained.

Here, in a liquid crystal display element in which there has been no pretilt process whatsoever and a liquid crystal display device including the same, even if an alignment regulation unit such as a slit portion for regulating the alignment of the liquid crystal molecules is provided on the substrates, when a driving voltage is applied, the directors of the liquid crystal molecules aligned in the vertical direction with respect to the substrates incline toward an arbitrary direction in the in-plane direction of the substrates. The liquid crystal molecules responding to the driving voltage in such a manner are in a state in which the direction of the director of each liquid crystal molecule is deviated, causing distortion in the overall alignment. Consequently, there is a problem in that the response speed slows, the response characteristics deteriorate, and as a result, the display characteristics degenerate. Further, if the initial driving voltage is driven by being set higher than the driving voltage of the display state (overdrive driving), there are responsive liquid crystal molecules and liquid crystal molecules that hardly respond at all when the initial driving voltage is applied, and there is a large difference in the inclination of the directors therebetween. When the driving voltage of the display state is then applied, the liquid crystal molecules that responded when the initial driving voltage was applied have directors inclined according to the driving voltage of the display state while the action thereof is hardly propagated to the other liquid crystal molecules, and such an inclination is propagated to the other liquid crystal molecules. As a result, while the pixel as a whole reaches the brightness of the display state when the initial driving voltage is applied, the brightness decreases thereafter before reaching the brightness of the display state once again. That is, when overdrive driving is performed, while the apparent response speed is faster than in a case where overdrive driving is not performed, there is a problem in that sufficient display quality is not easily obtained. Here, such problems tend not to occur with an IPS mode or FFS mode liquid crystal display element, and are considered problems unique to VA mode liquid crystal display elements.

On the other hand, with the liquid crystal display device (liquid crystal display element) of Embodiment 1 and the method of manufacturing the same, the alignment films 22 and 32 described above confer the predetermined pretilts θ1 and θ2 on the liquid crystal molecules 41A and 41B. In so doing, the problems of a case where a pretilt process is not performed at all tend not to occur, the response speed to the driving voltage is greatly improved, and the display quality during overdrive driving is also improved. Moreover, since the slit portions 21 or the like as an alignment regulation unit for regulating the alignment of the liquid crystal molecules 41 are provided on at least one of the TFT substrate 20 and the CF substrate 30, and display characteristics such as viewing angle characteristics are secured, the response characteristics are improved in a state in which favorable display characteristics are maintained.

Further, with a method of manufacturing a liquid crystal display device of the related art (optically alignment film technique), an alignment film is formed by irradiating linearly polarized light or light in a diagonal direction with respect to the substrate face (hereinafter referred to as “diagonal light”) on a precursor film including a predetermined polymer material provided on a substrate face, thereby performing a pretilt process. Therefore, there is a problem in that large-scale light irradiation devices such as a device irradiating linearly polarized light or a device irradiating diagonal light is used when forming alignment films. Further, in the formation of pixels with a multi-domain for realizing a wider viewing angle, as well as an even more large-scale device being used, there is a problem in that the manufacturing process is made complex. In particular, in a case where an alignment film is formed using diagonal light, if there are structures such as spacers or concavities and convexities on the substrates, regions in the shadow of the structures or the like where diagonal light does not reach are created, making desired alignment regulation with respect to the liquid crystal molecules in such regions difficult. In such a case, for example, in order to irradiate diagonal light using a photomask for providing a multi-domain within a pixel, a pixel design taking the wraparound of light is used. That is, in a case where an alignment film is formed using diagonal light, there is also a problem in that high-precision pixel formation is difficult.

Furthermore, among the optically alignment film techniques of the related art, in a case where a cross-lined polymer compound is used as the polymer material, since the cross-linkable functional group included in the cross-linked polymer compound in the precursor film faces a random direction through thermal motion, the probability of the cross-linkable functional groups coming physically close to one another decreases. Moreover, in a case where random light (unpolarized light) is irradiated, while the cross-linkable functional groups react by the physical distance therebetween shortening, a cross-linkable functional group reacting by linearly polarized light being irradiated only reacts when the polarization direction and the direction of the reacting portion are matched in a predetermined direction. Further, since diagonal light widens the irradiation area compared to vertical light, the irradiation amount per unit area decreases. That is, the proportion of cross-linkable functional groups reacting to linearly polarized light or diagonal light decreases compared to a case where random light (unpolarized light) is irradiated from the vertical direction with respect to the substrate faces. Accordingly, the cross-link density (cross-linkability) within the formed alignment film tends to be low.

On the other hand, in Embodiment 1, after forming the alignment films 22 and 32 including the pre-alignment process compound, the liquid crystal layer 40 is sealed between the alignment film 22 and the alignment film 32. Next, by applying a voltage to the liquid crystal layer 40, the liquid crystal molecules 41 adopt a predetermined alignment, and the pre-alignment process compound within the alignment films 22 and 32 is cross-linked while the alignment of the cross-linkable functional group is ordered by the liquid crystal molecules 41 (that is, while the direction of the terminal structure portion of the side chain with respect to the substrates or the electrodes being regulated by the liquid crystal molecules 41). In so doing, the alignment films 22 and 32 conferring the pretilt θ on the liquid crystal molecules 41A and 41B are able to be formed. That is, according to the liquid crystal display device (liquid crystal display element) of Embodiment 1 and a method of manufacturing the same, the response characteristics are able to be improved easily even without using a large-scale device. Moreover, since the pretilt θ is able to be conferred on the liquid crystal molecules 41 without being dependent on the irradiation direction of ultraviolet rays when the pre-alignment process compound is cross-linked, pixels with high precision are able to be formed. Furthermore, since the post-alignment process compound is generated in a state in which the alignment of the cross-linkable functional group within the pre-alignment process compound is ordered, it is considered that the cross-linkability of the post-alignment process compound is higher than in alignment films made using the method of manufacturing of the related art described above. Accordingly, since new cross-linked structures tend not to be formed during driving even with driving over a long period of time, the pretilts θ1 and θ2 of the liquid crystal molecules 41A and 41B are maintained in the state during the manufacture, improving reliability.

In such a case, in Embodiment 1, since the pre-alignment process compound within the alignment films 22 and 32 is cross-linked after the liquid crystal layer 40 is sealed between the alignment films 22 and 32, the transmission rate during the driving of the liquid crystal display element is able to be changed to continuously increase.

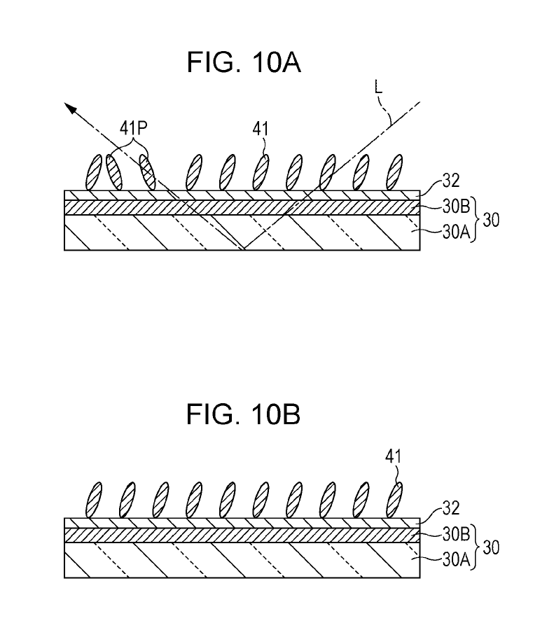

In detail, in a case where the optically alignment film technique of the related art is used, as illustrated in FIG. 10A, since a portion of diagonal light L irradiated to perform a pretilt process is reflected by the reverse face of the glass substrate 30, the direction of the pretilt is distorted at a portion (41P) of the liquid crystal molecules 41. In such a case, since the direction of the pretilt of a portion of the liquid crystal molecules 41 deviates from the direction of the pretilt of the other liquid crystal molecules 41, the order parameter which is an index representing the alignment state of the liquid crystal molecules 41 (how even the alignment state is) is small. Consequently, during the initial drive of the liquid crystal display element, by the portion of the liquid crystal molecules 41P in which the direction of the pretilt is deviated exhibiting a different behavior from the other liquid crystal molecules 41 and being aligned in a direction different from the other liquid crystal molecules 41, the transmission rate increases. However, since the liquid crystal molecules 41P are then aligned to match the alignment of the other liquid crystal molecules 41, the director direction of the liquid crystal molecules 41p which are temporarily inclines matches the director direction of the other liquid crystal molecules 41 after becoming vertical with respect to the substrate faces. Therefore, there is a possibility that the transmission rate of the liquid crystal display element does not continuously increase, and there is a possibility that the transmission rate decreases locally.

On the other hand, in Embodiment 1 in which a pretilt process is performed by a cross-link reaction of the pre-alignment process compound after the liquid crystal layer 40 is sealed, a pretilt is conferred according to the alignment direction of the liquid crystal molecules 41 during driving by an alignment regulation unit for regulating the alignment of the liquid crystal molecules 41 such as the slit portions 21. Accordingly, since the directions of the pretilts of the liquid crystal molecules 41 tend to match as illustrated in FIG. 10B, the order parameter increases (nears 1). In so doing, since the liquid crystal molecules 41 exhibit an even behavior when the liquid crystal display element is driven, the transmission rate continuously increases.

In such a case, in particular, if the pre-alignment process compound includes the group shown in Formula 1 along with a cross-linkable functional group, or the pre-alignment process compound includes the group shown in Formula 2 as a cross-linkable functional group, the alignment films 22 and 32 are more easily able to confer the pretilt θ. Therefore, the response speed is able to be improved further.

Furthermore, in another method of manufacturing a liquid crystal display element of the related art, after forming the liquid crystal layer using a liquid crystal material including a photopolymerizable monomer or the like, in a state in which the monomer is included, the monomer is polymerized by irradiating light while aligning the liquid crystal molecules in the liquid crystal layer in a predetermined direction. A polymer formed in such a manner confers a pretilt on the liquid crystal molecules. However, in the manufactured liquid crystal display element, there is a problem in that unreacted photopolymerizable monomers remain in the liquid crystal layer, decreasing reliability. Further, there is a problem in that the light irradiation period is prolonged in order to decrease the unreacted monomers, increasing the amount of time (cycle time) used in manufacture.

On the other hand, in Embodiment 1, since the alignment films 22 and 32 confer the pretilts θ1 and θ2 to the liquid crystal molecules 41A and 41B within the liquid crystal layer 40 even without forming the liquid crystal layer using a liquid crystal material in which monomers are added as described above, reliability is able to be improved. Furthermore, the cycle time is also able to be suppressed from being prolonged. Furthermore, the pretilt θ is able to be conferred on the liquid crystal molecules 41A and 41B favorably even without using a technique of conferring a pretilt on the liquid crystal molecules of the related art such as a rubbing process. Therefore, problems associated with a rubbing process such as a decrease in contrast due to rubbing marks in which marks are made on the alignment films, disconnection of wiring due to static electricity when rubbing, and a decrease in reliability and the like due to foreign matter, do not occur.

While a case where the alignment films 22 and 32 containing a pre-alignment process compound including a main chain mainly including a polyimide structure is used has been described in Embodiment 1, the main chain that the pre-alignment process compound includes is not limited to those including a polyimide structure. For example, the main chain may include a polysiloxane structure, a polyacrylate structure, a polymethacrylate structure, a maleimide polymer structure, a styrene polymer structure, a styrene or maleimide polymer structure, a polysaccharide structure, a polyvinyl alcohol structure, or the like may be included, of which a pre-alignment process compound including a main chain including a polysiloxane structure is preferable. Further, a glass transition temperature T_{g} of the compound configuring the main chain is desirably equal to or greater than 200° C. The reason is that that the same effects as the polymer compound including the polyimide structure described above are then obtained. An example of a pre-alignment process compound including a main chain including a polysiloxane structure is the polymer compound including a polysilane structure represented by Formula 9, for example. While R10 and R11 in Formula 9 are arbitrary as long as R10 and R11 are monovalent groups configured to include carbon, a cross-linkable functional group as a side chain is preferably included in either one of R10 and R11. The reason is that a sufficient alignment regulation function in the post-alignment process compound is then easily obtained. An example of the cross-linkable functional group in such a case is the group shown in Formula 41 described above, or the like.

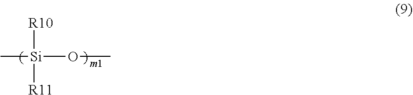

Here, R10 and R11 are monovalent organic groups, and m1 is an integer equal to or greater than 1.

Furthermore, while in Embodiment 1, the viewing angle characteristics are to be improved by dividing alignments by providing the slit portions 21 on the pixel electrodes 20B, Embodiment 1 is not limited thereto. For example, protrusions as alignment regulation units may be provided between the pixel electrodes 20B and the alignment film 22 instead of the slit portions 21. The same effects as a case where the slit portions 21 are provided are able to be obtained by providing protrusions in such a manner. Furthermore, protrusions as alignment regulation units may also be provided between the opposing electrodes 30B and the alignment film 32 of the CF substrate 30. In such a case, the protrusions on the TFT substrate 20 and the protrusions on the CF substrate 30 are arranged to not be opposing between the substrate. In such a case, the same effects as described above are still able to be obtained.

Next, while other embodiments will be described, the same symbols are given to constituent elements common with Embodiment 1, and description thereof will be omitted as appropriate. Further, the same actions and effects as Embodiment 1 will also be omitted as appropriate. Furthermore, the various technical items described above for Embodiment 1 will be applied to the other embodiments as appropriate.

### Embodiment 2

Embodiment 2 is a modification of Embodiment 1. While a liquid crystal display device (liquid crystal display element) in which the alignment films 22 and 32 are formed so that the pretilts θ1 and θ2 of the liquid crystal molecules 41A and 41B positioned in the vicinity thereof are approximately the same has been described in Embodiment 1, the pretilt θ1 and the pretilt θ2 are different in Embodiment 2.

Specifically, in Embodiment 2, first, similarly to step S101 described above, the TFT substrate 20 including the alignment film 22 and the CF substrate 30 including the alignment film 32 are created. Next, an ultraviolet radiation absorber, for example, is included in sealed in the liquid crystal layer 40. Next, the pre-alignment process compound within the alignment film 22 is cross-linked by irradiating ultraviolet rays from the TFT substrate 20 side by applying a predetermined voltage between the pixel electrodes 20B and the opposing electrodes 30B. At the time, since an ultraviolet radiation absorber is included in the liquid crystal layer 40, the ultraviolet rays incident from the TFT substrate 20 side are absorbed by the ultraviolet radiation absorber within the liquid crystal layer 40, and do hardly any reach the CF substrate 30 side. Therefore, the post-alignment process compound is generated in the alignment film 22. Next, the pre-alignment process compound within the alignment film 32 is reacted by irradiating ultraviolet rays from the CF substrate 30 side by applying a different voltage from the predetermined voltage described above between the pixel electrodes 20B and the opposing electrodes 30B to form the post-alignment process compound. In so doing, the pretilts θ1 and θ2 of the liquid crystal molecules 41A and 41B positioned in the vicinity of the alignment films 22 and 32 are able to be set according to the voltage applied in a case where ultraviolet rays are irradiated from the TFT substrate 20 side and the voltage applied in a case where ultraviolet rays are irradiated from the CF substrate 30 side. Accordingly, the pretilt θ1 and the pretilt θ₂ are able to be differentiated. However, a TFT switching element and various bus lines are provided on the TFT substrate 20, various transverse electric fields are generated during driving. Therefore, the alignment film 22 on the side of the TFT substrate 20 is desirably formed so that the pretilt θ1 of the liquid crystal molecules 41A positioned in the vicinity thereof is greater than the pretilt θ₂ of the liquid crystal molecules 41B positioned in the vicinity of the alignment film 32. In so doing, distortions in the alignment of the liquid crystal molecules 41A due to the transverse electric fields are able to be reduced effectively.

### Embodiment 3

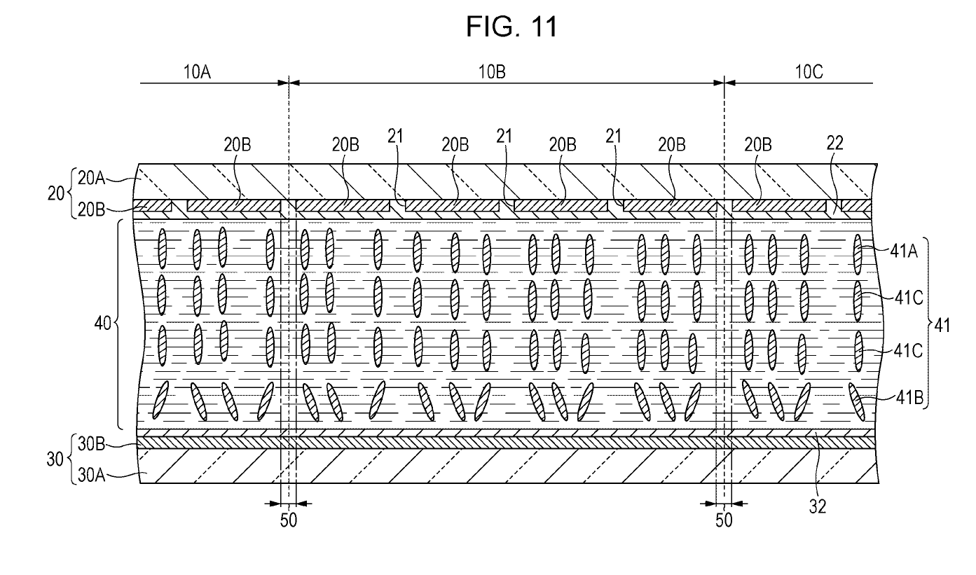

Embodiment 3 is a modification of Embodiments 1 and 2. A schematic partial cross-sectional view of the liquid crystal display device (liquid crystal display element) according to Embodiment 3 is illustrated in FIG. 11. Unlike in Embodiment 1, the alignment film 22 is configured without including the post-alignment process compound in Embodiment 3. That is, in Embodiment 3, while the pretilt θ2 of the liquid crystal molecules 41B positioned in the vicinity of the alignment film 32 has a greater value than 0°, the pretilt θ1 of the liquid crystal molecules 41A positioned in the vicinity of the alignment film 22 is configured to be 0°.

Here, the alignment film 22 is configured, for example by another vertical alignment agent described above.

The liquid crystal display device (liquid crystal display element) of Embodiment 3 is able to be manufactured by using another vertical alignment agent described above instead of the pre-alignment process compound or a polymer compound precursor as the pre-alignment process compound when forming the alignment film 22 on the TFT substrate 20 (step S101 of FIG. 4).

In the liquid crystal display device (liquid crystal display element) of Embodiment 3, the pretilt θ1 of the liquid crystal molecules 41A in the liquid crystal layer 40 is 0°, and the pretilt θ2 of the liquid crystal molecules 41B is greater than 0°. In so doing, the response speed to the driving voltage is able to be greatly improved compared to a liquid crystal display element on which a pretilt process has not been performed. Furthermore, since the liquid crystal molecules 41A are aligned in a state close to the normal direction of the glass substrates 20A and 30A, the transmission amount of light during black display is able to be reduced, and the contrast improved compared to the liquid crystal display devices (liquid crystal display elements) of Embodiments 1 and 2. That is, in the liquid crystal display device (liquid crystal display element), the contrast is improved by making the pretilt θ1 of the liquid crystal molecules 41A positioned on the TFT substrate 20 side 0°, for example, while improving the response speed by making the pretilt θ₂ of the liquid crystal molecules 41B positioned on the CF substrate 30 side greater than 0°. Accordingly, the response speed to the driving voltage and the contrast are able to be improved evenly.

Further, according to the liquid crystal display device (liquid crystal display element) of Embodiment 3 and a method of manufacturing the same, the alignment film 22 not including the pre-alignment process compound is formed on the TFT substrate 20, and the alignment film 32 including the pre-alignment process compound is formed on the CF substrate 30. Next, after sealing the liquid crystal layer 40 between the TFT substrate 20 and the CF substrate 30, the pre-alignment process compound within the alignment film 32 is reacted to generate the post-alignment process compound. Accordingly, since an alignment film 32 conferring the pretilt θ on the liquid crystal molecules 41B even without using a large-scale light irradiation device is able to be formed, the response characteristics are able to be improved easily. Further, for example, compared to a case where a photopolymerizable monomer is polymerized after sealing the liquid crystal layer using a liquid crystal material including a photopolymerizable monomer, high reliability is able to be secured.

Other effects relating to Embodiment 3 are the same as Embodiment 1.

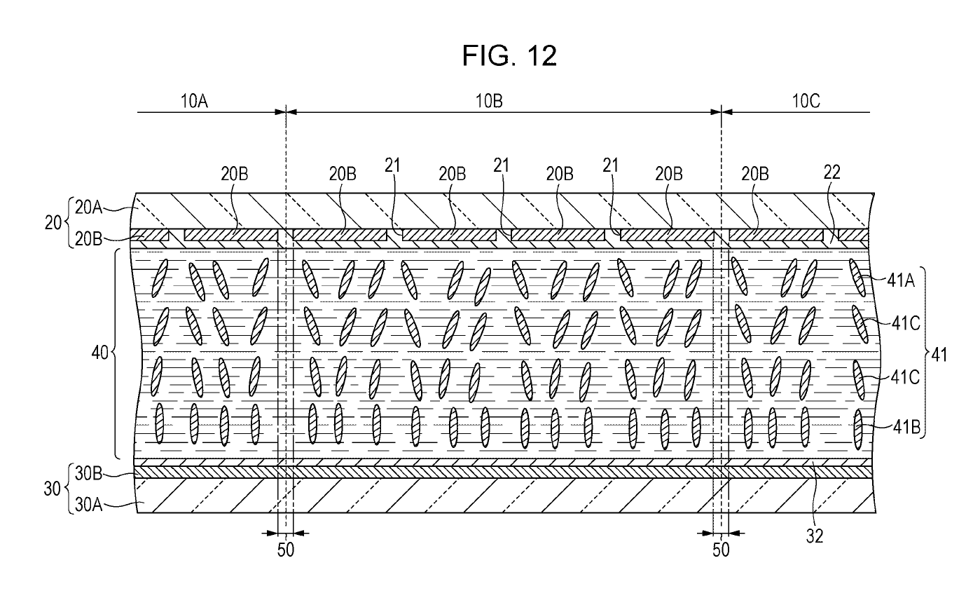

Here, as illustrated in FIG. 11, while Embodiment 3 has a configuration in which the alignment film 32 covering the CF substrate 30 including the post-alignment process compound and the pretilt θ₂ being conferred on the liquid crystal molecules 41B positioned on the side of the CF substrate 30 out of the liquid crystal layer 40, Embodiment 3 is not limited thereto. That is, as illustrated in FIG. 12, there may be a configuration in which the alignment film 22 covering the TFT substrate 20 includes the post-alignment process compound while the alignment film 32 does not include the post-alignment process compound, and the pretilt θ1 is conferred on the liquid crystal molecules 41A positioned on the side of the TFT substrate 20 out of the liquid crystal layer 40. Even in such a case, the same actions and the same effects as Embodiment 3 are able to be obtained. However, since various transverse electric fields are generated during driving on the TFT substrate 20 as described above, the alignment film 22 on the side of the TFT substrate 20 is desirably formed so that the pretilt θ1 is conferred on the liquid crystal molecules 41A positioned in the vicinity thereof. In so doing, distortions in the alignment of the liquid crystal molecules 41 due to the transverse electric fields are able to be reduced effectively.

### Embodiment 4

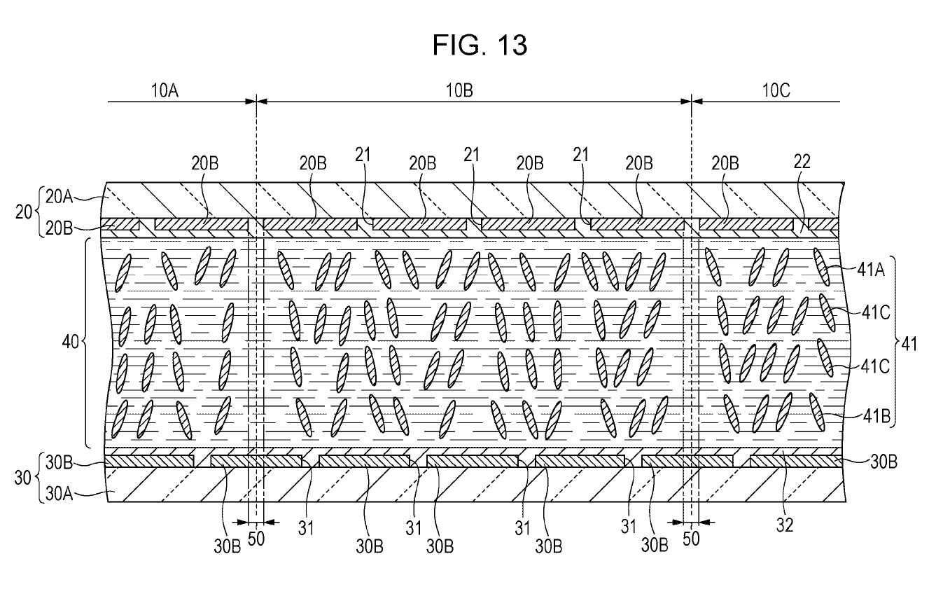

Embodiment 4 is also a modification of Embodiments 1 and 2. A schematic partial cross-sectional view of the liquid crystal display device (liquid crystal display element) according to Embodiment 4 is illustrated in FIG. 13. Other than the configuration of the opposing electrodes 30B that the CF substrate 30 includes being different, Embodiment 4 has the same configuration as the liquid crystal display devices (liquid crystal display elements) of Embodiments 1 and 2.

Specifically, slit portions 31 are provided on the opposing electrodes 30B in each pixel with the same pattern as the pixel electrodes 20B. The slit portions 31 are arranged to not oppose the slit portions 21 between the substrates. In so doing, when a driving voltage is applied, since the response speed to the voltage improves by a diagonal electric field being conferred on the directors of the liquid crystal molecules 41, and a region with a different alignment direction is formed within the pixels (alignment division), the viewing angle characteristics are improved.

The liquid crystal display device (liquid crystal display element) of Embodiment 4 is able to be manufactured by using a substrate on which the opposing electrodes 30B including predetermined slit portions 31 are provided on the color filter of the glass substrate 30A as the CF substrate 30 in step S101 of FIG. 4.

According to the liquid crystal display device (liquid crystal display element) of Embodiment 4 and a method of manufacturing the same, after forming the alignment films 22 and 32 including a polymer compound before being cross-linked, the liquid crystal layer 40 is sealed between the alignment film 22 and the alignment film 32. Next, a cross-linked polymer compound is generated by reacting the polymer compound before cross-linking within the alignment films 22 and 32. In so doing, the predetermined pretilts θ1 and θ2 are conferred on the liquid crystal molecules 41A and 41B. Accordingly, the response speed to the driving voltage is able to be improved greatly compared to a liquid crystal display element on which a pretilt process has not been performed. Therefore, alignment films 22 and 32 conferring the pretilt θ on the liquid crystal molecules 41 are able to be formed even without using a large-scale light irradiation device. Therefore, the response characteristics are able to be improved easily. Furthermore, high reliability is able to be secured compared to a case where a pretilt process is performed by polymerizing a photopolymerizable monomer after sealing the liquid crystal layer using a liquid crystal material including a photopolymerizable monomer, for example.

The actions and effects of the liquid crystal display device (liquid crystal display element) of Embodiment 4 and a method of manufacturing the same are the same as the actions and effects of Embodiments 1 and 2 described above.

Here, while the alignment films 22 and 32 are formed so that the pretilts θ1 and θ2 are conferred on the liquid crystal molecules 41A and 41B positioned in the vicinity thereof in Embodiment 4, the pretilt θ may also be conferred on the liquid crystal molecules 41 positioned in the vicinity of either one of the alignment films 22 and 32 using the same method as the method of manufacturing described in Embodiment 3. Even in such a case, the same actions and effects as in Embodiment 3 are obtained.

### Embodiment 5

In Embodiments 1 to 4, by generating the post-alignment process compound by reacting the pre-alignment process compound on at least one of the alignment films 22 and 32 in a state in which the liquid crystal layer 40 is provided, a pretilt is conferred on the liquid crystal molecules 41 in the vicinity thereof. On the other hand, in Embodiment 5, by disintegrating the structure of the polymer compound on at least one of the alignment films 22 and 32 in a state in which the liquid crystal layer 40 is provided, a pretilt is conferred on the liquid crystal molecules 41 in the vicinity thereof. That is, except for the method of forming the alignment films 22 and 32 being different, the liquid crystal display device (liquid crystal display element) of Embodiment 5 has the same configuration as Embodiments 1 to 4 described above.

In a case where the liquid crystal molecules 41A and 41B have the predetermined pretilts θ1 and θ2, the liquid crystal display device (liquid crystal display element) of Embodiment 5 is manufactured as below, for example. First, the alignment films 22 and 32 including a polymer compound such as the other vertical alignment agent described above, for example, are formed on the TFT substrate 20 and the CF substrate 30. Next, the TFT substrate 20 and the CF substrate 30 are arranged so that the alignment film 22 and the alignment film 32 are opposing, and the liquid crystal layer 40 is sealed between the alignment films 22 and 32. Next, a voltage is applied between the pixel electrodes 20B and the opposing electrodes 30B, ultraviolet rays UV including more optical components with short wavelength bands of approximately a wavelength of 250 nm than the ultraviolet rays UV described above are irradiated on the alignment films 22 and 32 in a state in which the voltage is still applied. At this time, the structure of the polymer compound within the alignment films 22 and 32 is changed by being disintegrated, for example, by the ultraviolet rays UV with short wavelength bands. In so doing, the predetermined pretilts θ1 and θ2 are able to be conferred in the liquid crystal molecules 41A positioned in the vicinity of the alignment film 22 and the liquid crystal molecules 41B positioned in the vicinity of the alignment film 32.

An example of the polymer compound that the alignment films 22 and 32 include before the liquid crystal layer 40 is sealed is the polymer compound including a polyimide structure represented by Formula 10, for example. As shown in the chemical reaction formula of Formula I, the polyimide structure shown in Formula 10 has the structure represented by Formula 11 in which the cyclobutane structure of Formula 10 is disintegrated through the irradiation of ultraviolet rays UV.

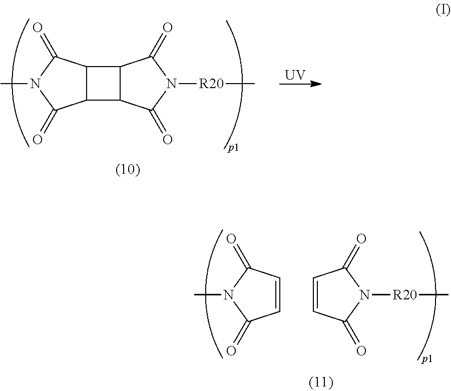

Here, R20 is a divalent organic group, and p1 is an integer equal to or greater than 1.

In Embodiment 5, by the liquid crystal molecules 41A positioned in the vicinity of the alignment film 22 and the liquid crystal molecules 41B positioned in the vicinity of the alignment film 32 having predetermined pretilts θ1 and θ2, the response speed is able to be improved greatly compared to a liquid crystal display element on which a pretilt process has not been performed. Further, at least one of the alignment films 22 and 32 able to confer the pretilt θ on the liquid crystal molecules 41 is able to be formed even without using a large-scale device. Therefore, the response characteristics are able to be improved easily. However, since there is a concern for disintegration or the like of the liquid crystal molecules 41 being caused by the ultraviolet rays irradiated on the alignment films 22 and 32, greater reliability is more easily secured with Embodiments 1 to 4 described above.

### Embodiment 6

Embodiment 6 relates to the liquid crystal display device according to the second embodiment of the present disclosure and the methods of manufacturing the liquid crystal display device according to the second and third embodiments of the present disclosure.

In Embodiments 1 to 4, the post-alignment process compound is obtained by the cross-linkable functional group in the pre-alignment process compound including a cross-linkable functional group as a side chain being cross-linked. On the other hand, in Embodiment 6, the post-alignment process compound is obtained based on a pre-alignment process compound including a photosensitive functional group deformed by the irradiation of energy rays as the side chain.

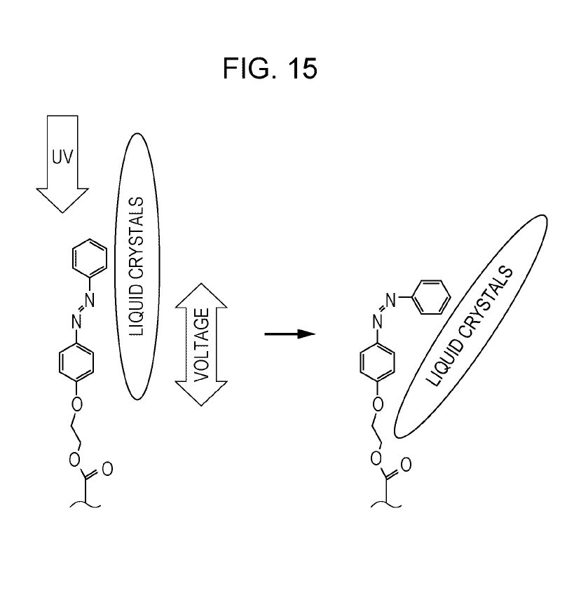

Here, even in Embodiment 6, the alignment films 22 and 32 are configured including one type or two or more types of a polymer compound (post-alignment process compound) including a cross-linked structure in a side chain. Furthermore, a pretilt is conferred on the liquid crystal molecules 41 by a deformed compound. Here, the post-alignment process compound is generated by forming the alignment films 22 and 32 in a state of including one type or two or more types of a polymer compound (pre-alignment process compound) including a main chain and a side chain, providing the liquid crystal layer 40, and deforming the polymer compound, or alternatively, by irradiation energy rays on the polymer compound, more specifically, by deforming the photosensitive functional group included in the side chain while applying an electric field or a magnetic field. Here, such a state is illustrated in the outline view of FIG. 15. Here, in FIG. 15, the direction of the arrow labeled “UV” and the direction of the arrow labeled “voltage” do not indicate the direction in which ultraviolet rays are irradiated and the direction in which an electric field is applied. Furthermore, the post-alignment process compound includes a structure of arranging the liquid crystal molecules 41 in a predetermined direction (specifically, diagonal direction) with respect to a pair of substrates (specifically, the TFT substrate 20 and the CF substrate 30). Since by deforming the polymer compound or irradiating energy rays on the polymer compound in such a manner and the post-alignment process compound being included within the alignment films 22 and 32, a pretilt is able to be conferred on the liquid crystal molecules 41 in the vicinity of the alignment films 22 and 32, the response speed is increased and the display characteristics are improved.

Examples of photosensitive functional groups include an azo benzene-based compound including an azo group, a compound including imine and aldimine in the skeleton (for convenience, referred to as “aldimine benzene”), and a compound including a styrene skeleton (for convenience, referred to as “stilbene”). Such compounds are able to confer a pretilt on the liquid crystal molecules 41 as a result of responding to energy rays (for example, ultraviolet rays) and deforming, that is, as a result of transitioning from a trans state to a cis state.

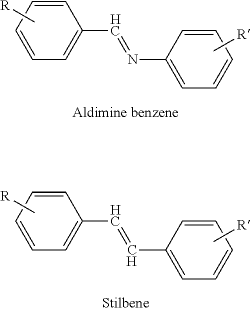

Specifically, examples of “X” in the azo benzene-based compound represented by Formula AZ-0 include the following Formulae AZ-1 to AZ-9.

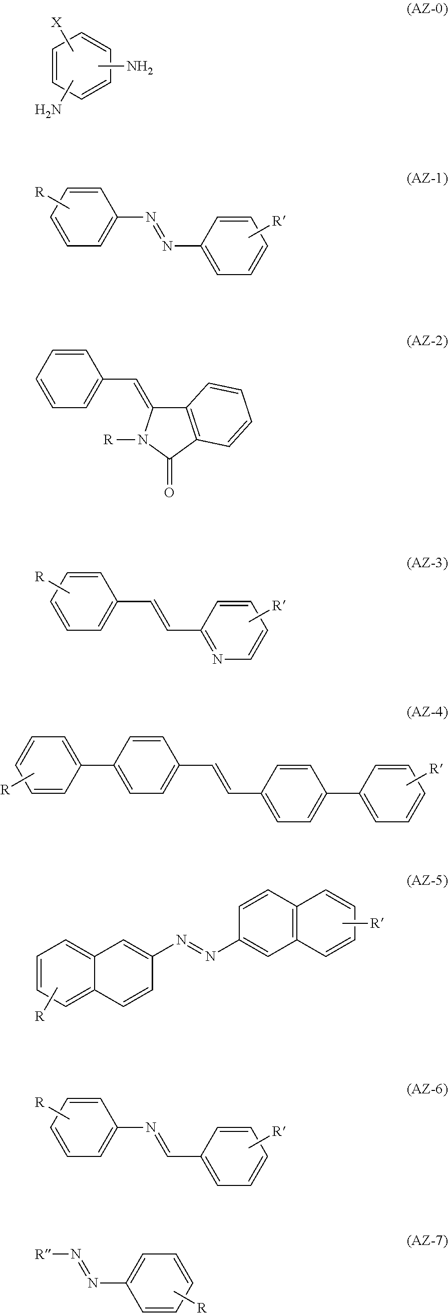

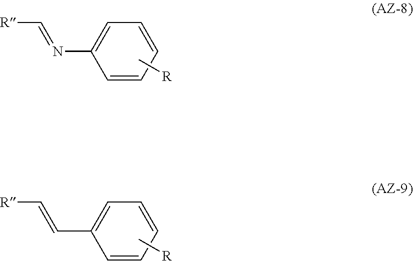

Here, either one of R and R″ is coupled to a benzene ring including diamine and the other is a terminal group, R, R′, and R″ are monovalent groups including a hydrogen atom, a halogen atom, an alkyl group, an alkoxy group, and a carbonate group, or a derivative thereof, and R″ is directly coupled to a benzene ring including diamine.

Since the liquid crystal display device of Embodiment 6 and a method of manufacturing the same is able to be fundamentally and substantially the same as the liquid crystal display devices of Embodiments 1 to 4 and the methods of manufacturing the same except that a pre-alignment process compound including a photosensitive functional group deformed by the irradiation of energy rays (specifically, ultraviolet rays) is used, detailed description will be omitted.

### Example 1

### Example 1A to Example 1F

Example 1 relates to the liquid crystal display device (liquid crystal display element) according to the first embodiment of the present disclosure and the method of manufacturing the same, and the method of manufacturing the liquid crystal display device (liquid crystal display element) according to the third embodiment of the present disclosure. In Examples 1A to 1F, the liquid crystal display device (liquid crystal display element) illustrated in FIG. 1 was created by the following procedures.

First, the TFT substrate 20 and the CF substrate 30 were prepared. A substrate with a slit pattern (line width 60 μm, 10 μm between lines: slit portions 21) on one face side of a glass substrate 20A with a thickness of 0.7 mm on which pixel electrodes 20B formed of ITO are formed was used as the TFT substrate 20. Further, a substrate with no pattern formed on the color filter of a glass substrate 30A with a thickness of 0.7 mm on which a color filter is formed on which opposing electrodes 30B formed of ITO are provided was used as the CF substrate 30. An inclined electric field is applied between the TFT substrate 20 and the CF substrate 30 by the slit pattern formed on the pixel electrodes 20B.

Meanwhile, the alignment film material shown in Formula F-1 as a compound configuring a cross-linked portion and a terminal structure portion of a cross-linked polymer compound in the 1C configuration of the present disclosure was prepared. That is, polyamic acid was obtained by reacting a diamine compound and tetracarboxylic dianhydride. Next, polyamic acid that is imide reacted and cyclodehydrated was dissolved in NMP. The polyimide shown in Formula F-1 was obtained in such a manner. Furthermore, after applying the prepared alignment film material respectively on the TFT substrate 20 and the CF substrate 30 using a spin coater, the applied films were dried for 80 seconds on a hotplate at 80° C. Next, the TFT substrate 20 and the CF substrate 30 were heated for one hour in a 200° C. oven in an atmosphere of nitrogen gas. In so doing, alignment films 22 and 32 with a thickness of 90 nm on the pixel electrodes 20B and the opposing electrodes 30B were formed.

Next, a sealing portion was formed by applying an ultraviolet curable resin including silica particles with a particle diameter of 3.2 μm on the pixel portion perimeter on the CF substrate 30, and a liquid crystal material including MLC-7026 (manufactured by Merck) that are negative type liquid crystals with negative dielectric constant anisotropy and a pretilt stability conferring compound was injected dropwise into the surrounded portion. Here, the mass ratio of the pretilt stability conferring compound with respect to the total of MLC-7026 and the pretilt stability conferring compound was 0.1 mass % to 0.5 mass %. The pretilt stability conferring compound that was used is shown in Table 1. Next, after pasting together the TFT substrate 20 and the CF substrate 30 and curing the sealing portion, the substrates were heated in an oven at 120° C. for one hour to completely cure the sealing portion. In so doing, the liquid crystal layer 40 was sealed, and the liquid crystal cell was able to be completed.

Next, the pre-alignment process compound within the alignment films 22 and 32 was reacted by irradiating even ultraviolet rays at 500 mJ (measured at a wavelength of 365 nm) in a state of applying an alternating current electric field (60 Hz) of square waves at an effective voltage of 20 volts on the liquid crystal cell created in such a manner. In so doing, the alignment films 22 and 32 including the post-alignment process compound were formed on both the TFT substrate 20 and the CF substrate 30. The liquid crystal display device (liquid crystal display element) illustrated in FIG. 1 with the liquid crystal molecules 41A and 41B on the TFT substrate 20 and the CF substrate 30 side achieving a pretilt was able to be completed as described above. Finally, a pair of polarizing plates were pasted onto the outside of the liquid crystal display device so that the absorption axes are orthogonal.

Furthermore, the pretilt (unit: degrees) and the response speed of the liquid crystal molecules were measured for the liquid crystal display device (liquid crystal display element) of Embodiment 1. The results are shown in the following Table 1.

The pretilt θ of the liquid crystal molecules 41 was measured by a crystal rotation method using He—Ne laser beams in compliance with a common method (method described in T. J. Scheffer et al, J. Appl. Phys., vol. 19, page 2013, 1980). Here, the pretilt θ is the inclination angle of the directors D of the liquid crystal molecules 41 (41A, 41B) with respect to the Z direction in a state in which the driving voltage is off in a case where the vertical direction (normal direction) to the surfaces of the glass substrates 20A and 30A is Z as described above and illustrated in FIG. 3.

When measuring the response time, a driving voltage (7.5 volts) was applied between the pixel electrodes 20B and the opposing electrodes 30B using LCD5200 (manufactured by Otsuka Electronics Co., Ltd.) as the measurement device, and the amount of time taken from a brightness of 10% to reach a brightness which is 90% of the gradation according to the driving voltage was measured.

As a result, the results shown in the following Table 1 were obtained for Embodiment 1. That is, excluding the point that a pretilt stability conferring compound is not included, excellent response speed was able to be obtained compared to the liquid crystal display device of Comparative Example 1 created similarly to Example 1. Here, in Table 1, the response time of Example 1 is represented by a value standardizing the response time of Comparative Example 1 as “1.00”.

TABLE 1

| | Pretilt | | | |
|---|---|---|---|---|
| | stability | Addition | | |
| | conferring | amount | Pretilt | Response |
| Example | compound | (mass %) | (degrees) | speed |
| 1A | 101-A | 0.5 | 1.6 | 0.67 |
| 1B | 102-B | 0.2 | 1.1 | 0.87 |
| 1C | 101-B | 0.15 | 1.0 | 0.92 |
| 1D | 101-C | 0.11 | 1.0 | 0.93 |
| 1E | 101-D | 0.11 | 1.0 | 0.94 |
| 1F | 102-E | 0.1 | 1.0 | 0.94 |
| Comparative | | Not added | 0.8 | 1.00 |
| Example 1 | | | | |

### Example 1G

In Example 1G, the following alignment film material was used. That is, first, 1 mol of the compound including a cross-linkable functional group shown in Formula A-7 which is a diamine compound, 1 mol of the compound including a vertical alignment inducing structure portion shown in Formula B-6, and 2 mol of the tetracarboxylic dianhydride shown in Formula E-2 were dissolved in N-methyl-2-pyrrollidone (NMP). Next, after reacting the solution at 60° C. for six hours, the reaction products were precipitated by pouring a large excess of pure water over the reacted solution. Next, after separating the precipitated solids, the solids were wasted using pure water, dried for 15 hours at 40° C. under reduced pressure, and in so doing, polyamic acid as a polymer compound precursor as the pre-alignment compound was synthesized. Finally, after creating a solution with a solid concentration of 3 mass % by dissolving 3.0 g of the obtained polyamic acid in NMP, the solution was filtered using a 0.2 μm filter. The alignment films were formed, and furthermore, the liquid crystal display device was created from the solution obtained in such a manner in a similar manner to Example 1A.

### Example 1H

In Example 1H, the same procedures as in Example 1A were performed except that an imidized polymer was used by cyclodehydrating polyamic acid instead of using polyamic acid as the alignment film material. At this time, cyclodehydration was performed by dissolving the polyamic acid synthesized in Example 1A in N-methyl-2-pyrrolidone, adding pyridine and an acetic dianhydride, and reacting the mixed solution at 110° C. for three hours. Next, the reaction products were precipitated by pouring a large excess of pure water on the reacted mixed solution, and the precipitated solids were washed using pure water after being separated. The imidized polymer as the pre-alignment process compound was obtained by then drying the solids for 15 hours at 40° C. under reduced pressure. Furthermore, the alignment films were formed, and furthermore, the liquid crystal display device was created in a similar manner to Example 1A.

### Example 1J

In Example 1J, the same procedures as in Example 1A were performed except that when the polyamic acid was synthesized, the compound including a vertical alignment inducing structure portion represented by the following Formula B-37 was used instead of the compound including a vertical alignment inducing structure portion shown in Formula B-6.

### Example 1K

In Example 1K, the same procedures as in Example 1A were performed except that when the polyamic acid was synthesized, the tetracarboxylic dianhydride shown in Formula E-3 was used instead of the tetracarboxylic dianhydride shown in Formula E-2.

### Example 1L

In Example 1L, the same procedures as in Example 1A were performed except that when the polyamic acid was synthesized, the tetracarboxylic dianhydride shown in Formula E-1 was used instead of the tetracarboxylic dianhydride shown in Formula E-2.

### Example 1M

In Example 1M, the same procedures as in Example 1A were performed except that when the polyamic acid was synthesized, the compound including a cross-linkable functional group shown in Formula A-7 was not used as the diamine compound and the ultraviolet rays irradiated on the liquid crystal cell was changed. In detail, when synthesizing the polyamic acid, 2 mol of the compound including a vertical alignment inducing structure portion shown in Formula B-6 was used as the diamine compound. Further, even ultraviolet rays at 100 mJ (measured with a wavelength of 250 nm) were irradiated on the liquid crystal cell in a state in which an alternating current electric field of square waves with a predetermined effective voltage was applied were irradiated.

The response speeds of the liquid crystal display devices of Examples 1G to 1M obtained as described above were appropriately 0.97 times the response time of the liquid crystal display device of Comparative Example 1, or less.

### Example 2A

Example 2 also relates to the liquid crystal display device (liquid crystal display element) according to the first embodiment of the present disclosure and the method of manufacturing the same, and the method of manufacturing the liquid crystal display device (liquid crystal display element) according to the third embodiment of the present disclosure. In Example 2A, the response characteristics were investigated by creating the liquid crystal display device (liquid crystal display element) illustrated in FIG. 1 in a similar manner to Example 1A.

Specifically, first, the TFT substrate 20 and the CF substrate 30 were prepared. A substrate with a slit pattern (line width 4 μm, 4 μm between lines: slit portions 21) on one face side of a glass substrate 20A with a thickness of 0.7 mm on which pixel electrodes 20B formed of ITO are formed was used as the TFT substrate 20. Further, a substrate in which opposing electrodes 30B formed of ITO are formed across the entire face of a color filter on a glass substrate 30A with a thickness of 0.7 mm on which a color filter is formed was used as the CF substrate 30. An inclined electric field is applied between the TFT substrate 20 and the CF substrate 30 by the slit pattern formed on the pixel electrodes 20B. Next, 3.25 μm spacer protrusions were formed on the TFT substrate 20 using photosensitive acrylic resin PC-335 (manufactured by JSR Corporation).

Meanwhile, the alignment film material was prepared. In such a case, first, the compound including a cross-linkable functional group shown in Formula A-8 which is a diamine compound, the compound including a vertical alignment inducing structure portion shown in Formula B-6, the compound shown in Formula C-1, and the tetracarboxylic dianhydride shown in Formula E-2 were dissolved in NMP. Next, after reacting the solution at 60° C. for four hours, a large excess of methanol was poured over the reacted solution to precipitate the reaction products. Next, the precipitated solids were washed using methanol after being separated, dried for 15 hours at 40° C. at reduced pressure, and in so doing, polyamic acid as the polymer compound precursor as the pre-alignment process compound was synthesized. Finally, the solution was made to have a solid concentration of 3 mass % by dissolving 3.0 g of the obtained polyamic acid in NMP before being filtered in a 0.2 μm filter.

Next, after applying the prepared alignment film material on the TFT substrate 20 and the CF substrate 30 respectively using a spin coater, the applied films were dried for 80 seconds using a hotplate at 80° C. Next, the TFT substrate 20 and the CF substrate 30 were heated for one hour using a 200° C. oven in an atmosphere of nitrogen gas. In so doing, alignment films 22 and 32 with a thickness of 90 nm on the pixel electrodes 20B and the opposing electrodes 30B were formed.

Next, a sealing portion was formed by applying an ultraviolet curable resin on the pixel portion perimeter on the CF substrate 30 in a similar manner to Example 1A, and the same liquid crystal material as in Example 1A (including a pretilt stability conferring compound) was injected dropwise into the surrounded portion. Thereafter, the TFT substrate 20 and the CF substrate 30 were pasted together to cure the sealing portion. Next, the sealing portion was completely cured by heating for one hour in a 120° C. oven. In so doing, the liquid crystal layer 40 was sealed, and the liquid crystal cell was able to be completed.

Next, the pre-alignment process compound within the alignment films 22 and 32 was reacted by irradiating even ultraviolet rays at 500 mJ (measured at a wavelength of 365 nm) in a state of applying an alternating current electric field (60 Hz) of square waves at an effective voltage of 20 volts on the liquid crystal cell created in such a manner. In so doing, the alignment films 22 and 32 including the post-alignment process compound were formed on both the TFT substrate 20 and the CF substrate 30. The liquid crystal display device (liquid crystal display element) illustrated in FIG. 1 with the liquid crystal molecules 41A and 41B on the TFT substrate 20 and the CF substrate 30 side achieving a pretilt was able to be completed as described above. Finally, a pair of polarizing plates were pasted onto the outside of the liquid crystal display device so that the absorption axes are orthogonal.

### Example 2B

In Example 2B, the same procedure as in Example 2A were performed except that the compound including a vertical alignment inducing structure portion shown in Formula B-6 was not used when synthesizing the polyamic acid.

### Example 2C

In Example 2C, the same procedure as in Example 2A were performed except that the compound shown in Formula C-2 was used instead of the compound shown in Formula C-1 when synthesizing the polyamic acid.

### Example 2D, Example 2E

In Examples 2D and 2E, the same procedure as in Example 2A were performed except that a compound including the group shown in Formula D-7 and the compound represented by Formula G-1 were used instead of the compound including a cross-linkable functional group shown in Formula A-8 and the compound including a vertical alignment inducing structure portion shown in Formula B-6, and the compound shown in Formula C-1 when synthesizing the polyamic acid.

The response speeds of the liquid crystal display devices of Examples 2A to 2E obtained as described above were appropriately 0.90 times the response time of the liquid crystal display device of Comparative Example 1, or less.

### Example 3

Example 3 also relates to the liquid crystal display device (liquid crystal display element) according to the first embodiment of the present disclosure and a method of manufacturing the same, and to the method of manufacturing the liquid crystal display device (liquid crystal display element) according to the third embodiment of the present disclosure.

### Example 3A

In Example 3A, similarly to Example 1, the polyimide shown in Formula F-1 was used. Furthermore, after obtaining the alignment films 22 and 32 in a similar manner to Example 1A, furthermore, the liquid crystal cell was completed fundamentally based on the same method as that described in Example 2A. However, the sealing portion was formed with the height of the spacer protrusions as 3.2 μm using silica particles with a particle diameter of 3.2 μm. Further, the thicknesses of the alignment films 22 and 32 on the pixel electrodes 20B and the opposing electrodes 30B were 90 nm.

Next, the pre-alignment process compound within the alignment films 22 and 32 was reacted by irradiating even ultraviolet rays at 500 mJ (measured at a wavelength of 365 nm) in a state of applying an alternating current electric field (60 Hz) of square waves at an effective voltage of 20 volts on the liquid crystal cell created in such a manner. In so doing, the alignment films 22 and 32 including the post-alignment process compound were formed on both the TFT substrate 20 and the CF substrate 30. The liquid crystal display device (liquid crystal display element) illustrated in FIG. 1 with the liquid crystal molecules 41A and 41B on the TFT substrate 20 and the CF substrate 30 side achieving a pretilt was able to be completed as described above. Finally, a pair of polarizing plates were pasted onto the outside of the liquid crystal display device so that the absorption axes are orthogonal.

### Example 3B

Alternatively, in Example 3B, first, the TFT substrate 20 and the CF substrate 30 were prepared. A substrate with a slit pattern (line width 60 μm, 10 μm between lines: slit portions 21) on one face side of a glass substrate 20A with a thickness of 0.7 mm on which pixel electrodes 20B formed of ITO are formed was used as the TFT substrate 20. Further, a substrate with a slit pattern (line width 60 μm, 10 μm between lines: slit portions 31) formed on a color filter on a glass substrate 30A with a thickness of 0.7 mm on which a color filter is formed in which opposing electrodes 30B formed of ITO are formed was used as the CF substrate 30. An inclined electric field is applied between the TFT substrate 20 and the CF substrate 30 by the slit patterns formed on the pixel electrodes 20B and the opposing electrodes 30B. Next, 3.5 μm spacer protrusions were formed on the TFT substrate 20. Furthermore, the liquid crystal display device (liquid crystal display element) illustrated in FIG. 13 with the liquid crystal molecules 41A and 41B on the TFT substrate 20 and the CF substrate 30 side achieving a pretilt was able to be completed by creating the liquid crystal display device using the TFT substrate 20 and the CF substrate 30 in a similar manner to Example 1A. Here, the sealing portion was cured by pasting together the TFT substrate 20 and the CF substrate 30 so that the center of the line portions of the pixel electrodes 20B and the slit portions 31 of the opposing electrodes 30B are opposing.

The response speeds of the liquid crystal display devices of Examples 3A and 3B obtained as described above were appropriately 0.91 times the response time of the liquid crystal display device of Comparative Example 1.

### Example 4

Example 4 relates to the liquid crystal display device (liquid crystal display element) according to the second embodiment of the present disclosure and a method of manufacturing the same, and to the method of manufacturing the liquid crystal display device (liquid crystal display element) according to the third embodiment of the present disclosure. In Example 4, a pre-alignment process compound and post-alignment process compound including a photosensitive functional group were used. Specifically, the liquid crystal display device with the same configuration and structure as that illustrated in FIG. 13 described in Example 3B was created using the azo benzene-based compounds shown in the following Formulae AZ-11 to AZ-17 as a pre-alignment process compound including a photosensitive functional group, and the response characteristics were investigated.

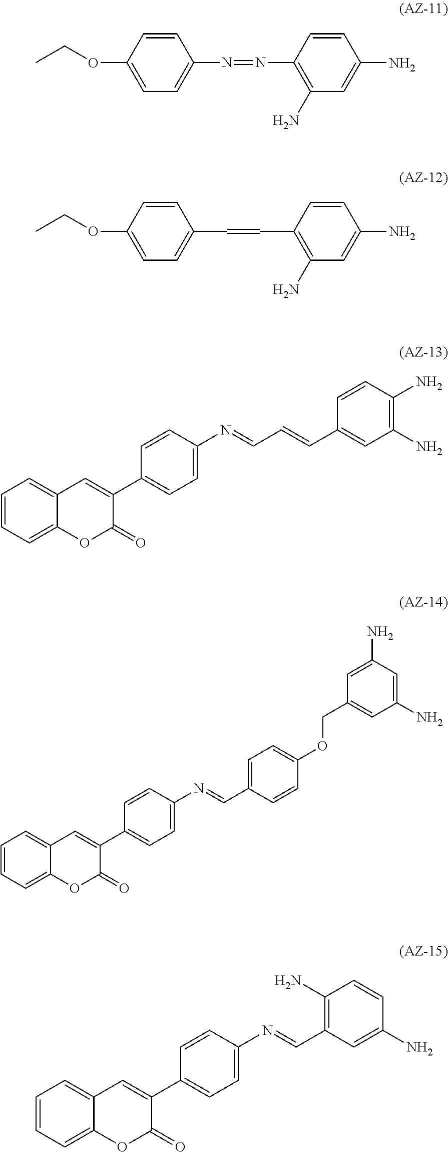 [SMILES: CCOc1ccc(N=Nc2ccc(N)cc2N)cc1 ; CCOc1ccc(C=Cc2ccc(N)cc2N)cc1 ; Nc1ccc(/C=C/C=N/c2ccc(-c3cc4ccccc4oc3=O)cc2)cc1N ; Nc1cc(N)cc(COc2ccc(/C=N/c3ccc(-c4cc5ccccc5oc4=O)cc3)cc2)c1 ; Nc1ccc(N)c(/C=N/c2ccc(-c3cc4ccccc4oc3=O)cc2)c1]

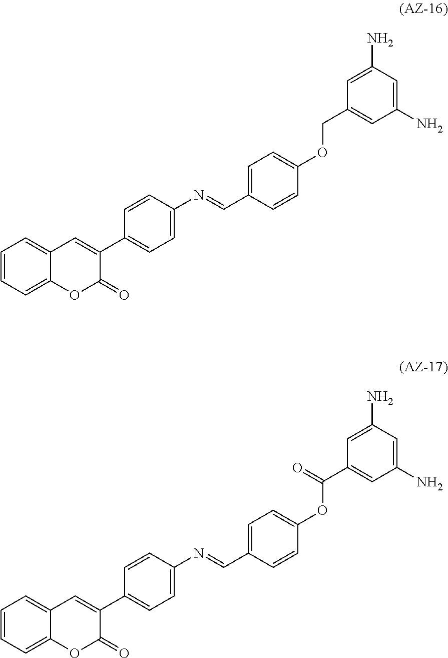 [SMILES: Nc1cc(N)cc(COc2ccc(/C=N/c3ccc(-c4cc5ccccc5oc4=O)cc3)cc2)c1 ; Nc1cc(N)cc(C(=O)Oc2ccc(/C=N/c3ccc(-c4cc5ccccc5oc4=O)cc3)cc2)c1]

In Example 4, after applying a polyimide material in which the tetracarboxylic dianhydride shown in Formula E-2 is the dianhydride with the compound shown in Formula AZ-11 and the compound C-1 as the diamine raw material with a mass ratio of 9:1 on the TFT substrate 20 and the CF substrate 30 respectively using a spin coater, the applied films were dried for 80 seconds using a hotplate at 80° C. Next, the TFT substrate 20 and the CF substrate 30 were heated for one hour using a 200° C. oven in an atmosphere of nitrogen gas. In so doing, alignment films 22 and 32 with a thickness of 90 nm on the pixel electrodes 20B and the opposing electrodes 30B were formed.

Next, similarly to Example 1A, a sealing portion was formed by applying an ultraviolet curable resin including silica particles with a particle diameter of 3.2 μm on the pixel portion perimeter on the CF substrate 30, and the same liquid crystal material as in Example 1A (including a pretilt stability conferring material) was injected dropwise into the surrounded portion. The sealing portion was then cured by pasting together the TFT substrate 20 and the CF substrate 30 so that the center of the line portion of the pixel electrodes 20B and the slit portions 31 of the opposing electrodes 30B are opposing. Next, the sealing portion was completely cured by heating in a 120° C. oven for one hour. In so doing, the liquid crystal layer 40 was sealed, and the liquid crystal cell (Example 4A) was able to be completed.

Next, the pre-alignment process compound within the alignment films 22 and 32 was deformed by irradiating even ultraviolet rays at 500 mJ (measured at a wavelength of 365 nm) in a state of applying an alternating current electric field (60 Hz) of square waves with a predetermined effective voltage on the liquid crystal cell created in such a manner. In so doing, the alignment films 22 and 32 including the post-alignment process compound (deformed polymer compound) were formed on both the TFT substrate 20 and the CF substrate 30. The liquid crystal display device (liquid crystal display element) illustrated in FIG. 1 with the liquid crystal molecules 41A and 41B on the TFT substrate 20 and the CF substrate 30 side achieving a pretilt was able to be completed as described above. Finally, a pair of polarizing plates were pasted onto the outside of the liquid crystal display device so that the absorption axes are orthogonal.

The liquid crystal display devices (liquid crystal display elements) of Examples 4B to 4G were completed in a similar manner to those described above using the compounds shown in Formulae AZ-12 to AZ-17 instead of the compound shown in Formula AZ-11.

The response speeds of the liquid crystal display devices of Examples 4A to 4G obtained as described above were appropriately 0.96 times the response time of the liquid crystal display device of Comparative Example 1, or less.

While embodiments of the present disclosure have been described above based on preferable embodiments and example, the embodiments of the present disclosure are not limited thereto, and various modifications are possible. For example, while VA mode liquid crystal display devices (liquid crystal display elements) have been described in the embodiments and example, the embodiments of the present disclosure are not necessarily limited thereto, and are applicable to other display modes such as the TN mode, an IPS (In Plane Switching) mode, an FFS (Fringe Field Switching) mode, or an OCB (Optically Compensated Bend) mode. The same effects are obtained even in such cases. However, in the embodiments of the present disclosure, compared to when a pretilt process has not been performed, a particularly high improvement effect in the response characteristics are able to be exhibited in the VA mode than in the IPS mode or the FFS mode.

Further, while only transmission type liquid crystal display devices (liquid crystal display elements) were described in the embodiments and examples, the embodiments of the present disclosure are not necessarily limited to a transmission type, and may, for example, be a reflection type. In the case of the reflection type, the pixel electrodes are configured by an electrode material with light reflectivity such as aluminum.

Here, the present disclosure may take the following configurations.

### 1 Liquid Crystal Display Device: First Embodiment

A liquid crystal display device including: a liquid crystal display element including a pair of alignment films provided on opposing face sides of a pair of substrates, and a liquid crystal layer including liquid crystal molecules with negative dielectric constant anisotropy provided between the pair of alignment films, wherein at least one of the pair of alignment films includes a compound in which a polymer compound including a cross-linkable functional group as a side chain is cross-linked, a pretilt is conferred on the liquid crystal molecules by the cross-linked compound, and at least one type of a compound represented by the following General Formula 101 or General Formula 102 is included in the liquid crystal layer.

CH₍₄₋ₙ₎(R¹)ₙ (101)

(R²)ₘ-A-(X)ₚ (102)

Here, in General Formula 101, R² represents a phenyl group or a cyclohexyl group which may be respectively independently substituted and n is 3 or 4, and in General Formula 102, “A” represents a benzene ring or a cyclohexane ring, R² represents a phenyl group, a cyclopentadienyl group, or a naphthyl group which may be respectively independently substituted, X respectively independently represents a halogen atom, m is 3, and p is an integer between 0 and 3.

### 2 Liquid Crystal Display Device: First Embodiment

A liquid crystal display device including: a liquid crystal display element including a pair of alignment films provided on opposing face sides of a pair of substrates, and a liquid crystal layer including liquid crystal molecules with negative dielectric constant anisotropy provided between the pair of alignment films, wherein at least one of the pair of alignment films includes a compound in which a polymer compound including a photosensitive functional group as a side chain is deformed, a pretilt is conferred on the liquid crystal molecules by the deformed compound, and at least one type of a compound represented by the following General Formula 101 or General Formula 102 is included in the liquid crystal layer.

CH₍₄₋ₙ₎(R¹)ₙ (101)

(R²)ₘ-A-(X)ₚ (102)

Here, in General Formula 101, R² represents a phenyl group or a cyclohexyl group which may be respectively independently substituted and n is 3 or 4, and in General Formula 102, “A” represents a benzene ring or a cyclohexane ring, R² represents a phenyl group, a cyclopentadienyl group, or a naphthyl group which may be respectively independently substituted, X respectively independently represents a halogen atom, m is 3, and p is an integer between 0 and 3.
3 The liquid crystal display device according to 1 or 2, wherein a substituent in R¹ or R² of the compound represented by General Formula 101 or General Formula 102 is at least one type selected from a group consisting of a halogen atom, a hydrocarbon group with one to eight carbon atoms, and an alkoxy group with one to six carbon atoms.
4 The liquid crystal display device according to 3, wherein the halogen atom is a fluorine atom or a chlorine atom.
5 The liquid crystal display device according to any one of 1 to 4, wherein the mass ratio of the compound represented by General Formula 101 or General Formula 102 with respect to the total of the compound represented by General Formula 101 or General Formula 102 and the liquid crystal molecules is 0.1 mass % to 5 mass %.
6 The liquid crystal display device according to any one of 1 to 5, wherein a compound configuring at least one of the pair of alignment films is further formed by a compound including the group represented by Formula 1 as a side chain.

—R1—R2—R3 (1)

Here, R1 is a linear or branched divalent organic group with three or more carbon atoms which is coupled with the main chain of the polymer compound, R2 is a divalent organic group including a plurality of ring structures in which one of the atoms configuring the ring structures is coupled with R1, and R3 is a monovalent group including a hydrogen atom, a halogen atom, an alkyl group, an alkoxy group, and a carbonate group, or a derivative thereof.

7 The liquid crystal display device according to any one of 1 to 5, wherein a compound configuring at least one of the pair of alignment films is further formed by a compound including the group represented by Formula 2 as a side chain.

—R11—R12—R13—R14 (2)

Here, R11 is a linear or branched divalent organic group with one or more and twenty or fewer carbon atoms, and preferably three or more and twelve or fewer carbon atoms including an ether group or an ester group which is coupled with the main chain of the polymer compound, or R11 is an ether group or an ester group which is coupled with the main chain of the polymer compound, R12 is a divalent group including any one type of structure out of chalcone, cinnamate, cinnamoyl, coumarin, maleimide, benzophenone, norbornene, oryzanol, and chitosan, or is an ethynylene group, R13 is a divalent organic group including a plurality of ring structures, and R14 is a monovalent group including a hydrogen atom, a halogen atom, an alkyl group, an alkoxy group, and a carbonate group, or a derivative thereof.

8 The liquid crystal display device according to 1, wherein the compound obtained by cross-linking the polymer compound is configured by a side chain and a main chain supporting the side chain with respect to the substrates, the side chain is configured by a cross-linked portion coupled to the main chain and in which a portion of the side chain is cross-linked and a terminal structure portion coupled to the cross-linked portion, and a pretilt is conferred by the liquid crystal molecules being along the terminal structure portion or being interposed by the terminal structure portion.
9 The liquid crystal display device according to 2, wherein the compound obtained by deforming the polymer compound is configured by a side chain and a main chain supporting the side chain with respect to the substrates, the side chain is configured by a deformed portion coupled to the main chain and in which a portion of the side chain is deformed and a terminal structure portion coupled to the deformed portion, and a pretilt is conferred by the liquid crystal molecules being along the terminal structure portion or being interposed by the terminal structure portion.
10 The liquid crystal display device according to 1, wherein the compound obtained by cross-linking the polymer compound is configured by a side chain and a main chain supporting the side chain with respect to the substrates, and the side chain is configured by a cross-linked portion coupled to the main chain and in which a portion of the side chain is cross-linked and a terminal structure portion coupled to the cross-linked portion including a mesogenic group.
11 The liquid crystal display device according to 2, wherein the compound obtained by deforming the polymer compound is configured by a side chain and a main chain supporting the side chain with respect to the substrates, and the side chain is configured by a deformed portion coupled to the main chain and in which a portion of the side chain is deformed and a terminal structure portion coupled to the deformed portion including a mesogenic group.
12 The liquid crystal display device according to any one of 1 to 11, wherein a surface roughness Ra of at least one of the pair of alignment films is equal to or less than 1 nm.
13 The liquid crystal display device according to any one of 1 to 12, wherein the pair of alignment films have the same composition.
14 The liquid crystal display device according to any one of 1 to 13, wherein an alignment regulation unit formed of a slit formed on an electrode or a protrusion provided on a substrate is provided.

### 15 Method of Manufacturing Liquid Crystal Display Device: First Embodiment

A method of manufacturing a liquid crystal display device, the method including: forming a first alignment film formed of a polymer compound including a cross-linkable functional group as a side chain on one of a pair of substrates; forming a second alignment film on the other of the pair of substrates; arranging the pair of substrates so that the first alignment film and the second alignment film are opposing, and sealing a liquid crystal layer including liquid crystal molecules with negative dielectric constant anisotropy and at least one type of compound represented by the following General Formula 101 or General Formula 102 between the first alignment film and the second alignment film; and conferring a pretilt on the liquid crystal molecules by cross-linking the polymer compound after sealing the liquid crystal layer.

CH₍₄₋ₙ₎(R¹)ₙ (101)

(R²)ₘ-A-(X)ₚ (102)

Here, in General Formula 101, R² represents a phenyl group or a cyclohexyl group which may be respectively independently substituted and n is 3 or 4, and in General Formula 102, “A” represents a benzene ring or a cyclohexane ring, R² represents a phenyl group, a cyclopentadienyl group, or a naphthyl group which may be respectively independently substituted, X respectively independently represents a halogen atom, m is 3, and p is an integer between 0 and 3.

### 16 Method of Manufacturing Liquid Crystal Display Device: Second Embodiment

A method of manufacturing a liquid crystal display device, the method including: forming a first alignment film formed of a polymer compound including a photosensitive functional group as a side chain on one of a pair of substrates; forming a second alignment film on the other of the pair of substrates; arranging the pair of substrates so that the first alignment film and the second alignment film are opposing, and sealing a liquid crystal layer including liquid crystal molecules with negative dielectric constant anisotropy and at least one type of compound represented by the following General Formula 101 or General Formula 102 between the first alignment film and the second alignment film; and conferring a pretilt on the liquid crystal molecules by deforming the polymer compound after sealing the liquid crystal layer.

CH₍₄₋ₙ₎(R¹)ₙ (101)

(R²)ₘ-A-(X)ₚ (102)

Here, in General Formula 101, R² represents a phenyl group or a cyclohexyl group which may be respectively independently substituted and n is 3 or 4, and in General Formula 102, “A” represents a benzene ring or a cyclohexane ring, R² represents a phenyl group, a cyclopentadienyl group, or a naphthyl group which may be respectively independently substituted, X respectively independently represents a halogen atom, m is 3, and p is an integer between 0 and 3.

### 17 Method of Manufacturing Liquid Crystal Display Device: Third Embodiment

A method of manufacturing a liquid crystal display device, the method including: forming a first alignment film formed of a polymer compound including a cross-linkable functional group or a photosensitive functional group as a side chain on one of a pair of substrates; forming a second alignment film on the other of the pair of substrates; arranging the pair of substrates so that the first alignment film and the second alignment film are opposing, and sealing a liquid crystal layer including liquid crystal molecules with negative dielectric constant anisotropy and at least one type of compound represented by the following General Formula 101 or General Formula 102 between the first alignment film and the second alignment film; and conferring a pretilt on the liquid crystal molecules by irradiating energy rays on the polymer compound after sealing the liquid crystal layer.

CH₍₄₋ₙ₎(R¹)ₙ (101)

(R²)ₘ-A-(X)ₚ (102)

Here, in General Formula 101, R² represents a phenyl group or a cyclohexyl group which may be respectively independently substituted and n is 3 or 4, and in General Formula 102, “A” represents a benzene ring or a cyclohexane ring, R² represents a phenyl group, a cyclopentadienyl group, or a naphthyl group which may be respectively independently substituted, X respectively independently represents a halogen atom, m is 3, and p is an integer between 0 and 3.

The present disclosure contains subject matter related to that disclosed in Japanese Priority Patent Application JP 2011-275508 filed in the Japan Patent Office on Dec. 16, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display device comprising:
a liquid crystal display element including
a pair of alignment films provided on opposing face sides of a pair of substrates, and
a liquid crystal layer including liquid crystal molecules with negative dielectric constant anisotropy provided between the pair of alignment films,
wherein at least one of the pair of alignment films includes a compound in which a polymer compound including a cross-linkable functional group as a side chain is cross-linked,
a pretilt is conferred on the liquid crystal molecules by the cross-linked compound, and
at least one type of a compound represented by a following General Formula 101 or General Formula 102 is included in the liquid crystal layer,
CH₍₄₋ₙ₎(R¹)ₙ (101)
(R²)ₘ-A-(X)ₚ (102).
wherein
in General Formula 101, R¹ represents a phenyl group or a cyclohexyl group which may be respectively independently substituted and n is 3 or 4, and
in General Formula 102, “A” represents a benzene ring or a cyclohexane ring, R² represents a phenyl group, a cyclopentadienyl group, or a naphthyl group which may be respectively independently substituted, X respectively independently represents a halogen atom, m is 3, and p is an integer between 0 and 3.

2. A liquid crystal display device comprising:
a liquid crystal display element including
a pair of alignment films provided on opposing face sides of a pair of substrates, and
a liquid crystal layer including liquid crystal molecules with negative dielectric constant anisotropy provided between the pair of alignment films,
wherein at least one of the pair of alignment films includes a compound in which a polymer compound including a photosensitive functional group as a side chain is deformed,
a pretilt is conferred on the liquid crystal molecules by the deformed compound, and
at least one type of a compound represented by a following General Formula 101 or General Formula 102 is included in the liquid crystal layer,
CH₍₄₋ₙ₎(R¹)ₙ (101)
(R²)ₘ-A-(X)ₚ (102).
wherein
in General Formula 101, R¹ represents a phenyl group or a cyclohexyl group which may be respectively independently substituted and n is 3 or 4, and
in General Formula 102, “A” represents a benzene ring or a cyclohexane ring, R² represents a phenyl group, a cyclopentadienyl group, or a naphthyl group which may be respectively independently substituted, X respectively independently represents a halogen atom, m is 3, and p is an integer between 0 and 3.

3. The liquid crystal display device according to claim 1,
wherein a substituent in R¹ or R² of the compound represented by General Formula 101 or General Formula 102 is at least one type selected from the group consisting of a halogen atom, a hydrocarbon group with one to eight carbon atoms, and an alkoxy group with one to six carbon atoms.

4. The liquid crystal display device according to claim 3,
wherein the halogen atom is a fluorine atom or a chlorine atom.

5. The liquid crystal display device according to claim 1,
wherein a mass ratio of the compound represented by General Formula 101 or General Formula 102 with respect to a total of the compound represented by General Formula 101 or General Formula 102 and the liquid crystal molecules is 0.1 mass % to 5 mass %.

6. The liquid crystal display device according to claim 1,
wherein a compound configuring at least one of the pair of alignment films is further formed by a compound including a group represented by Formula 1 as a side chain,
—R1—R2—R3 (1)
here, R1 is a linear or branched divalent organic group with three or more carbon atoms which is coupled with a main chain of the polymer compound, R2 is a divalent organic group including a plurality of ring structures in which one of the atoms configuring the ring structures is coupled with R1, and R3 is a monovalent group including a hydrogen atom, a halogen atom, an alkyl group, an alkoxy group, and a carbonate group, or a derivative thereof.

7. The liquid crystal display device according to claim 1,
wherein a compound configuring at least one of the pair of alignment films is further formed by a compound including a group represented by Formula 2 as a side chain,
—R11—R12—R13—R14 (2)
here, R11 is a linear or branched divalent organic group with one or more and twenty or fewer carbon atoms, and preferably three or more and twelve or fewer carbon atoms including an ether group or an ester group which is coupled with a main chain of the polymer compound, or R11 is an ether group or an ester group which is coupled with the main chain of the polymer compound, R12 is a divalent group including any one type of structure out of chalcone, cinnamate, cinnamoyl, coumarin, maleimide, benzophenone, norbornene, oryzanol, and chitosan, or is an ethynylene group, R13 is a divalent organic group including a plurality of ring structures, and R14 is a monovalent group including a hydrogen atom, a halogen atom, an alkyl group, an alkoxy group, and a carbonate group, or a derivative thereof.

8. The liquid crystal display device according to claim 1,
wherein the compound obtained by cross-linking the polymer compound is configured by a side chain and a main chain supporting the side chain with respect to the substrates,
the side chain is configured by a cross-linked portion coupled to the main chain and in which a portion of the side chain is cross-linked and a terminal structure portion coupled to the cross-linked portion, and
a pretilt is conferred by the liquid crystal molecules being along the terminal structure portion or being interposed by the terminal structure portion.

9. The liquid crystal display device according to claim 2,
wherein the compound obtained by deforming the polymer compound is configured by a side chain and a main chain supporting the side chain with respect to the substrates,
the side chain is configured by a deformed portion coupled to the main chain and in which a portion of the side chain is deformed and a terminal structure portion coupled to the deformed portion, and
a pretilt is conferred by the liquid crystal molecules being along the terminal structure portion or being interposed by the terminal structure portion.

10. The liquid crystal display device according to claim 1,
wherein the compound obtained by cross-linking the polymer compound is configured by a side chain and a main chain supporting the side chain with respect to the substrates, and
the side chain is configured by a cross-linked portion coupled to the main chain and in which a portion of the side chain is cross-linked and a terminal structure portion coupled to the cross-linked portion, including a mesogenic group.

11. The liquid crystal display device according to claim 2,
wherein the compound obtained by deforming the polymer compound is configured by a side chain and a main chain supporting the side chain with respect to the substrates, and
the side chain is configured by a deformed portion coupled to the main chain and in which a portion of the side chain is deformed and a terminal structure portion coupled to the deformed portion, including a mesogenic group.

12. The liquid crystal display device according to claim 1,
wherein a surface roughness Ra of at least one of the pair of alignment films is equal to or less than 1 nm.

13. The liquid crystal display device according to claim 1,
wherein the pair of alignment films have a same composition.

14. The liquid crystal display device according to claim 1,
wherein an alignment regulation unit formed of a slit formed on an electrode or a protrusion provided on a substrate is provided.

15. A method of manufacturing a liquid crystal display device, the method comprising:
forming a first alignment film formed of a polymer compound including a cross-linkable functional group as a side chain on one of a pair of substrates;
forming a second alignment film on an other of the pair of substrates;
arranging the pair of substrates so that the first alignment film and the second alignment film are opposing, and sealing a liquid crystal layer including liquid crystal molecules with negative dielectric constant anisotropy and at least one type of compound represented by a following General Formula 101 or General Formula 102 between the first alignment film and the second alignment film; and
conferring a pretilt on the liquid crystal molecules by cross-linking the polymer compound after sealing the liquid crystal layer,
CH₍₄₋ₙ₎(R¹)ₙ (101)
(R²)ₘ-A-(X)ₚ (102).
wherein
in General Formula 101, R¹ represents a phenyl group or a cyclohexyl group which may be respectively independently substituted and n is 3 or 4, and
in General Formula 102, “A” represents a benzene ring or a cyclohexane ring, R² represents a phenyl group, a cyclopentadienyl group, or a naphthyl group which may be respectively independently substituted, X respectively independently represents a halogen atom, m is 3, and p is an integer between 0 and 3.

16. A method of manufacturing a liquid crystal display device, the method comprising:
forming a first alignment film formed of a polymer compound including a photosensitive functional group as a side chain on one of a pair of substrates;
forming a second alignment film on an other of the pair of substrates;
arranging the pair of substrates so that the first alignment film and the second alignment film are opposing, and sealing a liquid crystal layer including liquid crystal molecules with negative dielectric constant anisotropy and at least one type of compound represented by a following General Formula 101 or General Formula 102 between the first alignment film and the second alignment film; and
conferring a pretilt on the liquid crystal molecules by deforming the polymer compound after sealing the liquid crystal layer,
CH₍₄₋ₙ₎(R¹)ₙ (101)
(R²)ₘ-A-(X)ₚ (102).
wherein
in General Formula 101, R¹ represents a phenyl group or a cyclohexyl group which may be respectively independently substituted and n is 3 or 4, and
in General Formula 102, “A” represents a benzene ring or a cyclohexane ring, R² represents a phenyl group, a cyclopentadienyl group, or a naphthyl group which may be respectively independently substituted, X respectively independently represents a halogen atom, m is 3, and p is an integer between 0 and 3.

17. A method of manufacturing a liquid crystal display device, the method comprising:
forming a first alignment film formed of a polymer compound including a cross-linkable functional group or a photosensitive functional group as a side chain on one of a pair of substrates;
forming a second alignment film on an other of the pair of substrates;
arranging the pair of substrates so that the first alignment film and the second alignment film are opposing, and sealing a liquid crystal layer including liquid crystal molecules with negative dielectric constant anisotropy and at least one type of compound represented by a following General Formula 101 or General Formula 102 between the first alignment film and the second alignment film; and
conferring a pretilt on the liquid crystal molecules by irradiating energy rays on the polymer compound after sealing the liquid crystal layer,
CH₍₄₋ₙ₎(R¹)ₙ (101)
(R²)ₘ-A-(X)ₚ (102).
wherein
in General Formula 101, R¹ represents a phenyl group or a cyclohexyl group which may be respectively independently substituted and n is 3 or 4, and
in General Formula 102, “A” represents a benzene ring or a cyclohexane ring, R² represents a phenyl group, a cyclopentadienyl group, or a naphthyl group which may be respectively independently substituted, X respectively independently represents a halogen atom, m is 3, and p is an integer between 0 and 3.
